(19) United States
(12) Patent Application Publication
(10) Pub. No.: US 2026/0044839 A1
(43) Pub. Date: Feb. 12, 2026

(54) MULTI-FACTOR AUTHENTICATION SYSTEM AND INTERFACE FOR SECURITY IN DISTRIBUTED LEDGER INTERACTIONS

(71) Applicant: Block, Inc., Oakland, CA (US)

(72) Inventors: Max J. Guise, Albuquerque, NM (US); Arvin Aminpour, New York, NY (US); Jonathan Pollack, Walnut Creek, CA (US); Clayton Douglas Garrett, Atlanta, GA (US); Charlie R. Hart, Los Angeles, CA (US); Kenneth Lopez, London (GB); Thomas Kilbride, Seattle, WA (US)

(21) Appl. No.: 19/359,324

(22) Filed: Oct. 15, 2025

Related U.S. Application Data
(63) Continuation-in-part of application No. 18/666,155, filed on May 16, 2024.
(60) Provisional application No. 63/467,190, filed on May 17, 2023.

(51) Int. Cl. G06Q 20/06; G06Q 20/32; G06Q 20/40

(52) U.S. Cl. CPC G06Q 20/065; G06Q 20/322; G06Q 20/401; G06Q 2220/00

(57) ABSTRACT

Systems and methods for multi-factor authentication are disclosed. In some examples, a system can receive a request for a transfer of an amount of a digital asset from a transferor to a transferee. The system can receive a first input through a first interactive user interface (UI) (that identifies at least a portion of the amount) to verify that at least the portion of the amount is correct, as a first factor of authentication for the transfer. The system can receive a second input through a second interactive UI (that identifies a first subset of a transferee address), and can verify that the second input matches the second subset of the transferee address, as a second factor of authentication for the transfer. The system can initiate the transfer of the amount from the transferor to the transferee in response to multi-factor authentication via the two factors of authentication.

### CROSS-REFERENCE TO RELATED APPLICATIONS

This application is a continuation-in-part of U.S. patent application Ser. No. 18/666,155, filed May 16, 2024, and titled “Key Device and Supplemental Interface Use,” and claims the priority benefit of U.S. Provisional Patent Application No. 63/467,190, filed May 17, 2023, and titled “Wallet Hardware Key Device and Supplemental Display Use,”, the entire disclosures of which are hereby incorporated by reference.

### TECHNICAL FIELD

Cryptocurrency addresses such as blockchain addresses, oftentimes have one or more private keys that can be used to sign transactions for asset transfer from the address. Because the private key allows an entity to spend the assets within the wallet, private keys are often secured in hardware or software wallets.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is a block diagram of a non-limiting example environment of key device and supplemental interface use as described herein in accordance with one or more implementations.

FIG. 2 is a block diagram of a non-limiting example environment showing operation of devices associated with a first entity of FIG. 1 in greater detail in accordance with one or more implementations.

FIG. 3 is a block diagram of a non-limiting example environment showing operation of devices associated with a first entity of FIG. 1 that includes a key device and a first edge device in greater detail as generating transaction details and transmitting the transaction details in accordance with one or more implementations.

FIG. 4 is a flow diagram depicting a step-by-step procedure in an example implementation of operations performable by a processing device for accomplishing a result of entry of details of a digital transaction involving a transfer of cryptographic tokens by a key device and transfer of those details to a wallet server.

FIG. 5 is a block diagram of a non-limiting example environment showing receipt by a wallet server of the transaction details of FIG. 3 and initiation of a transfer of cryptographic tokens as part of a digital transaction responsive to confirmation by a supplemental interface in accordance with one or more implementations.

FIG. 6 is a flow diagram depicting a step-by-step procedure in an example implementation of operations performable by a processing device for accomplishing a result of initiation of a transfer of cryptographic tokens responsive to receipt of a confirmation from a supplemental interface in accordance with one or more implementations.

FIG. 7 is a block diagram of a non-limiting example environment showing generation of transaction details on an edge device and confirmation of the details by a supplemental interface for initiating a digital transaction involving a transfer of cryptographic tokens accordance with one or more implementations.

FIG. 8 depicts an example implementation showing output of a user interface by the first edge device in support of entry of transaction details in accordance with one or more implementations.

FIG. 9 depicts an example implementation showing output of a user interface by the first edge device in support of entry of a supplemental interface that is to confirm transaction details accordance with one or more implementations.

FIG. 10 depicts an example implementation showing output of a user interface by a supplemental interface as displaying transaction details and an option that is user selectable by the first entity to confirm transaction details accordance with one or more implementations.

FIG. 11 is a flow diagram depicting a step-by-step procedure in an example implementation of operations performable by a processing device for accomplishing a result of initiation of a transfer of cryptographic tokens responsive to receipt of a confirmation from a supplemental interface responsive to generation of the transaction details by an edge device in accordance with one or more implementations.

FIG. 12 is a non-limiting example environment showing operation of a blockchain node as part of a blockchain system of FIG. 11 in accordance with one or more implementations.

FIG. 13 is a non-limiting illustration of an example system that is operable to implement blockchain supported resource transfer communication protocol techniques described herein in accordance with one or more implementations.

FIG. 14 is a user interface diagram illustrating a series of interactive user interfaces for a transaction amount verification and a transferee address verification, in accordance with one or more implementations.

FIG. 15 is a user interface diagram illustrating interactive user interfaces for a transaction amount verification and a potential security issue, in accordance with one or more implementations.

FIG. 16 is a user interface diagram illustrating interactive user interfaces for a transferee address verification and a potential security issue, in accordance with one or more implementations.

FIG. 17 is a user interface diagram illustrating interactive user interfaces for a transferee address verification, in accordance with one or more implementations.

FIG. 18 is a user interface diagram illustrating interactive user interfaces for adjusting a setting indicating a condition for address verification, in accordance with one or more implementations.

FIG. 19 is a user interface diagram illustrating interactive user interfaces for a potential security issue and an automatic adjustment of a threshold for address verification, in accordance with one or more implementations.

FIG. 20 is a flow diagram illustrating a process for multi-factor authentication to improve distributed ledger asset transaction security, in accordance with one or more implementations.

FIG. 21 is a block diagram illustrating an example environment for providing an application and/or for customizing the application for different platforms, in accordance with one or more implementations.

FIG. 22 is a block diagram illustrating an example environment including a service provider system which may be associated with the server(s) of FIG. 21, in accordance with one or more implementations.

FIG. 23 is a block diagram illustrating a system for performing techniques described herein, in accordance with one or more implementations.

### DETAILED DESCRIPTION

Self-custody tools refer to techniques and devices to store, control, and manage cryptographic tokens in a safe and secure manner. Examples of self-custody tools include hardware or software wallets that store private keys, wallet applications that implement self-custody wallets, key devices that may be implemented using hardware to support cryptographic key storage, and so forth. Key devices, for instance, can add additional layers of security to a digital wallet through use of a sensor to uniquely identify an entity, and permit or restrict access to a cryptographic key (e.g., hardware key) maintained in an associated storage device through a control module. Key devices, for instance, are configurable as wallet hardware key devices that do not include a display device. In real-world scenarios, however, self-custody tools can be unfamiliar and appear complicated to casual entities (e.g., users) that have not gained specialized knowledge nor confidence in operation of these tools.

Among commonly accepted practices with hardware wallets is the use of relatively small hardware screens and buttons to mitigate attacks, often ineffectively. In practice, use of a hardware screens in real-world scenarios may involve squinting and peeking through prompt after prompt, comparing alphanumeric strings and other details between the screen on the hardware wallet and where the information is stored, typically offline on a paper. Hardware screens also add cost and complexity to a hardware wallet, that has a portable form factor. When this process results in a final decision to approve a transaction, the hardware wallet uses a respective private key to sign the transaction so that it will be accepted by a decentralized network (e.g., a blockchain network) onto the public ledger.

The irreversible nature of these transactions increases reliance on accurate verification as opposed to typical custodial banking transactions. For example, if the wrong inputs, such as addresses, are keyed on the screen or a wrong amount of funds is sent, the recipient has the sole resources to return the funds.

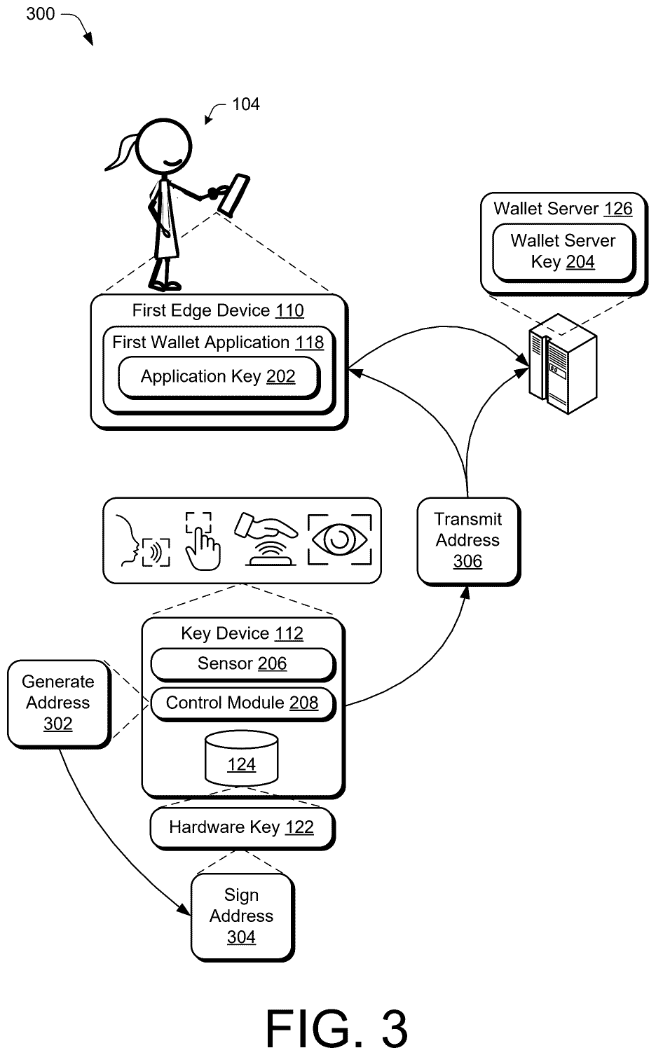

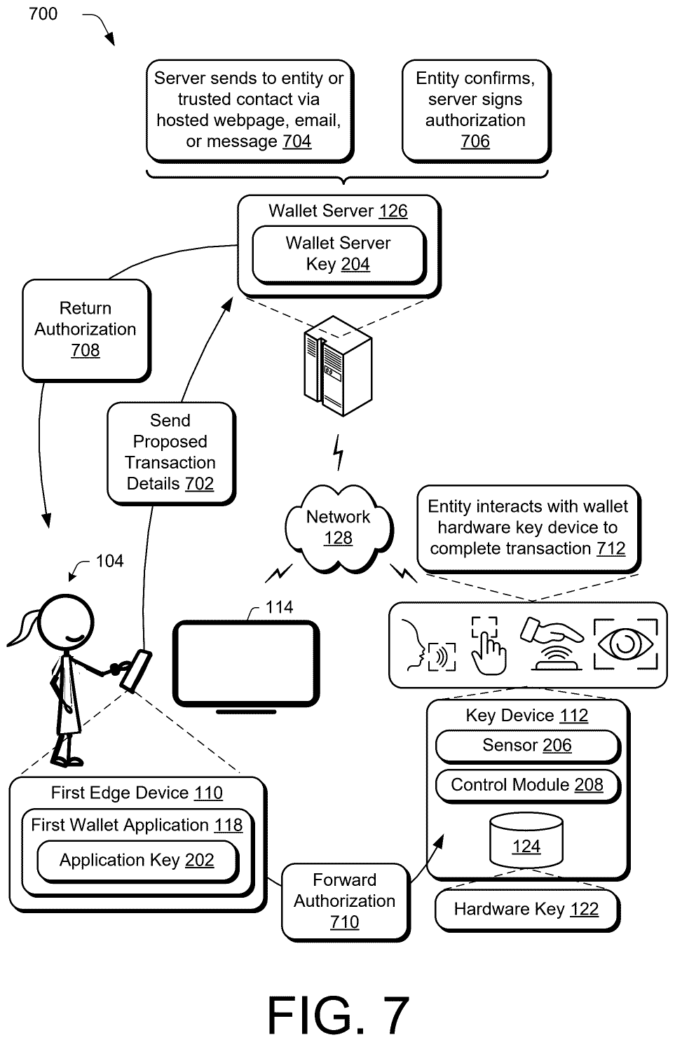

To address these and other technical challenges, techniques and systems are described that leverage use of a key device and supplemental display as part of transferring cryptographic tokens in a digital transaction. These techniques and systems support a comparison of details involved in the digital transaction (e.g., addresses, account names, amounts) using an independent device to protect against compromise by malicious parties. The comparison may be performed in a variety of ways. One or more initial examples involve use of a supplemental interface to confirm entry of the address and other details of the digital transaction as described in relation to FIGS. 3-6. One or more additional examples involve use of a supplemental interface to confirm entry by a wallet application which is then used to initiate a transfer by a key device as described in relation to FIGS. 7-11. The supplemental interface, for instance, is selectable by a wallet server (e.g., randomly) from a list of supplemental interfaces (e.g., devices) verified by the entity, a list of trusted contacts, and so forth.

In the one or more initial examples, an entity interacts with a key device (e.g., a hardware key device) and enters details of a digital transaction that is to involve transfer of one or more cryptographic tokens, e.g., to be received by the entity or transferred from the entity. The details may include an address that is to participate in the digital transaction, amount of cryptographic tokens involved in the transaction, and so forth. The address and other details are then signed by the key device for authorizing a transfer of cryptographic tokens. The key device maintains a database of which wallet application keys and server keys it can collaborate with to sign transactions, allowing the key device to generate a receive address without inputs from the wallet application.

The signed address is received from the key device at an edge device, e.g., a mobile phone associated with the entity. In an implementation, inputs are received at the edge device through execution of a wallet application that specifies a supplemental interface that is to be used to confirm the details. The supplemental interface, for instance, is selectable via a user interface using a dropdown menu or other functionality, e.g., an IP address or other “pairing” technique.

The details of the digital transaction (e.g., the signed address) are then transmitted by the wallet application executing on the edge device to a wallet server, e.g., via the internet. Other implementations are also contemplated in which the key device transmits the address and other details of the digital transaction directly to the wallet server.

The wallet server, upon receipt of the transmission, is configured to verify that the signed address originated from the key device. To do so, in one implementation, the wallet server checks as to whether the signed address is signed with the private key of the key device based on a comparison with a public key of the key device. In another implementation, the wallet server executes such checks by comparing with past transaction history involving the sending and receiving address, edge devices, and other such information. In yet another implementation, the wallet server may be instructed (e.g., by the user via the key device) to attest any transaction meeting certain attributes, e.g., above a certain amount or for a certain period, without any additional checks. Once verified, the wallet server establishes a communication with the supplemental interface associated with the edge device, which is encrypted. Continuing with the previous examples, the communication is transmitted based on identification of the supplemental interface at the edge device, through association with an account of the entity maintained at the wallet server (e.g., in support of direct communication between the key device and the wallet server), and so forth.

The supplemental interface displays the communication in a user interface. The communication includes a representation of the address that is to receive the cryptographic tokens, an amount of the cryptographic tokens, and so forth. The user interface also includes an option that is selectable to generate a confirmation to authorize the transfer. Selection of the option causes the supplemental interface to communicate the confirmation back to the wallet server.

The wallet server receives the confirmation from the supplemental interface, and in response, permits the transfer of the cryptographic tokens as part of the digital transaction using the address and other details. In this way, the supplemental interface is configurable to address technical challenges and protect against compromise by malicious parties, further discussion of which may be found in relation to FIGS. 3-6.

In one or more additional examples, a supplemental interface for a key device is used in support of a digital wallet to perform a digital transaction. The system further includes an edge device, a wallet server, and a key device. The edge device sends proposed transaction details to the wallet server, which then sends the details to a supplemental interface. The entity that is associated with the supplemental interface (e.g., owner or trusted contact) views the proposed transaction details and, if accurate, confirms the details. The web server then generates a signed authorization confirming the transaction details, which is sent to the edge device. The edge device forwards the signed authorization to the key device. Once the key device receives the authorization and verifies the authorization was sent from the web server (e.g., through public/private key verification), the key device enables completion of the digital transaction to transfer the cryptographic tokens. Thus, in this example a supplemental interface is used to confirm entry by a wallet application which is then used to initiate a transfer by a key device.

As described in each of the examples above, supplemental use of a display device in conjunction with a key device supports a variety of functionalities. In initial examples of FIGS. 3-6, for providing receive addresses to a sender either in person or via multiple platforms/channels that the sender can compare. In additional examples of FIGS. 7-11, for verifying outgoing transaction details, specifically on a device that was not used to supply the key device with the transaction details in the first place. Other examples are also described in the following sections for protecting against mobile malware from silently manipulating outgoing transaction parameters which is also not capable of sufficiently manipulating the phone's display.

For example, verification of the transaction may be performed on a server in which “stringified” text is sent to an edge device that is then transmitted into an application (e.g., hosted remotely). A user, for instance, initiates a transaction and signs the transaction using a key device, which is then sent to a wallet server. The wallet server signs the transaction and is returned to the edge device, which is then transmitted locally (e.g., “airdropped”) to a supplemental interface, which then communicates with a remotely executed application to verify. In another example, a user initiates a transaction and a supplemental interface is paired with a web server and shares a public key. The web application sends the transaction to the web server, which is encrypted. The supplemental interface is then used to confirm the transaction and send a confirmation back to the web server. The web server signs the transaction along with the signature. The key device is then used to validate and sign the transaction.

In some cases, transactions involving transfers of digital assets (e.g., cryptocurrency) can face issues related to transfers of incorrect amounts of digital assets, and/or transfers of the digital assets to an incorrect address/recipient. In some examples, such issues can be caused by mistakes in entry of amounts and/or addresses. In some examples, such issues can be caused by security issues, for instance by malicious parties (e.g., attackers) sending unauthorized transaction requests, or modifying authorized transaction requests in unauthorized ways.

The systems and methods disclosed herein can implement a multi-factor authentication that can prevent issues in transactions, whether caused by mistakes or security issues. The multi-factor authentication can enhance the security of distributed ledger asset transactions by using multiple forms of verification before a transaction is approved. This approach mitigates the risk of unauthorized access, mistakes in transactions, and/or suspicious network activity (e.g., attempts to initiate potentially fraudulent transactions) by ensuring, in multiple ways, that amounts (to be transferred) and addresses (of parties to the transaction) are correct. The systems and methods disclosed herein also provide improved user interfaces that are interactive and provide easy-to-implement ways to improve security (e.g., even with mobile devices of low complexity). For instance, the interactive user interfaces can allow users to verify the accuracy of the transaction details, such as the amount of the digital asset and/or the address of the transferor, before proceeding. If the details are incorrect, the system outputs a security alert and cancels or prevents erroneous or malicious transactions.

Multi-factor authentication of addresses presents several technical problems, including security vulnerabilities and user interface challenges. By making the transaction contingent on verification and/or authentication of the amount of the digital asset and/or the address of the transferee account through separate interactive user interfaces, the system ensures that different aspects of the transaction are authenticated independently. This layered approach to verification reduces the likelihood of errors and enhances the overall security of the transaction process. Furthermore, the systems and methods disclosed herein provide for improved security through dynamic adjustments to security thresholds (e.g., where transfers of amounts exceeding a verification threshold are subject to increased verification and/or other security measures) based on potential security issues. For instance, the authentication system can automatically lower the verification threshold in response to detected security threats, thereby providing an adaptive security mechanism that dynamically and proactively monitors, responds to, mitigates, and/or remediates security issues (e.g., unauthorized transactions). This enhances security by proactively safeguarding access to account(s) and/or digital assets, potentially canceling a pending transaction and increasing verification procedures for future transactions (e.g., by reducing the verification threshold, which is the threshold that triggers verification of a transaction) in response to any suspicious activity (e.g., potential security issues). The systems and methods disclosed herein thus provide robust security enhancements and effectively address technical problems related to transaction verification and user interface design. By implementing multiple layers of authentication and adaptive security measures, the system provides a secure and easy-to-use solution for managing distributed ledger asset transactions.

In some examples, the systems and methods disclosed herein can include performance of multi-factor authentication for a transfer. For instance, in some examples, an authentication system (e.g., a mobile device, a server) can receive a request for a transfer of an amount of a digital asset from a transferor account to a transferee account. The authentication system can receive a first input through a first interactive user interface (UI). The first interactive UI identifies at least a portion of the amount of the digital asset. The first input verifies that at least the portion of the amount of the digital asset is correct. The first input represents a first factor of authentication for the transfer. The authentication system can receive a second input through a second interactive UI. The second interactive UI identifies a first subset of alphanumeric characters of an address corresponding to the transferee account. The second input identifies a second subset of alphanumeric characters of the address corresponding to the transferee account. The authentication system can verify that the second input matches the second subset of the address. The second input represents a second factor of authentication for the transfer. The authentication system can initiate the transfer of the amount of the digital asset from the transferor account to the transferee account in response to multi-factor authentication via the first factor of authentication and the second factor of authentication.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

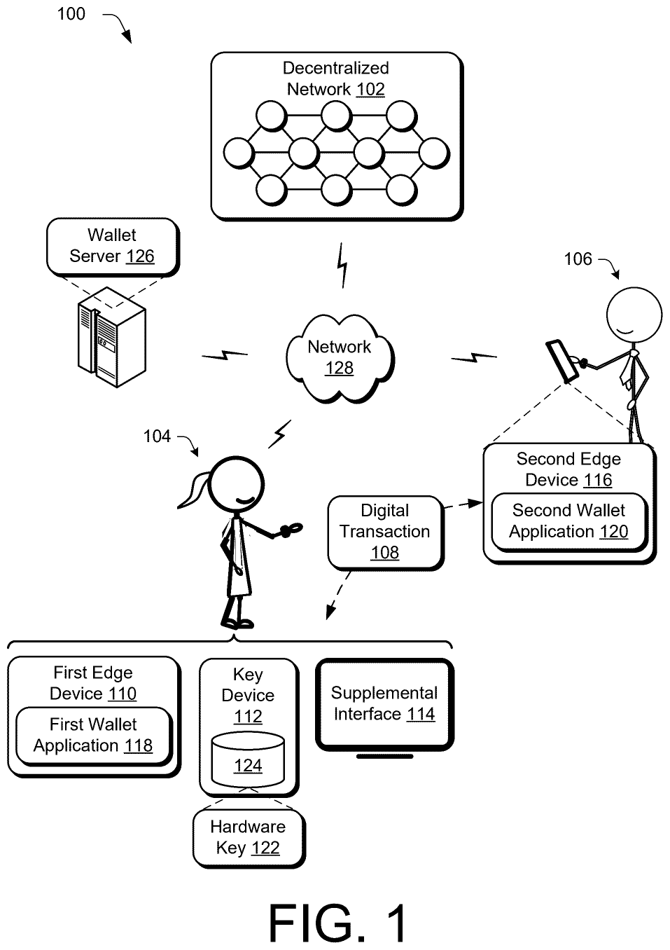

FIG. 1 is a block diagram of a non-limiting example environment 100 of key device and supplemental display use as described herein in accordance with one or more implementations. The environment 100 includes a decentralized network 102, a first entity 104 and a second entity 106 that are to participate in a digital transaction 108, e.g., to transfer one or more cryptographic tokens via the decentralized network 102. The first entity 104 is associated with a variety of devices, illustrated examples of which include a first edge device 110, a key device 112, and a supplemental interface 114. The second entity 106 is depicted as associated with a second edge device 116.

Computing devices that implement the environment 100 and the devices within the environment 100 are configurable in a variety of ways. A computing device, for instance, is configurable as a server, a desktop computer, a laptop computer, a mobile device (e.g., assuming a handheld configuration such as a tablet or mobile phone), an IoT device, a wearable device (e.g., a smart watch), an AR/VR device, and so forth. Thus, a computing device ranges from full resource devices with substantial memory and processor resources to low-resource devices with limited memory and/or processing resources. Although in instances in the following discussion reference is made to a computing device in the singular, a computing device may also represent any number of different computing devices, such as multiple servers of a server farm utilized to perform operations “over the cloud” as further described below.

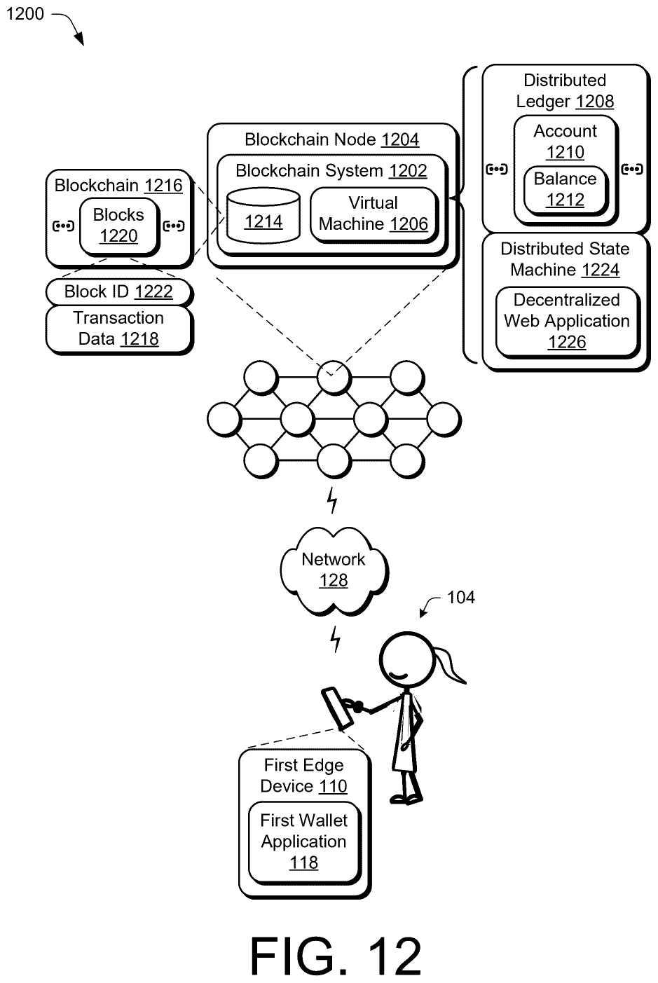

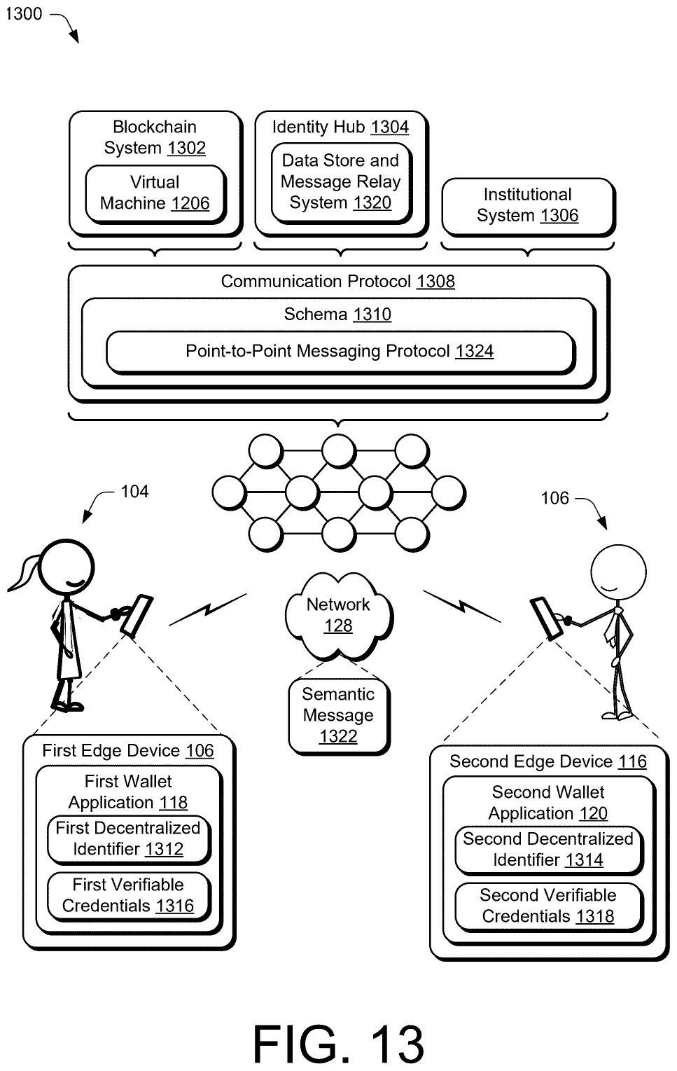

The first edge device 110 has executing thereon a first wallet application 118 and the second edge device 116 has executing thereon a second wallet application 120. The first and second wallet applications 118, 120 respectively, permit access to the decentralized network 102, e.g., a blockchain network and/or “layer 2” network that is built “on top” of a blockchain network as further described in relation to FIGS. 12 and 13.

The key device 112 is configurable to maintain a hardware key 122 in a storage device 124 that is local to the key device 112. The key device 112 is configurable to add additional layers of security to a digital wallet. The key device 112, for instance, is configurable to receive inputs that are usable to uniquely identify the first entity 104 to permit or restrict access to the hardware key 122 maintained in the storage device 124, e.g., as encrypted.

The environment 100 also includes a wallet server 126. The wallet server 126 is configurable by a third party separate from the first entity 104. The wallet server 126 supports functionality to interact with the decentralized network 102. The wallet server 126, for instance, is configured to route the digital transaction 108 using the decentralized network 102 on behalf of the first and second entities 104 106, e.g., by cryptographically signing the digital transaction 108 and interacting with nodes of the decentralized network 102. A network 128 (e.g., the Internet) is illustrated as communicatively coupling the decentralized network 102, first edge device 110, second edge device 116, and/or wallet server 126, either directly or indirectly. The network 128 is also representative of one or more networks, e.g., local area networks, near field communication networks, the Internet, and so on. The key device 112, for instance, is communicatively coupled to the first edge device 110 locally (e.g., via near field communication) to communicate with the decentralized network 102 via the network 128.

In one implementation and in case of a transaction between a first user and a second user, the key device 112 can cryptographically sign information and the first edge device 110 can forward that signature to wallet server 126. The wallet server 126 compares the received signature against potential malware and stored information to verify the information was not modified in transit by the edge device, even if their edge device is compromised by malware. Conversely, the wallet server 126 can sign information that can be verified by key device, e.g., by comparing received information with stored information, ensuring that a compromised edge device didn not tamper with information sent from wallet server 126 to key device 112. With the ability to send data securely between wallet server 126 and key device 112, the present methods and systems potentially use the server to do something the hardware cannot in one or more implementations: communicate detailed transaction information like destination address, fees, and amounts directly to users. That is, after receiving information like transaction details and receive addresses from the key device 112, the wallet server 126 communicates the information, along with guidance about how to safely verify it, to a user via communication channels like email, a webpage, or even one to one of their trusted contacts through the recovery module (discussed later). In one example, the guidance can also include flags in case the wallet server detects potential malware or other attack feature introduced by the edge devices.

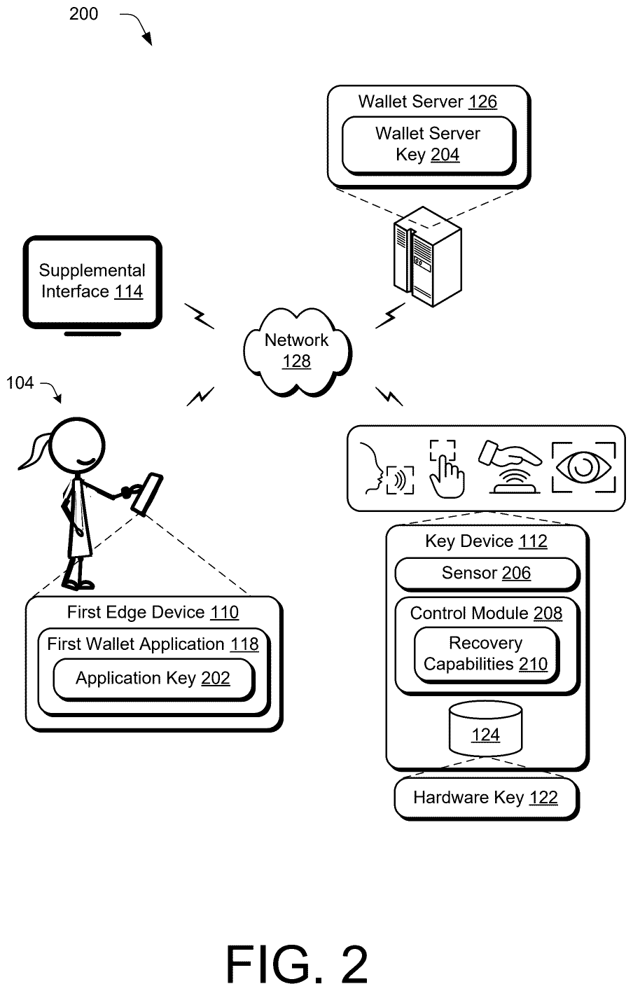

FIG. 2 is a block diagram of a non-limiting example environment 200 showing operation of devices associated with the first entity 104 of FIG. 1 in greater detail in accordance with one or more implementations. The non-limiting example environment 200 is operable to implement security mechanisms using cryptographic keys in support of a digital wallet as described herein according to an implementation of the present subject matter.

Implementation of a digital wallet is achieved in this example through use of the first wallet application 118, the key device 112, and a wallet server 126. Each of these entities includes a respective cryptographic key that is usable to authorize a resource transfer using a multi-party computation (MPC) security technique. The key device 112, for instance, includes a hardware key 122 as previously described. The first wallet application 118 includes an application key 202 and the wallet server 126 includes a wallet server key 204.

The three parts of the digital wallet have different permissions and are optionality built-in to allow the first entity 104 to use self-serve tools in a way that fits with corresponding desires and supports variation across different geographic settings. The first wallet application 118 is operable as a mobile application executed on the first edge device 110 (e.g., a mobile phone of the first entity 104) that outputs a user interface to enable the first entity 104 to safely own and manage cryptographic tokens, while finding partners in order to buy/sell/convert between fiat currencies and cryptographic currencies.

In an implementation, the wallet server 126 further includes functionality of a decentralized service provider that runs as a node that peers directly with a node that is executed as part of a digital wallet on an edge device. The wallet server 126 is configured to route payments on the entity's behalf through the decentralized network 102 of FIG. 1, e.g., a blockchain network. Accordingly, the wallet server 126 may be executed as part of the decentralized network 102 or separately by a third-party system. Signing and transaction features are implemented by the wallet server 126.

The key device 112 is implemented to add additional layers of security as part of the digital wallet. The key device 112, for instance, includes a sensor 206 that is configured to receive inputs that are usable to uniquely identify the first entity 104, e.g., via biometric inputs, spoken utterance, a PIN a fingerprint scanner, palm reading, eye reading, and so forth. Inputs received via the sensor 206 are used by a control module 208 to permit or restrict access to the hardware key 122 maintained in the storage device 124. The control module 208 also includes recovery capabilities 210, e.g., in case the first entity 104 loses the first edge device 110 and therefore access to the first wallet application 118.

The key device 112, for instance, can be configured to prove ownership of corresponding hardware (e.g., the first edge device 110) which is then usable to provision the application key 202 and first wallet application 118 on the first edge device 110. A fingerprint sensor, for example, of the key device 112 is usable to authenticate the identity of the first entity 104. Authentication is performed in this instance before the key device 112 interacts with a near-field-communication (NFC) field of the first edge device 110 to sign a transaction with the application key 202 in the first wallet application 118. In another example, a PIN is entered using the first wallet application 118 and is then communicated using NFC to the key device 112 to unlock the device.

The digital wallet secures funds through use of the application key 202, the wallet server key 204, and the hardware key 122. In a multi-party computation (MPC) (e.g., “two-of-three”) security mechanism, two out of the three keys are utilized to permit a fund transfer as part of a transaction, i.e., by signing the transaction. This security mechanism is enforced by the decentralized network 102. Access to these keys is protected by corresponding access mechanisms. For the application key 202, for instance, access is protected through access techniques used to access the first edge device 110 itself and may also include a PIN or passphrase. For the hardware key 122, access is protected through use of the sensor 206 and control module 208, e.g., using biometric techniques of the key device 112 in which data identifying the first entity 104 is maintained locally and not exposed outside of the device. For the wallet server key 204, this key is maintained by a wallet server 126, e.g., by a third party separate from the first entity 104. Consequently, as a “two-of-three” security mechanism, transfers of cryptographic tokens as part of a digital transaction are permitted without the wallet server 126 and corresponding wallet server key 204 through use of the application key 202 and the hardware key 122.

In an example of a transaction involving a relatively small amount of funds, a transaction is initiated by the first wallet application 118, which is then signed by the wallet server key 204. As such, the first entity 104 is able to perform the transaction while keeping the key device 112 “safely tucked away” as reserved for the recovery capabilities 210 and/or for relatively larger transactions, e.g., above a transaction limit as set by the first wallet application 118 and enforced by the wallet server 126.

Access to the hardware key 122 in the key device 112 is protected (e.g., by biometric data or PIN) and acts as but one part of the digital wallet. Another part of the digital wallet is implemented by the first wallet application 118. Both the first wallet application 118 and the key device 112 are configurable to work together in physical proximity (e.g., via NFC) to move larger amounts of funds, e.g., an amount that is over a transaction limit.

The digital wallet is also configurable to specify that both the first wallet application 118 and application key 202 as well as the key device 112 and hardware key 122 are to be used for each transaction, regardless of size, for additional security. On the other hand, the digital wallet is also configurable to permit any size of transaction without use of the key device 112. The key device 112 in this scenario is then used to recover keys in case the first edge device 110 and corresponding first wallet application 118 are lost through use of the recovery capabilities 210.

Through use of the multi-party computation (MPC) (e.g., “two-of-three”) security mechanism, a third party (e.g., associated with the wallet server 126) is not able to transfer funds, rather the first entity 104 is given true ownership as having two of the three keys. The wallet server key 204 is usable by the wallet server 126 to cooperate in wallet recovery (e.g., in case the first edge device 110 or key device 112 is lost) or sign transactions initiated by the first wallet application 118 and signed using the application key 202.

If the first edge device 110 is lost, the digital wallet is recoverable using the first wallet application 118 as executed on a new edge device and the key device 112. The first entity 104, for instance, unlocks the key device 112 using a fingerprint or PIN to expose the hardware key 122. If the key device 112 is lost (alone or along with the first edge device 110), the digital wallet is recoverable based on security settings defined by the first entity 104 when setting up the digital wallet.

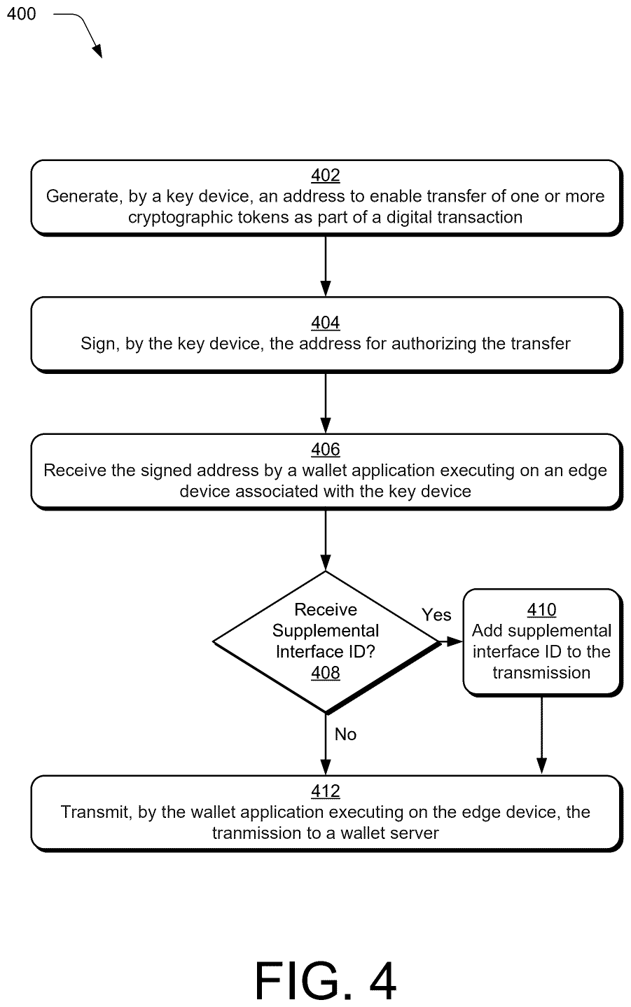

FIG. 3 is a block diagram of a non-limiting example environment 300 showing operation of devices associated with the first entity 104 of FIG. 1 including a key device and a first edge device in greater detail as generating transaction details and transmitting the transaction details in accordance with one or more implementations. FIG. 4 is a flow diagram depicting a step-by-step procedure 400 in an example implementation of operations performable by a processing device for accomplishing a result of entry of details of a digital transaction involving a transfer of cryptographic tokens by a key device and transfer of those details to a wallet server. The following discussion refers, interchangeably, to FIGS. 3 and 4.

To begin in this example, an address is generated by a key device to enable transfer of one or more cryptographic tokens as part of a digital transfer (blocks 302, 402). An entity, for example, interacts with a key device 112 (e.g., a hardware key device) and enters details of a digital transaction that is to involve transfer of one or more cryptographic tokens, e.g., to be received by the entity or transferred from the entity. The details may include an address that is to participate in the digital transaction, amount of cryptographic tokens involved in the transaction, and so forth.

To do so, for instance, the first entity 104 is authenticated for access to the key device 112 (e.g., using sensors 206) to provide credentials such as to input a password, biometric data, spoken utterance, and so forth. Once authenticated. The first entity 104 interacts with a hardware input device disposed on the key device 112 (e.g., using sensors 206) to input the address as an intended participant in a digital transaction involving cryptographic tokens. Once entered, the address is signed (blocks 304, 404) by a hardware key 122 (e.g., a private cryptographic key) of the key device 112 that is maintained securely in storage device 124 local to the key device 112 (e.g., encrypted) and not exposed “outside” of the key device 112.

The key device 112 is then configured to transmit the signed address (and other transaction details when applicable such as transaction amount) to the wallet server 126, which may be performed directly and indirectly via the first edge device 110 (block 306). In an example in which the transmission is performed to the first edge device 110, the signed address is received from the key device 112 at the first edge device 110 associated with the key device 112 (block 406), e.g., using near field communication. The first edge device 110 and the key device 112 are “paired” in this example to implement secure communication between the two devices, e.g., using encrypted communications.

In an implementation, inputs are received at the first edge device 110 through execution of a wallet application 118 that specifies a supplemental interface 114 that is to be used to confirm the details. The supplemental interface 114, for instance, is selectable via a user interface using a dropdown menu as illustrated in FIG. 9 or other functionality, e.g., an IP address or other “pairing” technique. As a result, the first entity 104 is given a degree of control as to “how” confirmation of the transfer of cryptographic tokens as part of the digital transaction is performed. The transaction details, including the signed address and the supplemental interface identifier (ID) are then transmitted by the first edge device 110 to the wallet server 126 via the network 128, which may also be secured using cryptographic techniques to protect against compromise by malicious parties.

A determination is then made by the first wallet application 118 of the first edge device 110 as to whether a supplemental interface ID is received (decision block 408). If so (“yes” from decision block 408), the supplemental interface ID is included as part of a communication to be transmitted to the wallet server 126. If not (“no” from decision block 408) or in an instance in which the supplemental ID has been added to the transmission (block 410), the transmission is transmitted by the first wallet application 118 executed on the first edge device 110 to the wallet server 126 (block 412). Accordingly, in these examples the details of the digital transaction (e.g., the signed address) are then transmitted by the first wallet application 118 at the first edge device 110 to a wallet server 126. Other implementations are also contemplated in which the key device 112 transmits the signed address and other details of the digital transaction directly to the wallet server 126. The wallet server 126 then continues processing of the transaction as further described in the following example and shown in corresponding figures.

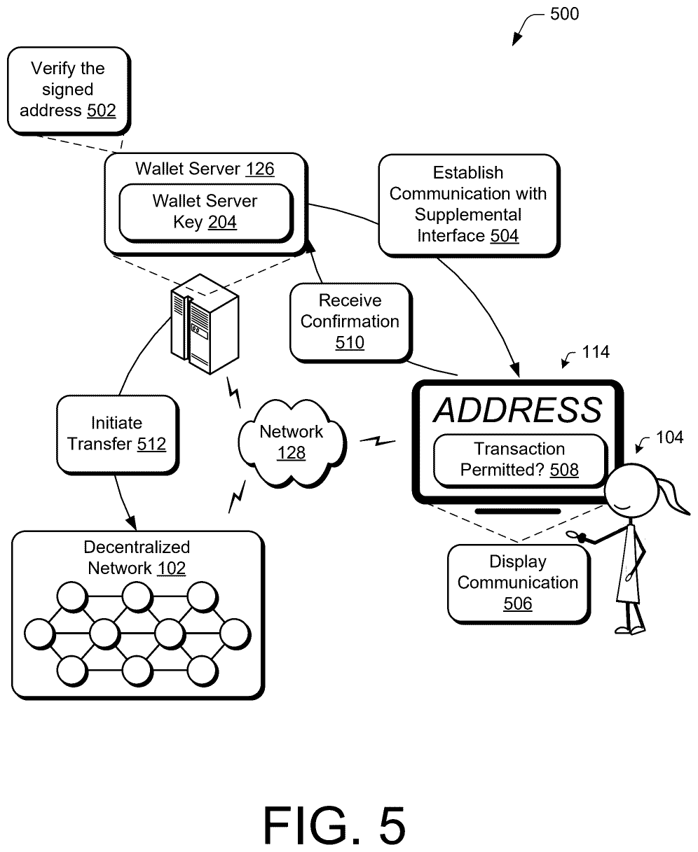

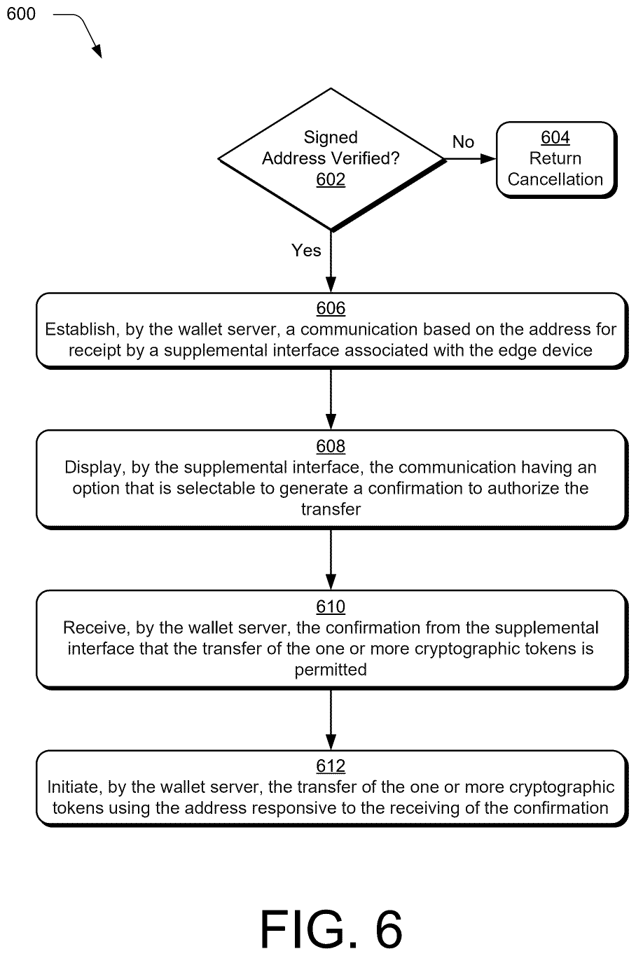

FIG. 5 is a block diagram of a non-limiting example environment 500 showing receipt by a wallet server of the transaction details of FIG. 3 and initiation of a transfer of cryptographic tokens as part of a digital transaction responsive to confirmation by a supplemental interface in accordance with one or more implementations. FIG. 6 is a flow diagram depicting a step-by-step procedure 600 in an example implementation of operations performable by a processing device for accomplishing a result of initiation of a transfer of cryptographic tokens responsive to receipt of a confirmation from a supplemental interface in accordance with one or more implementations. The following discussion refers, interchangeably, to FIGS. 5 and 6.

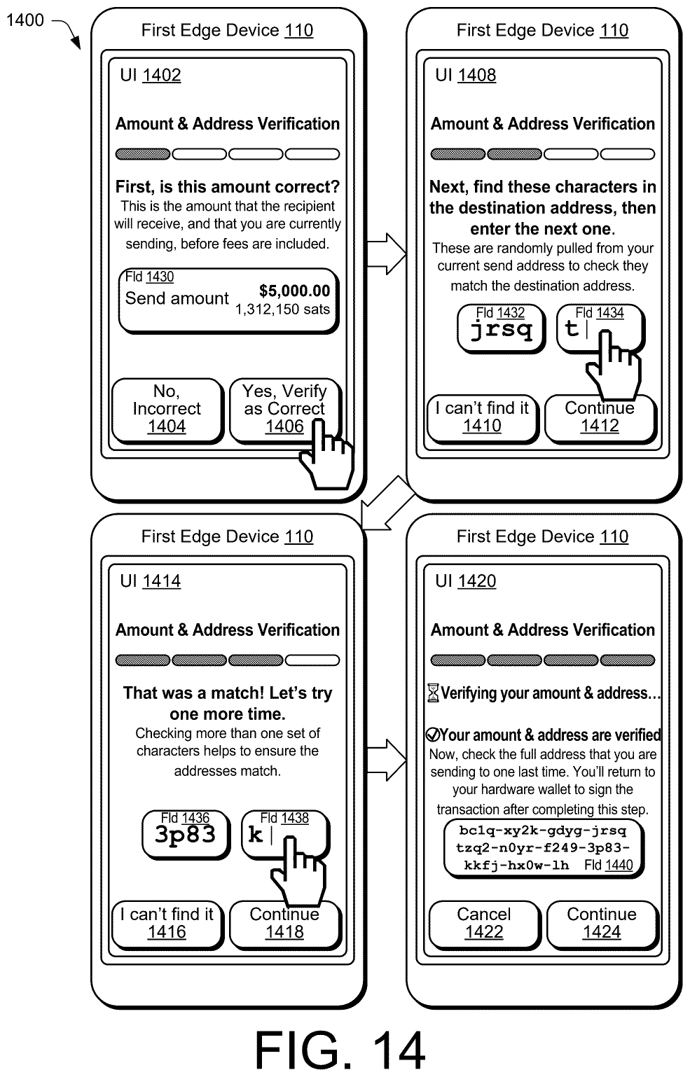

The wallet server 126, upon receipt of the transmission (e.g., from the first edge device 110 and/or the key device 112), is configured to verify whether the signed address originated from the key device 112 (block 502, decision block 602). To do so, the wallet server 126 checks as to whether the signed address is signed with the private key of the key device 112 based on a comparison with a public key of the key device 112. In some examples, the address verification of decision block 602 can be based on an interactive interface in which a first portion of the address is output (e.g., displayed) and a second portion of the address (e.g., next character(s) in the address) a requested for input, as in the user interface 1408 and/or the user interface 1414 of FIG. 14. If verification fails (“no” from decision block 602), a cancellation is returned (block 604) by the wallet server 126 to the first edge device 110 and/or the key device 112.

If the verification of the signed address at decision block 602 is successful (“yes” from decision block 602, for instance indicating that the signed address is confirmed to have originated from the key device 112), the wallet server 126 establishes a communication with the supplemental interface 114 associated with the edge device (e.g., at block 504 and/or block 606). Continuing with the previous examples, the communication is transmitted based on identification of the supplemental interface 114 at the first edge device 110, through association with an account of the first entity 104 maintained at the wallet server 126 (e.g., in support of direct communication between the key device and the wallet server), and so forth. The wallet server 126, for instance, may maintain a user account associated with the first entity 104. The user account includes a listing of supplemental interfaces that have been verified, through interaction with the first entity 104, as being permitted to confirm the transaction.

The supplemental interface 114 then displays the communication (block 506) in a user interface. The communication includes a representation of the address that is to receive the cryptographic tokens, an amount of the cryptographic tokens, and so forth. The user interface also includes an option 508 that is selectable to generate a confirmation to authorize the transfer (block 608). Selection of the option 508 causes the supplemental interface 114 to communicate the confirmation back to the wallet server.

The wallet server 126 receives the confirmation from the supplemental interface 114 (block 510, block 610), and in response, initiates the transfer of the cryptographic tokens (block 512) as part of the digital transaction using the address and other details (block 612) e.g., through interaction with the decentralized network 102 such as a blockchain. In this way, the supplemental interface 114 is configurable to address the previously described technical challenges and protect against compromise by malicious parties. In some examples, the wallet server 126 returns an approval to a wallet application 118 (e.g., on the first edge device 110) before initiating the transfer of the cryptographic tokens (e.g., before broadcasting a signed transaction to the decentralized network 102), for instance as in block 1116). In some examples, the wallet server 126 provides a signature itself before initiating the transfer of the cryptographic tokens (e.g., before broadcasting a signed transaction to the decentralized network 102).

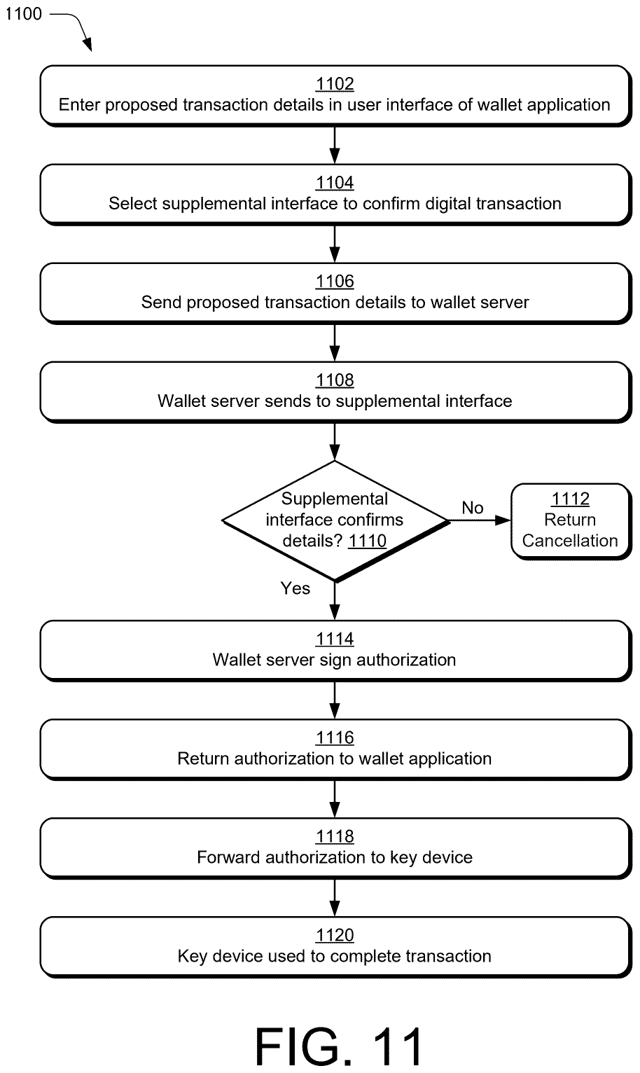

FIG. 7 is a block diagram of a non-limiting example environment 700 showing generation of transaction details on an edge device and confirmation of the details by a supplemental interface for initiating a digital transaction involving a transfer of cryptographic tokens accordance with one or more implementations. FIG. 11 is a flow diagram depicting a step-by-step procedure 1100 in an example implementation of operations performable by a processing device for accomplishing a result of initiation of a transfer of cryptographic tokens responsive to receipt of a confirmation from a supplemental interface responsive to generation of the transaction details by an edge device in accordance with one or more implementations. The following discussion refers, interchangeably, to FIGS. 7 and 11.

In these additional examples, a supplemental interface 114 associated with a key device 112 is also used in support of a digital wallet to perform a digital transaction. However, in this scenario the transaction details are entered at an edge device, confirmed by a supplemental interface, and once confirmed the edge device causes a key device to perform the transaction.

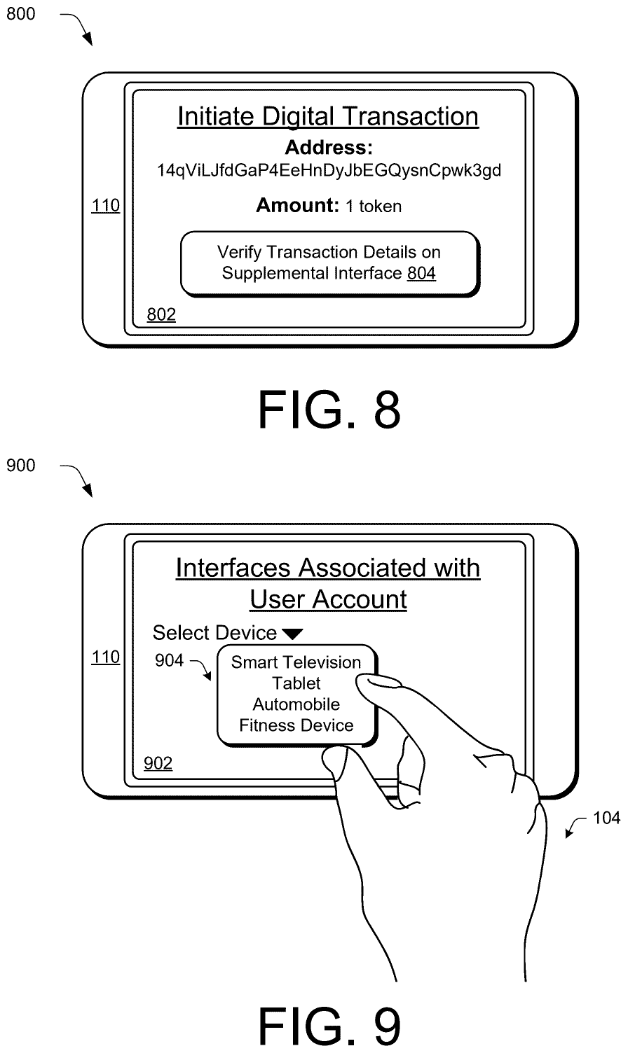

Proposed transaction details, for instance, are entered in a user interface of a first wallet application 118 (block 1102) executed by a first edge device 110. FIG. 8 depicts an example implementation 800 showing output of a user interface 802 by the first edge device 110 in support of entry of transaction details accordance with one or more implementations. The user interface 802 includes options to initiate a digital transaction, including an address that is to participate in the digital transaction and an amount. The user interface 802 further includes an option 804 that is user selectable via an input received thru the user interface 802 to verify transaction details on a supplemental interface.

A supplemental interface 114 is also selected via execution of the first wallet application 118 by the first edge device 110 to confirm the digital transaction (block 1104). FIG. 9 depicts an example implementation 900 showing output of a user interface 902 by the first edge device 110 in support of entry of a supplemental interface 114 that is to confirm transaction details in accordance with one or more implementations.

In this example, the user interface 902 is prepopulated with one or more supplemental interfaces that have been vetted through interaction with the first entity 104 for use in confirming a transaction. The user interface 902 includes options 904 including representations of the supplemental interfaces that are selectable to specify “which one” is to be used for confirmation in this particular instance, thereby further protecting against compromise by malicious parties. Accordingly, the user interface 902 supports inputs received via the first entity 104 to select a particular supplemental interface to be used for confirmation.

Returning again to FIG. 7, the first edge device 110 sends proposed transaction details to the wallet server 126 (block 702, block 1106) via the network 128. The wallet server 126 is then configured to send the transaction details to the supplemental interface 114 (block 1108) specified by the first edge device 110, e.g., to the first entity 104 or trusted contact via a custom webpage, email, or message (block 704). For example, the wallet server can generate a link to share with an intended recipient, e.g., edge device, to view the receive address and confirm that the address is correct.

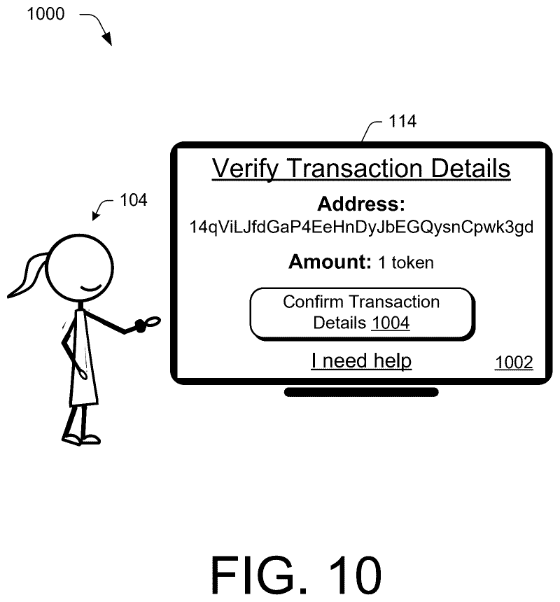

FIG. 10 depicts an example implementation 1000 showing output of a user interface 1002 by a supplemental interface 114 as displaying transaction details and an option 1004 that is user selectable by the first entity 104 to confirm transaction details accordance with one or more implementations. The supplemental interface 114 displays the transaction details in a user interface 1002, which includes an address and an amount.

The user interface 1002 further includes an option 1004 that is user selectable to confirm the transaction details. The first entity 104 that is associated with the supplemental interface 114 (e.g., or trusted contact), for instance, views the proposed transaction details via the user interface 1002 and, if accurate, confirms the details through selection of the option 1004. The user interface 1002 also includes an option “I need help” that is selectable to surface additional information involving the digital transaction, how the transaction is to be implemented, and so forth.

Returning again to FIG. 7, a determination is made at the wallet server 126 as to whether the supplemental interface 114 has confirmed the transaction details (decision block 1110). If the confirmation is not received (“no” from decision block 1110), a cancellation is returned by the wallet server 126 (block 1112) to the edge device 112. If the confirmation is received (“yes” from decision block 1110), the web server then generates a signed authorization confirming the transaction details (block 706, block 1114). The signed authorization is then returned by the wallet server 126 to the first wallet application 118 (block 708, block 1116) executed by the first edge device 110. In this illustrated example, the first edge device 110 forwards the signed authorization to the key device 112 (block 710, block 1118), e.g., via near field communication (NFC).

Once the key device 112 receives the authorization and verifies the authorization was sent from the web server (e.g., through public/private key verification), the key device 112 enables completion of the digital transaction to transfer the cryptographic tokens (block 1120). The key device 112, for instance, supports user interaction with the first entity 104 to enable the key device 112 to sign an authorization to complete the transaction (block 712). Thus, in this example a supplemental interface is used to confirm entry by a wallet application which is then used to initiate a transfer by a key device. Other examples are also contemplated.

FIG. 12 is a non-limiting example environment 1200 showing operation of a blockchain node 1204 as part of a blockchain system 1202 as an example of a decentralized network 102 of FIG. 1 in accordance with one or more implementations. The blockchain system 1202 implements a virtual machine 1206 that is representative of a diverse range of functionality made possible by leveraging a blockchain. In a first such example, the virtual machine 1206 implements a 1208 of accounts 1210 and associated balances 1212 of those accounts 1210. Distributed ledgers 1208 support secure transfer of digital assets (e.g., tokens or coins of cryptocurrencies) between accounts 1210. The secure transfer is performable without management by a central authority through storage (illustrated as storage 1214) by blockchain nodes 1204 implementing a blockchain 1216 of the blockchain system 1202 as part of transaction data 1218. The transaction data 1218 is maintained as part of blocks 1220 (and associated block IDs 1222) of the blockchain 1216.

Through synchronized and distributed access supported by the blockchain 1216, changes to balances 1212 (e.g., a number of tokens) are visible to any entity with access to the blockchain 1216. Techniques are also implemented to support management of the balances 1212 across the accounts 1210, e.g., to enforce rules that a respective account 1210 does not transfer more tokens than are available based on a balance 1212 specified for that account 1210.

In another example, the virtual machine 1206 implements a distributed state machine 1224 that supports execution of a decentralized web application 1226. The distributed state machine 1224 is implemented along with the transaction data 1218 within the blocks 1220 of the blockchain 1216 such that the blocks 1220 describe accounts and balances as described above for the distributed ledger 1208. The transaction data 1218 also supports a machine state, which can change from block to block of the blockchain 1216. In one example, the decentralized web application 1226 is executable as part of a “Turing-complete” decentralized virtual machine that is distributed across the blockchain nodes 1204 of the blockchain. As Turning-complete, the decentralized web application 1226 is computationally universal to perform computing device operations, e.g., logic or computing functions. Thus, the decentralized web application 1226 is executable by a processing system as software that is storable in a computer-readable storage medium of the blockchain nodes 1204 to perform a variety of operations.

An example of the decentralized web application 1226 is executable automatically and without user intervention (or with partial human interaction wherein desired) by the blockchain nodes 1204 of the distributed state machine 1224. Execution of the decentralized web application 1226 includes obtaining data from a specified data source (e.g., devices, APIs, and so forth that are accessible via the network 128), and based on the data, initiating one or more operations based on conditions described in the decentralized web application 1226.

In order to publish blocks for addition to the blockchain 1216, a blockchain node 1204 may be implemented as a “miner” to add a block of transactions to the blockchain 1216. In one or more implementations, other blockchain nodes 1204 may communicate transactions received at those nodes to one or more mining nodes for validation. Mining nodes may perform peer-to-peer computations to check if transactions intended for the blockchain 1216 are valid and, if validated, may add validated transactions to a block 1220 that those blockchain nodes are building. If the transactions are determined to be valid, for instance, then the transaction data 1218 describing those transactions is encoded in or otherwise stored on a respective block 1220, which is linked to the blockchain 1216 such that the new block is “at the end” or “at the top” of the blockchain 1216, e.g., through inclusion of a hash of a previous block in the chain.

The blockchain nodes 1204 then broadcast this transaction history via the decentralized network 102 for sharing with other blockchain nodes. This acts to synchronize the blocks 1220 of the blockchain 1216 across the distributed architecture of computing devices. A variety of “types” of blockchain nodes 1204 may be used to implement the blockchain 1216. By way of example, the blockchain 1216 may be implemented at least in part using “full” blockchain nodes, which are nodes that store an entirety of the blockchain 1216, e.g., locally in computer-readable storage media of respective computing devices of the blockchain nodes. Other types of blockchain nodes may also be employed to implement additional functionality, such as for governing voting events, execution of protocol operations, rules enforcement, and so forth.

The blockchain 1216 may be leveraged to provide a diverse range of functionality. Due in part to the distributed storage and updating of the blockchain 1216 over the blockchain network, the blockchain 1216 may store its data in a decentralized manner, without a centralized database (e.g., run by a clearinghouse), and thus operate as a distributed ledger. The decentralized storage of the blockchain 1216 overcomes one of the disadvantages of centralized storage, which is that centralized storage essentially has a single point of failure. It is to be appreciated that in one or more implementations, the blockchain 1216 may be public (e.g., like Bitcoin and Ethereum blockchains), such that transactions on the blockchain 1216 are generally viewable with a connection to the Internet. Alternatively, the blockchain 1216 may be configured as a private blockchain, in one or more implementations. When the blockchain 1216 is a “private” blockchain, the computing devices used to implement the blockchain nodes may be controlled by a centralized authority, such as a company or a consortium of entities.

The blockchain 1216 supports the secure transfer of digital assets, such as the transfer of cryptographic tokens for a cryptocurrency. Often, cryptocurrencies (e.g., coins of the cryptocurrency) are the native assets to blockchains, whereas tokens are created “on top” of these blockchains. By way of example, the Bitcoin blockchain's native asset is (Bitcoin or “BTC”), a cryptocurrency. In one or more implementations, the blockchain network corresponds to the Bitcoin blockchain. In variations, however, the blockchain network may correspond to a different blockchain network (e.g., the Ethereum blockchain) or a combination of blockchain networks. It is to be appreciated that the described techniques may be used to optimize routing within a decentralized network (e.g., the decentralized network 102) for various digital instruments, including, by way of example and not limitation, cryptocurrencies (e.g., Bitcoin (BTC), Ether (ETH), Ripple (XRP), etc.) and tokens (e.g., non-fungible tokens (NFTs), smart contracts, digital rights management (DRM) mechanisms associated with digital content, mechanisms for shipping and logistics, etc.).

FIG. 13 is a non-limiting illustration of an example system 1300 that is operable to implement blockchain supported resource transfer communication protocol techniques described herein in accordance with one or more implementations. The illustrated system 1300 includes the first edge device 110 and first wallet application 118, the second edge device 116 and a second wallet application 120, a blockchain system 1302 as corresponding to the blockchain 1216 of FIG. 12, an identity hub 1304, and an institutional system 1306 (e.g., in support of performing a fund transfer of a transaction by a transaction server) that are communicatively coupled, one to another, via the network 128.

In accordance with the described techniques, the system 1300 implements a communication protocol 1308 configured to provide blockchain support for resource transfer in this example, i.e., to transfer funds as part of a transaction. The communication protocol 1308 incorporates various components, including decentralized identifiers and credentials as well as a schema 1310. Examples of the decentralized identifiers include first and second decentralized identifiers 1312, 1314 as managed by the first and second wallet applications 118, 120, respectively. Additionally, examples of the credentials include first and second verifiable credentials 1316, 1318 as also managed by the first and second wallet applications 118, 120, respectively.

The communication protocol 1308 facilitates the formation of mutual trust between parties involved in a message transfer that is not centrally controlled. Mutual trust is implemented, for instance, through direct trust negotiation between the parties, use of mutually trusted third-party systems to “vouch” for the parties, and so forth. The communication protocol 1308 is configurable in an example to implement trust in a manner that differs from conventional decentralized exchange protocols in that the model is not trustless. The communication protocol 1308, for instance, is configurable to employ decentralized trust through a public key infrastructure (PKI) that is usable to secure communication between entities, e.g., the first and second edge devices 110, 116, the institutional system 1306, and so forth. The communication protocol 1308 is built upon the decentralized identifiers used by the first and second edges devices 110, 116 as well as other entities in the system 1300, e.g., the institutional system 1306. Decentralized identifiers in this example support verifiable, decentralized digital identity.

As such, decentralized identifiers are configurable to refer to a variety of different entity types (e.g., a user, organization, institution, data model, thing, abstract entity, and so forth) as determined by a controlling entity of the decentralized identifier. This is in contrast to typical federated identifiers, in that decentralized identifiers are decoupled from centralized registries, identity providers, and certificate authorities. For example, while other parties may be used to enable information discovery related to a decentralized identifier, this configuration supports an entity which is associated with a decentralized identifier control over the identity associated with the decentralized identifier without involving permission from another entity.

Decentralized identifiers (DIDs) are configurable as uniform resource identifiers (URIs) that associate a DID subject with a DID document, thereby supporting trustworthy interactions associated with that subject. Examples of the decentralized identifiers include a first decentralized identifier 1312 associated with the first wallet application 118 and a second decentralized identifier 1314 associated with the second wallet application 120. Decentralized identifier (DID) documents, which are linked to the decentralized identifiers, are configurable as a metadata file that includes a variety of data elements, examples of which include cryptographic material and routing endpoints. Cryptographic material is usable by an entity that is associated with the decentralized identifier to provide control, e.g., through use of public keys, digital signatures, and so forth. Routing endpoints specify locations, at which, data with an entity that is associated with the decentralized identifier is exchanged and/or at which the entity is contacted. The routing endpoints, for instance, specify an identity hub 1304 having associated personal data storage and relay nodes used by a data store and message relay system 1320.

Decentralized identifier techniques are implemented by the communication protocol 1308 in a variety of ways. Examples include use of a communication protocol 1308 that is open, public, and permissionless, and is tamper resistant. Further, the communication protocol 1308 produces a record that is probabilistically finalized and independently, deterministically verifiable, even in the presence of segmentation, state withholding, and collusive node conditions. Further, the communication protocol 1308 is not reliant on authorities, trusted third parties, or entities that cannot be displaced through competitive market processes.

Credentials are also used as part of the communication protocol 1308, examples of which include the first and second verifiable credentials 1316, 1318. These credentials are configured as cryptographically secure, respect privacy, and are machine verifiable. In one implementation, inclusion of a zero-knowledge proof is usable to further advance privacy and safety by preventing an ability to link across disclosures, reduces an amount of data that is discoverable, and reduces raw data value exposure.

The system 1300 is also configurable to include a variety of additional entities that are involved as part of the communication protocol 1308, examples of which are illustrated as a blockchain system 1302 implementing a virtual machine 1206 and an identity hub 1304 implementing the data store and message relay system 1320.

The identity hub 1304 provides an interface, through which, to store, discover, and fetch data related to communications involved in a request (e.g., transaction involving a funds transfer) supported by the communication protocol 1308. The data store and message relay system 1320 of the identity hub 1304, for instance, is usable to locate public or permissioned private data related to a particular decentralized identifier, e.g., the first and second decentralized identifiers 1312, 1314. The identity hub 1304 is configurable as having a mesh-like datastore construction that supports an ability of an entity to operate multiple instances that synchronize to a same state across one another. Use of the mesh-like datastore construction provides an entity that is associated with the decentralized identity with an ability to secure, manage, and transact data with other entities without reliance on location or provider-specific infrastructure, interfaces, or routing mechanisms.

The identity hub 1304 supports use of a semantic message 1322 and respective data interfaces (e.g., as inferential application programming interfaces (APIs)) in accordance with the schema 1310 that are accessible without direct knowledge of a semantic type of data that is to be exchanged. A diverse set of interactions and flows are modeled within these interfaces as part of the schema 1310 by externally codifying sets of message schemas and processing directives to form respective protocols.

The semantic message 1322 employs the schema 1310 as supporting a naming convention of the datatypes of objects included in the message. Configuration of the semantic message 1322 enables entities that receive the semantic message 1322 to readily parse the message using the schema 1310, e.g., to determine whether the semantic message 1322 is of interest to the entity and process it accordingly. As such, the schema 1310 of the semantic message 1322 helps support the distributed architecture of the communication protocol 1308. For example, the identity hub 1304 is configured to identify, through semantics of the message, and process/forward the semantic message 1322 to a respective institutional system 1306 which can then also process the semantic message 1322 based on the schema. In one example, the semantic messages 1322 are signed by each entity through the process by the schema 1310 as part of a point-to-point messaging protocol 1324.

Digital wallets act as agents for individuals or institutions by facilitating exchanges with the institutional system 1306 or other third-party service provider system. As such, digital wallets are configurable to support a variety of functionalities. The first and second wallet applications 118, 120, for instance, support secure encrypted storage for verifiable credentials as illustrated, e.g., the first and second verifiable credentials 1316, 1318 for the blockchain system 1302. The first and second wallet applications 118, 120 also support discovery of an institutional system 1306 or other third-party service provider system by crawling the identity hub 1304. The first and second wallet applications 118, 120, further include mechanisms for receiving, offering, and presenting verifiable credentials used as part of the communication protocol 1308. Yet further, the first and second wallet applications 118, 120 implement digital signature mechanisms and support an ability to store a transaction history. The first and second wallet applications 118, 120 are configurable to support seamless transfer of credentials between wallets, and as such does not claim “ownership” of verifiable credentials. Additionally, operation of the first and second wallet applications 118, 120 is consent driven by an entity associated with the digital wallet.

The communication protocol 1308 includes a plurality of communication layers, an example of which includes a point-to-point messaging protocol 1324. The point-to-point messaging protocol 1324 is used to implement secure communication between the first and second wallet applications 118, 120, and the institutional system 1306, e.g., to exchange data used to obtain and receive decentralized identity data.

The semantic messages 1322 exchanged between the first and second wallet applications 118, 120 and institutional system 1306 (e.g., using the data store and message relay system 1320 of the identity hub 1304) contains semantically defined objects adherent to the schema 1310. The message objects also contain data usable by the entities to evaluate requests, verify credentials, and execute value exchanges. The semantic message 1322 is configurable as a JavaScript Object Notation (JSON) object, which is signed by each entity from a sending entity to the receiving entity for each segment of the resource transfer. The semantic message 1322 is encrypted in one example and employs programming hooks that enable a message handler service to receive the semantic message 1322 in real time at the identity hub 1304 and process the messages as part of a data store and message relay system 1320 in accordance with the semantics and rule set by the communication protocol 1308 and schema 1310 that are defined for a given message type. In this way, the identity data exchange is secured.

FIG. 14 is a user interface diagram 1400 illustrating a series of interactive user interfaces for a transaction amount verification and a transferee address verification, in accordance with one or more implementations. In particular, the user interface diagram 1400 includes a user interface 1402, a user interface 1408, a user interface 1414, and a user interface 1420, all of which are output (e.g., displayed) on a first edge device 110. The user interfaces are used to perform a multi-factor authentication (e.g., two-factor authentication, three-factor authentication, or more factors of authentication) in response to a request to process a transfer of an amount of a digital asset (e.g., a cryptocurrency such as bitcoin) from a transferor address of a transferor account to a transferee address of a transferee account.

The user interface 1402 is used by the first edge device 110 (and/or a server such as the wallet server 126) of a transferor to perform an amount verification, as a first factor of authentication before initiating processing of the transfer. In particular, the user interface 1402 outputs (e.g., displays) the amount of the digital asset (e.g., the cryptocurrency) to be sent in the requested transfer in a field 1430. The example of the user interface 1402 illustrated in FIG. 4 includes the field 1430 that lists this amount as $5,000.00, or 1,312,150 satoshis (sats), which is the hypothetical conversion rate between U.S. Dollars and sats. The user interface 1402 includes a “No” button 1404 that, when interacted with, indicates that the amount is incorrect. The user interface 1402 includes a “Yes” button 1406 that, when interacted with, confirms or verifies that the amount is correct. A finger icon over the “Yes” button 1406 shows that interacting with the “Yes” button 1406, in some examples, transitions the first edge device 110 from the user interface 1402 to the user interface 1408.

In some examples, the amount of the transaction can be previously received by the first edge device 110 through a previous user interface (not pictured). In some examples, the amount of the transaction can be determined based on a request for a transaction from another device (e.g., a device associated with the transferee and/or a payment service).

The user interface 1408 is used by the first edge device 110 (and/or a server such as the wallet server 126) to perform an address verification (of an address of the transferee account), as a second factor of authentication before initiating processing of the transfer. Because the address may be long (e.g., as seen in the field 1440 of the user interface 1420)—to help verify that the address is accurate, the user interface 1408 outputs (e.g., displays) a first subset of the address in a field 1432, and asks the user to interact with a field 1434 (which is an interactive field) to provide a second subset of the address. For instance, the user interface 1408 asks the user to type, into the field 1434, the next one or more character(s) that come after the first subset (that is shown in the field 1432). The second subset is thus adjacent to the first subset. The first subset may be randomly selected from within the address, or semi-randomly selected based on what the user interface 1408 is asking of the user in the field 1434 (e.g., if the user is being asked to provide the next character after the first subset in the field 1434, the random selection of the first subset can ensure that the subset does not include the very last character of the address, so that at least one character still remains in the address after the first subset). In FIG. 14, the field 1432 is illustrated as including the characters “jrsq,” and the field 1434 is illustrated as receiving a “t” as an input from the user. The first edge device 110 (or a server such as the wallet server 126) compares that character(s) that are received through the interaction(s) with the field 1434 to the actual next character(s) in the address. For instance, as seen in the address in the field 1440 of the user interface 1420, the next character after the first subset (“jrsq”) actually is “t,” so the first edge device 110 (or a server such as the wallet server 126) can verify that the input to the field 1434 is correct, and thus verify that the address to be transferred to is correct.

The second subset (in field 1434) is different from the first subset (in field 1432). As illustrated in FIG. 14, the first subset (in field 1432) of the address includes four characters from the address (“jrsq”), while the second subset (in field 1434) of the address includes one character from the address (“t”). In some examples, the first subset (in field 1432) of the address can include more or fewer than four characters from the address. In some examples, the second subset (in field 1434) of the address can include more than one character from the address. In some examples, the user interface 1408 includes more fields that output more subsets of the address, and/or that receive more subsets of the address via user interface input. For instance, in some examples, the user interface 1408 can include an additional first field outputting an additional subset of the address, and an additional second field into which the user interface requests the user type in the next N characters of the address after the additional subset. In some examples, the user interface 1408 can be modified to include any number of such fields.

In some examples, the second subset can be part of the first subset instead of being adjacent to the first subset. For instance, rather than requesting that the user input an adjacent character to the first subset that is shown in field 1432, the field 1432 can include a subset with one or more characters “blank,” and the user interface 1408 can request that the user “fill in the blank(s)” by typing in the character(s) that should be in the blank spot(s). For instance, instead of the field 1432 displaying “jrsq,” the field 1432 can display “jr_q,” and the user interface 1408 can ask the user to fill in the blank space (the “_”). The user can then type “s” into the field 1434 to correctly fill in the blank (e.g., to fill in “jr_q” with “s” to be “jrsq”).

The user interface 1408 includes an “I can't find it” button 1410 that, when interacted with, indicates that the user cannot find the first subset (in the field 1432) in the address, and/or cannot find the second subset (to be entered into the field 1434) in the address-either way, indicating a potential address mismatch and therefore a potential security issue. The user interface 1408 includes a “Continue” button 1412 that, when interacted with, submits the character(s) in the field 1434 for verification. A finger icon over the field 1434 shows that the user has typed “t” into field 1434. In some examples, the user interacting with the “Continue” button 1412 can transition the application from the user interface 1408 to the user interface 1414, or from the user interface 1408 to the user interface 1420. The user interface 1408 provides improved security by forcing the user to closely check what the correct address should be, for instance from a separate source, to ensure that the field 1432 is present in the correct address (in the separate source), and to identify the second subset (to enter into the field 1434) from the correct address (from the separate source).

In some examples, the user interface 1414 can be used by the first edge device 110 (and/or a server such as the wallet server 126) to perform a secondary address verification (of the address of the transferee account), as a third factor of authentication before initiating processing of the transfer. Similarly to the user interface 1408, the user interface 1414 outputs (e.g., displays) a third subset of the address in a field 1436 (similarly to the first subset in the field 1432 of the user interface 1408), and asks the user to interact with a field 1438 (which is an interactive field) to provide a fourth subset of the address (similarly to the first subset in the field 1434 of the user interface 1408). The user interface 1414 once again asks the user to type, into the field 1438, the next one or more character(s) that come after the third subset (that is shown in the field 1436). The fourth subset is thus adjacent to the third subset. In FIG. 14, the field 1436 is illustrated as including the characters “3p83,” and the field 1438 is illustrated as receiving a “k” as an input from the user. The first edge device 110 (and/or a server such as the wallet server 126) compares that character(s) that are received through the interaction(s) with the field 1438 to the actual next character(s) in the address. For instance, as seen in the address in the field 1440 of the user interface 1420, the next character after the third subset (“3p83”) actually is “k,” so the first edge device 110 (and/or a server such as the wallet server 126) can verify that the input to the field 1438 is correct, and thus verify that the address to be transferred to is correct.

The fourth subset (in field 1438) is different from the third subset (in field 1436). As illustrated in FIG. 14, the third subset (in field 1436) of the address includes four characters from the address (“3p83”), while the fourth subset (in field 1438) of the address includes one character from the address (“k”). In some examples, the third subset (in field 1436) of the address can include more or fewer than four characters from the address. In some examples, the fourth subset (in field 1438) of the address can include more than one character from the address. In some examples, the user interface 1414 includes more fields that output more subsets of the address, and/or that receive more subsets of the address via user interface input. For instance, in some examples, the user interface 1414 can include an additional third field outputting an additional subset of the address, and an additional fourth field into which the user interface requests the user type in the next N characters of the address after the additional subset. In some examples, the user interface 1414 can be modified to include any number of such fields.

In some examples, the fourth subset can be part of the third subset instead of being adjacent to the third subset. For instance, rather than requesting that the user input an adjacent character to the third subset that is shown in field 1436, the field 1436 can include a subset with one or more characters “blank,” and the user interface 1414 can request that the user “fill in the blank(s)” by typing in the character(s) that should be in the blank spot(s). For instance, instead of the field 1436 displaying “3p83,” the field 1436 can display “3_3,” and the user interface 1414 can ask the user to fill in the blank spaces (the “_”). The user can then type “p8” into the field 1438 (or “p” and “8” into individual per-blank fields) to correctly fill in the blanks (e.g., to fill in the “_” in “3_3” with “p8” to be “3p83”).

The user interface 1414 includes an “I can't find it” button 1416 that, when interacted with, indicates that the user cannot find the first subset (in the field 1436) in the address, and/or cannot find the second subset (to be entered into the field 1438) in the address-either way, indicating a potential address mismatch and therefore a potential security issue. The user interface 1414 includes a “Continue” button 1418 that, when interacted with, submits the character(s) in the field 1438 for verification. A finger icon over the field 1438 shows that the user has typed/entered “k” into field 1438. In some examples, the user interacting with the “Continue” button 1418 can transition the application from the user interface 1414 to the user interface 1420.

The user interface 1420 is used by the first edge device 110 (and/or a server such as the wallet server 126) to perform a tertiary address verification (of the address of the transferee account), as a fourth factor of authentication before initiating processing of the transfer. In some examples, the user interface 1420 includes a field 1440 that includes the address in its entirety, as a final verification before the transaction to transfer the amount of the digital asset from the transferor account to the transferee account is processed. The user interface 1420 includes a “Cancel” button 1422 that, when interacted with, indicates that the address is incorrect, and that the transaction should be cancelled—and in some cases, proactively cancels the transaction. The user interface 1420 includes a “Continue” button 1424 that, when interacted with, confirms or verifies that the address is correct, and proceeds with initiating the processing of the transaction. In some examples, an interaction with the “Continue” button 1424 transitions the transaction initiation process to another device (e.g., the key device 112, the second edge device 116, and/or the wallet server 126) for further approvals and/or for processing. In some examples, an interaction with the “Continue” button 1424 causes generation of a new block into a distributed ledger (e.g., associated with the decentralized network 102), with the new block having a payload indicative of the transaction, to process the transaction.

While the field 1430 in the user interface 1402 is illustrated as showing the entirety of the amount of the digital asset to be transferred ($5,000.00 or 1,312,150 sats), in some examples, the user interface 1402 may instead include a first field that shows a first portion or subset of the amount of the digital asset to be transferred (e.g., similar to the field 1432 of the user interface 1408 or the field 1436 of the user interface 1414), and may require the user to fill in a second field with a second portion or subset (e.g., which may be adjacent to the first portion or subset) of the amount of the digital asset to be transferred (e.g., similar to the field 1434 of the user interface 1408 or the field 1438 of the user interface 1414). For instance, in an illustrative example, the first field of the user interface 1402 can include “3121,” as part of the total number of sats (1,312,150) of the amount, and the user interface 1402 can ask the user to fill in the next character(s) (digit(s)) into the second field, and confirm whether the user filled in “5” or “50” (which would be correct), or any other value (which would be incorrect and indicate a potential security issue). Alternately, such a user interface can leave one or more characters (digits) of the transaction amount “blank,” and the user interface 1402 can request that the user “fill in the blank(s)” by typing in a character(s) (digit(s)) that should be in the blank spot(s). For instance, instead of the first field of the user interface 1402 displaying “3121” and asking for the next digit(s), the field 1432 can display “1_12_50” and the user interface 1402 can ask the user to fill in the blank spaces (the “_” spaces). The user can then type “3” and “1” into corresponding fields of the user interface 1402 to correctly fill in the blanks (e.g., to fill in the two “_” blanks in “1_12_50” with “3” and “1,” respectively, to be “1312150”).

In some examples, the first edge device 110 (and/or a server such as the wallet server 126) can randomly select the first subset (“jrsq” in field 1432) and/or the third subset (“3p83” in field 1436) by selecting a random number between zero and the length of the address, and selecting the subset that starts at that character of the address. In some examples, the first edge device 110 (and/or a server such as the wallet server 126) can compare the address to a dictionary or other source of words in the English language or another language, and can identify whether a word exists in the address, and select that word to be at least a part of the first subset (in field 1432) and/or the third subset (in field 1436). For instance, if the characters of the address happen to form the word “sand” partway through the address, the first edge device 110 (and/or a server such as the wallet server 126) can select the word “sand” to be the first subset (in field 1432) and/or the third subset (in field 1436). This can help improve the ease-of-use of the interface by making it easier for a user to find the first subset (in field 1432) and/or the third subset (in field 1436) within the address.

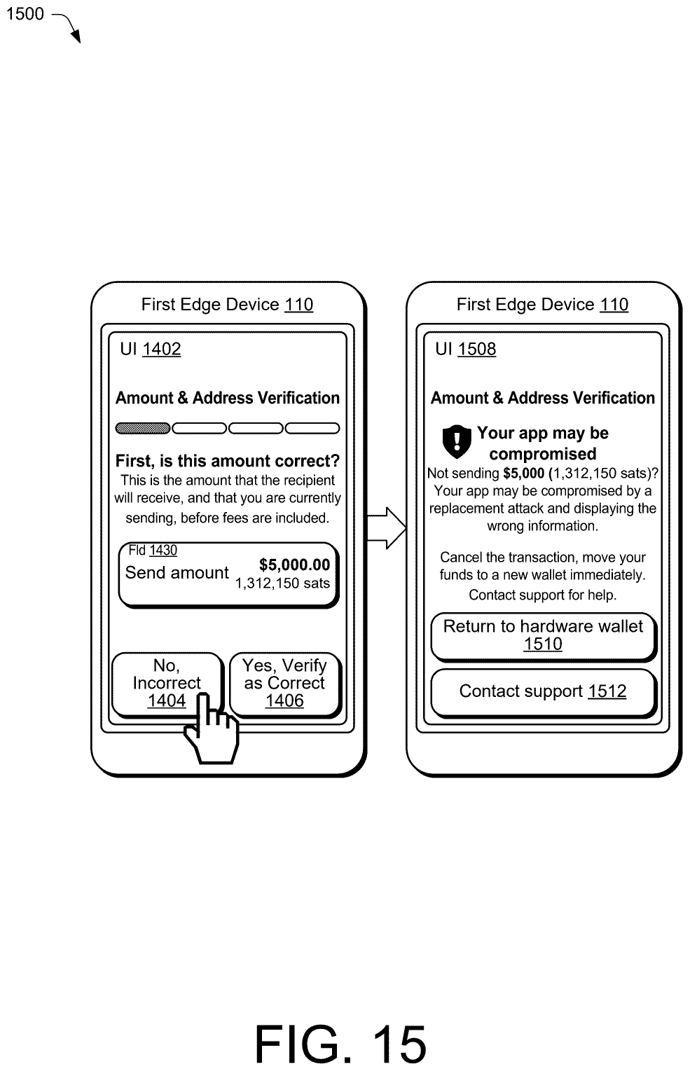

FIG. 15 is a user interface diagram 1500 illustrating interactive user interfaces for a transaction amount verification and a potential security issue, in accordance with one or more implementations. The user interface diagram 1500 includes the user interface 1402 of FIG. 14, as well as a user interface 1508 with a security warning. In some examples, the first edge device 110 transitions from the user interface 1402 to the user interface 1508 in response to an interaction with the “No” button 1404 of the user interface 1402. The finger icon over the “No” button 1404 in FIG. 15 suggests that the “No” button 1404 is pressed in FIG. 15.

The user interface 1508 includes a warning, indicating that if the user is not sending the amount indicated in the field 1430 of the user interface 1402, that a replacement attack or some other suspicious or malicious activity could have been used to tamper with a legitimate transaction request to change the amount. The amount mismatch can also be caused by a mistake. The user interface 1508 includes a “return to hardware wallet” button 1510 that can cancel the transaction and return to a different application on the first edge device 110 (and/or transition to a different device such as the key device 112). The user interface 1508 includes a “contact support” button 1512 allowing the user to contact a support agent to help with resolving any effects of the potential security issue.

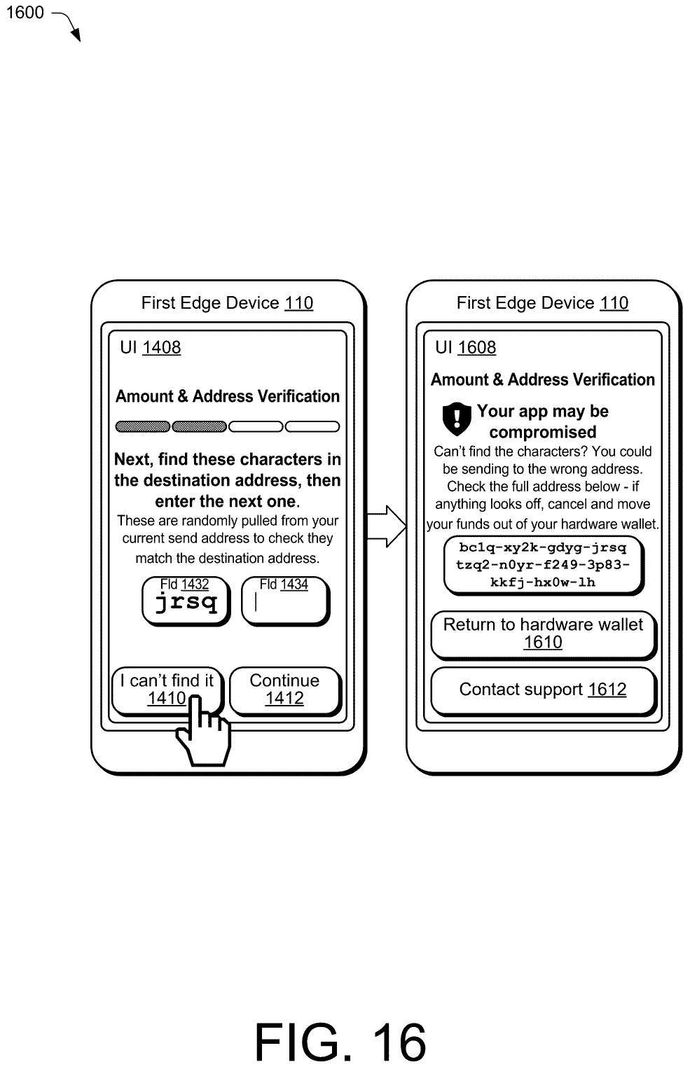

FIG. 16 is a user interface diagram 1600 illustrating interactive user interfaces for a transferee address verification and a potential security issue, in accordance with one or more implementations. The user interface diagram 1600 includes the user interface 1408 of FIG. 14, as well as a user interface 1608 with a security warning. In some examples, the first edge device 110 transitions from the user interface 1408 to the user interface 1608 in response to an interaction with the “I can't find it” button 1410 of the user interface 1408. The finger icon over the “I can't find it” button 1410 in FIG. 16 suggests that the “I can't find it” is pressed in FIG. 16.

The user interface 1608 includes a warning, indicating that if the user is unable to find the first subset of characters of the address displayed in the field 1432 (“jrsq”) in the transferee address, and/or if the user is unable to find a second subset of characters of the address to enter into the field 1434 that match the criteria laid out in user interface 1408 (e.g., the next character(s) after the first subset) in the transferee address, that the transfer may be set to go to a different transferee address than what the user (transferor) intended. This can be due to an attack or some other suspicious or malicious activity that potentially could have been used to tamper with a legitimate transaction request to change the address, or can be due to a mistake. The user interface 1608 includes a “return to hardware wallet” button 1610 that can cancel the transaction and return to a different application on the first edge device 110 (and/or transition to a different device such as the key device 112). The user interface 1608 includes a “contact support” button 1612 allowing the user to contact a support agent to help with resolving any effects of the potential security issue.

In some examples, the user interface 1608, or a similar warning user interface, can also be displayed in response to an interaction with the “I can't find it” button 1416 of the user interface 1414, and/or with the “cancel” button 1422 of the button 1422. In some examples, the user interface 1608, or a similar warning user interface, can also be displayed in response to the user entering an incorrect second subset of the address into the field 1434 and pressing the “continue” button 1412 of the user interface 1408, or in response to the user entering an incorrect fourth subset of the address into the field 1438 and pressing the “continue” button 1418 of the user interface 1414.

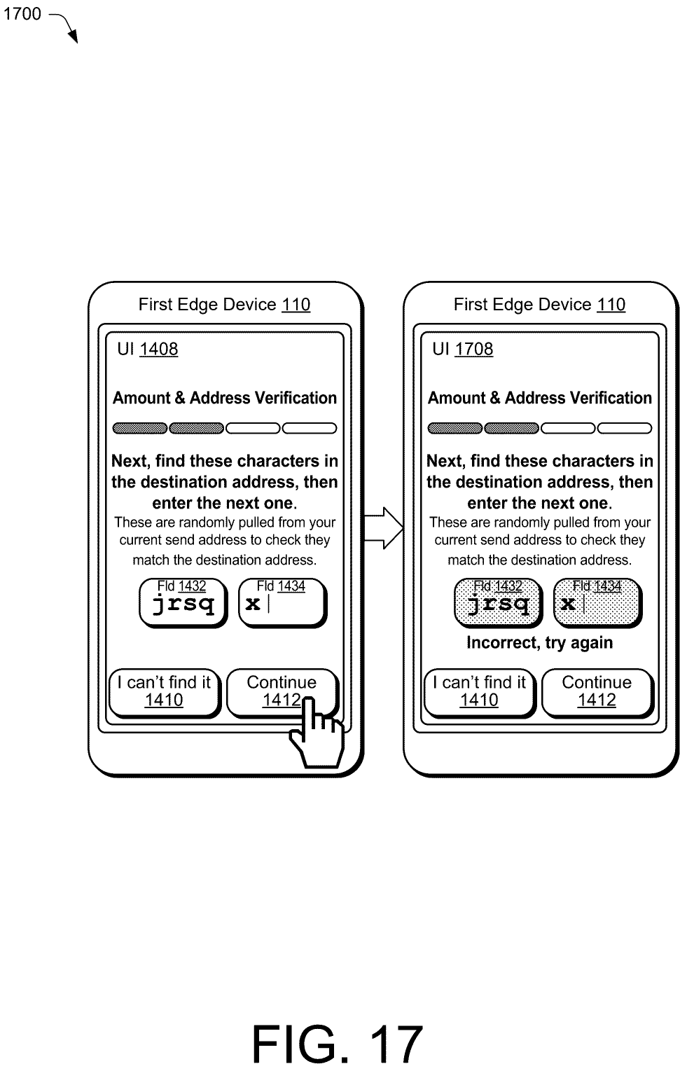

FIG. 17 is a user interface diagram 1700 illustrating interactive user interfaces for a transferee address verification, in accordance with one or more implementations. The user interface diagram 1700 includes the user interface 1408 of FIG. 14, as well as a user interface 1708 that is a modified variant of the user interface 1408 of FIG. 14. For instance, in the user interface 1408 as illustrated in FIG. 14, the user has entered an incorrect character (“x”) into the field 1434, and interact with (e.g., pressed) the “Continue” button 1412 of the user interface 1408. This causes the user interface 1408 to change into the user interface 1708, which includes a message reading “incorrect, try again,” and includes shading or coloring highlighting the field 1432 and/or the field 1434 to alert the user that the character (“x”) that they entered into the field 1434 was incorrect.

In some examples, the address verification can provide this type of warning a determined number of times to prevent a malicious user from repeatedly guessing the correct character(s) to enter into the field 1434. In some examples, after the number of attempts exceeds a threshold, the first edge device 110 transitions from the user interface 1708 (and/or from the user interface 1408) to the user interface 1608.

In some examples, a similar modified variant of the user interface 1414 can be output by the first edge device 110 if the user enters an incorrect fourth subset of the address into the field 1438 and presses the “Continue” button 1418 of the user interface 1414.

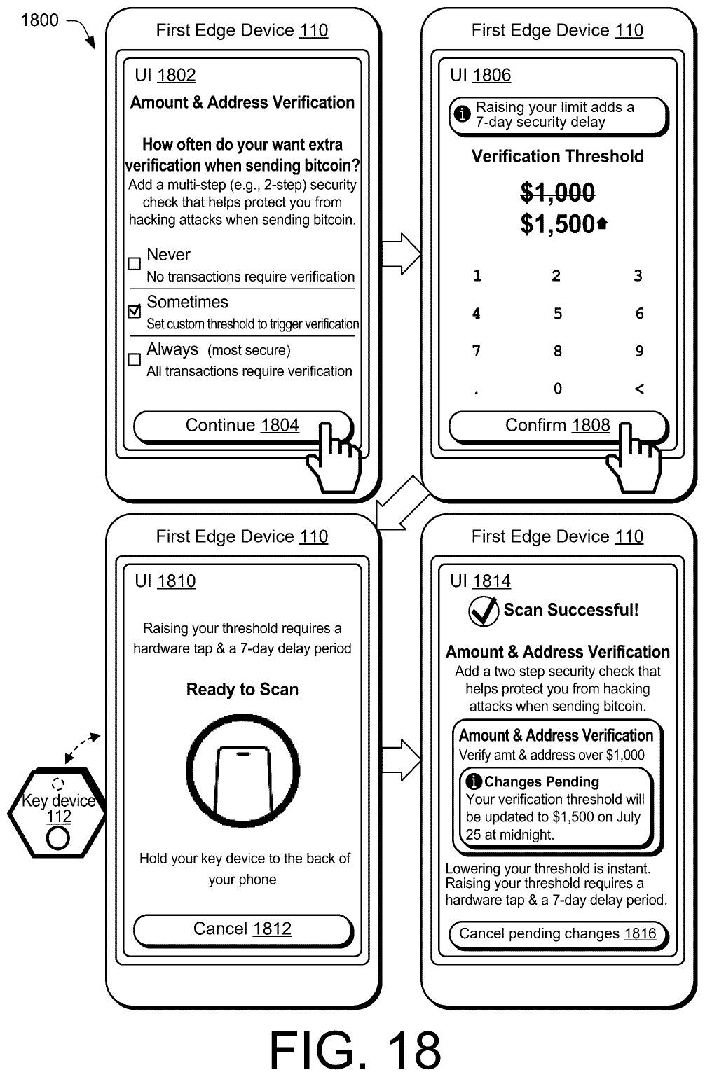

FIG. 18 is a user interface diagram 1800 illustrating interactive user interfaces for adjusting a setting indicating a condition for address verification, in accordance with one or more implementations. The user interface diagram 1800 includes a user interface 1802, a user interface 1806, a user interface 1810, and a user interface 1814, all of which are output (e.g., displayed) on a first edge device 110. The user interfaces are used to set and/or adjust settings for when the amount verification and/or address verification (e.g., as illustrated in FIGS. 14-17 and 20) are performed.

The user interface 1802 is used by the first edge device 110 (and/or a server such as the wallet server 126) to set and/or change a setting for when the amount verification and/or address verification (e.g., as illustrated in FIGS. 14-17 and 20) are performed. The available settings include “never” (meaning that no transactions require amount verification and/or address verification), “always” (meaning that all transactions require amount verification and/or address verification), and “sometimes.” The “sometimes” setting can refer to a setting in which transactions involving transfer of an amount exceeding a verification threshold require amount verification and/or address verification, transactions not on an allowlist (whitelist) require amount verification and/or address verification, transactions on a blocklist (blacklist) require amount verification and/or address verification, or a combination thereof. The user interface 1802 includes checkboxes next to each option, and shows that the checkbox next to “sometimes” is checked, while the checkboxes next to “never” and “always” are unchecked. The user interface 1802 includes a “Continue” button 1804 that, when interacted with, can set or change the setting, and/or can transition the first edge device 110 from the user interface 1802 to the user interface 1806, allowing the user to set or change the verification threshold.

The user interface 1806 is used by the first edge device 110 (and/or a server such as the wallet server 126) to set and/or change the verification threshold beyond which transactions require amount verification and/or address verification. That is, transactions involving transfer of an amount exceeding the verification threshold require amount verification and/or address verification. The user interface 1806 includes a number pad that allows the user to enter a number for the verification threshold. The user interface 1806 identifies that the user has entered the number $1,500, indicating that the user wishes the change the verification threshold to $1,500. The user interface 1806 includes a struck-through number $1,000 indicating that the previous verification threshold was $1,000. The user interface 1806 includes an arrow pointing upward next to the number $1,500, indicating that this requested change in the verification threshold from $1,000 to $1,500 is an increase. The user interface 1806 includes an alert indicating to the user that “raising your limit adds a 7-day security delay.” The user interface 1806 includes a “Confirm” button 1808 that, when interacted with, can initiate the setting and/or changing of the verification threshold, and can transition the first edge device 110 from the user interface 1806 to the user interface 1810 and/or the user interface 1814. This confirmation can serve as a first factor of authentication for changing the verification threshold.

The user interface 1810 indicates that “raising your threshold requires a hardware tap & a 7-day delay period,” notes that the first edge device 110 is “ready to scan” the key device 112, and instructs the user to “hold [their] key device to the back of [their] phone.” An example of the key device 112 is illustrated tapping the back of the first edge device 110. The tap can initiate a short-range wireless signal communication between the key device 112 and the first edge device 110, for instance transmitting a digital signature from the key device 112 to the first edge device 110 that the first edge device 110 can verify using a corresponding public key, transmitting a digital signature from the first edge device 110 to the key device 112 that the key device 112 can verify using a corresponding public key, or a combination thereof. In some examples, the key device 112 need not actually be tapped against the first edge device 110, but instead, the key device 112 can enter into the short-range wireless signal transmission range of the first edge device 110, and/or vice versa. The short-range wireless signal communication(s) between the key device 112 and the first edge device 110 can serve as a second factor of authentication for changing the verification threshold. In some examples, the short-range wireless signal communication(s) between the key device 112 and the first edge device 110 can serve as a trigger to change the verification threshold. In some examples, changing the verification threshold is also contingent on a waiting period (a “delay and notify” period), which may be 7 days as discussed in the user interface 1806, the user interface 1810, and the user interface 1814. In some examples, the short-range wireless signal communication(s) between the key device 112 and the first edge device 110 can serve as a trigger to change the first edge device 110 from the user interface 1810 to the user interface 1814. The user interface 1810 includes a “cancel” button 1812 that can allow a user to cancel the change, for instance if the user is missing their key device 112 or is otherwise unable to initiate the short-range wireless signal communication(s) between the key device 112 and the first edge device 110.

The user interface 1814 identifies that the scan or tap between the key device 112 and the first edge device 110 (the short-range wireless signal communication(s) between the key device 112 and the first edge device 110 illustrated with respect to the user interface 1810) was successful. The user interface 1814 identifies that, because the change to the verification threshold is an increase, the verification threshold will still remain at $1,000 for seven days (e.g., until July 25 at midnight per the user interface 1814), after which the verification threshold will automatically change from $1,000 to $1,500 as requested using the user interface 1806 and the user interface 1810. The user interface 1814 includes a “cancel pending changes” button 1816 that can allow a user to cancel the change to the verification threshold, for instance if a different user requested the change to the verification threshold, and the primary user sees the pending change in the user interface 1814 and does not agree with it. If the “cancel pending changes” button 1816 is interacted with (e.g., pressed), the first edge device 110 (and/or a server such as the wallet server 126) can cancel the pending change of the verification threshold from $1,000 to $1,500, causing the verification threshold to remain at $1,000. This delay, with an option to cancel, can serve as a third factor of authentication for changing the verification threshold.

In some examples, the first edge device 110 (and/or a server such as the wallet server 126) can also send a communication to the user through an alternate communication channel (than the application or website that the button 1816 is a part of) to notify the user about the pending change to the verification threshold. The alternate communication channel can include, for example, email, text messaging (e.g., Short Message Service (SMS), Multimedia Messaging Service (MMS), Rich Communication Services (RCS), or a platform-specific text messaging service), a third-party messaging service (e.g., WhatsApp®, Google®, Apple®, Facebook®, and the like), or a combination thereof. The message sent through the alternate communication channel can look similar to the user interface 1814, and/or can include similar content to the content illustrated in the user interface 1814. For instance, a message sent through the alternate communication channel can include a button or link that functions in the same way as the “cancel pending changes” button 1816 of the user interface 1814. For instance, if the button or link in the message interacted with (e.g., pressed, clicked), the first edge device 110 (and/or a server such as the wallet server 126) can cancel the pending change of the verification threshold from $1,000 to $1,500, causing the verification threshold to remain at $1,000. Having this message be sent through the alternate communication channel can ensure that even if the first edge device 110 is lost, stolen, or compromised, the user still has an opportunity to prevent an unwanted or unauthorized change to the verification threshold. This delay, with an option to cancel, sent through the alternate communication channel, can serve as a third or fourth factor of authentication for changing the verification threshold.

In some examples, other changes can also be gated by the short-range wireless signal communication(s) between the key device 112 and the first edge device 110 (as illustrated with the user interface 1810) and/or a “delay and notify” period (as illustrated with the user interface 1814). For instance, in some examples, if the user changes the “always” setting to the “sometimes” setting or to the “never” setting in the user interface 1802, this change is also gated by the short-range wireless signal communication(s) between the key device 112 and the first edge device 110 (as illustrated with the user interface 1810) and/or a “delay and notify” period (as illustrated with the user interface 1814), thus increasing security by requiring multiple factors of authentication for such a change. Similarly, in some examples, if the user changes the “sometimes” setting to the “never” setting in the user interface 1802, this change is also gated by the short-range wireless signal communication(s) between the key device 112 and the first edge device 110 (as illustrated with the user interface 1810) and/or a “delay and notify” period (as illustrated with the user interface 1814), thus increasing security by requiring multiple factors of authentication for such a change.

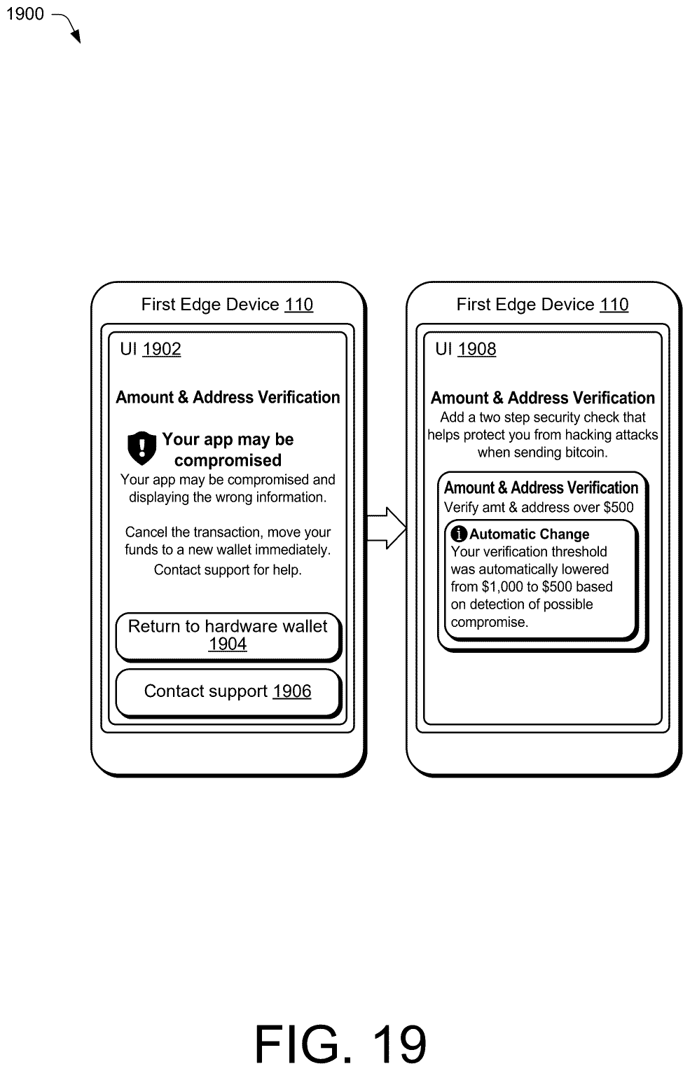

FIG. 19 is a user interface diagram 1900 illustrating interactive user interfaces for a potential security issue and an automatic adjustment of a threshold for address verification, in accordance with one or more implementations. The user interface diagram 1900 includes a user interface 1902, which can be an example of the user interface 1508, the user interface 1608, or another warning user interface caused by an indication of lack of security. The user interface 1902 includes a “return to hardware wallet” button 1910 that can cancel the transaction and return to a different application on the first edge device 110 (and/or transition to a different device such as the key device 112). The user interface 1902 includes a “contact support” button 1912 allowing the user to contact a support agent to help with resolving any effects of the potential security issue.

The user interface diagram 1900 also includes a user interface 1908, which indicates a change to the verification threshold similarly to the user interface 1814. The change to the verification threshold in the user interface 1908 reduces the verification threshold (e.g., from $1,000 to $500), therefore making the system more secure by requiring multi-factor authentication for more transactions (e.g., for any transaction involving a transfer of more than $500). In some examples, encountering the user interface 1902, or some other indication of a potential security issue (e.g., the user interface 1508, the user interface 1608) can automatically trigger the verification threshold change of the user interface 1908 as a proactive security precaution to reduce how much damage an attacker can cause, if there is in fact an attacker.

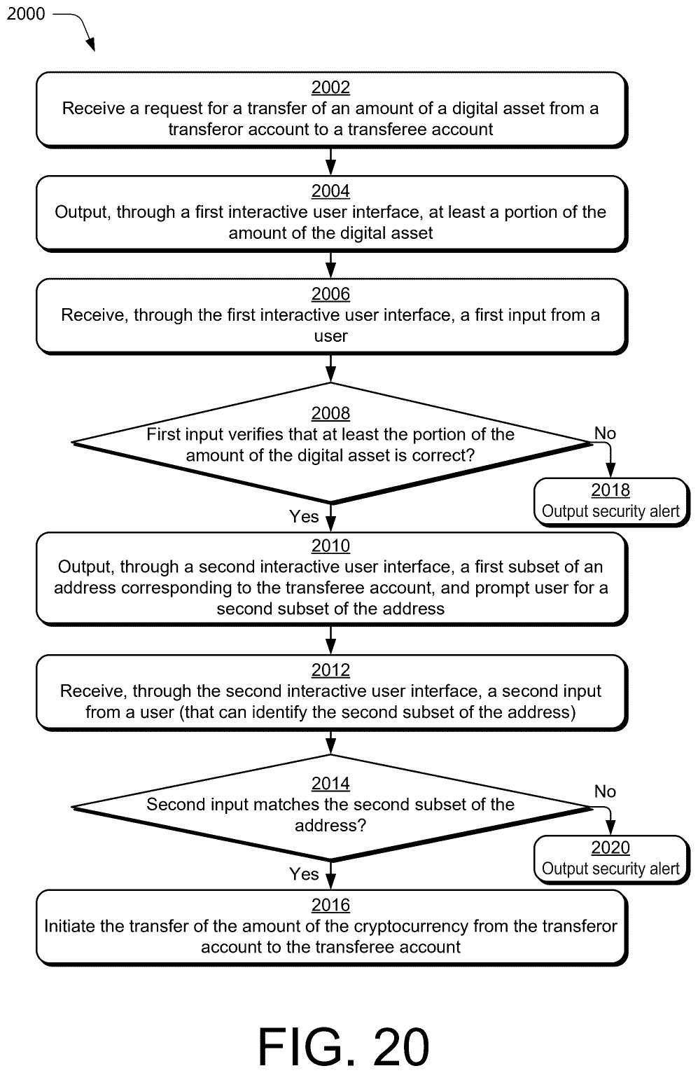

FIG. 20 is a flow diagram illustrating a process 2000 for multi-factor authentication to improve distributed ledger asset transaction security, in accordance with one or more implementations. The process 2000 can be performed by, and/or using, an authentication system. The authentication system can include, for instance, the environment 100, the decentralized network 102, the first edge device 110, the key device 112, the supplemental interface 114, the second edge device 116, the wallet server 126, the network 128, the environment 200, the sensor 206, the control module 208, the environment 300, a system that performs the procedure 400, the environment 500, a system that performs the procedure 600, the environment 700, the user interface 802, the user interface 902, the user interface 1002, a system that performs the procedure 1100, the environment 1200, the blockchain system 1202, the blockchain nodes 1204, the virtual machine 1206, the distributed ledgers 1208, the storage 1214, the blockchain 1216, the blocks 1220, the distributed state machine 1224, the decentralized web application 1226, the system 1300, the blockchain system 1302, the identity hub 1304, the institutional system 1306, the communication protocol 1308, the data store and message relay system 1320, the point-to-point messaging protocol 1324, the user interface 1402, the user interface 1408, the user interface 1414, the user interface 1420, the user interface 1508, the user interface 1608, the user interface 1708, the user interface 1802, the user interface 1806, the user interface 1810, the user interface 1814, the user interface 1908, the environment 2100 for application interface customization, the server(s) 2102, the network(s) 2104, the end user devices 2106, the server(s) 2108, the environment 2200, the service provider system 2202, the user device 2204, the data store(s) 2206, the asset storage 2208, the public blockchain 2214, the node 2216, the hardware wallet 2218, the private blockchain 2232, the system 2300, the user device 2302, the server(s) 2304, the reader device 2326, the datastore 2344, a system, an apparatus, a point of sale (POS) system or terminal, a transaction instrument reader device, a processor that executes instructions stored in a non-transitory computer-readable storage medium to run a program, any subsystems or components of any of the above-listed systems, any other computing systems discussed herein, or a combination thereof.

At block 2002, the authentication system (or a subsystem thereof) is configured to, and can, receive a request for a transfer of an amount of a digital asset from a transferor account to a transferee account. The transfer can be part of a transaction, such as the digital transaction 108. The transferee account is associated with an address that includes at least a first subset and a second subset. The request can be, for example, part of entering and/or sending proposed transaction details as in block 702, block 1102, and/or block 1106.

In some aspects, the digital asset is a cryptocurrency, a token (e.g., a non-fungible token (NFT)), a media file (e.g., an image, a video, and/or an audio file), a document, another type of file, or a combination thereof.

At block 2004, the authentication system (or a subsystem thereof) is configured to, and can, output, through a first interactive user interface, at least a portion of the amount of the digital asset. At block 2006, the authentication system (or a subsystem thereof) is configured to, and can, receive, through the first interactive user interface, a first input from a user.

In some aspects, the authentication system (or a subsystem thereof) is configured to, and can, output the first interactive user interface (e.g., at or before block 2004). In some aspects, the authentication system (or a subsystem thereof) is configured to, and can, display a first interactive graphical user interface (e.g., user interface 1402) of the first interactive user interface (e.g., at or before block 2004).

At block 2008, the authentication system (or a subsystem thereof) is configured to, and can, check whether the first input (received at block 2006) verifies that at least the portion of the amount of the digital asset (output in block 2004) is correct. If the authentication system confirms, at block 2008, that the at least the portion of the amount of the digital asset (output in block 2004) is correct, then the process 2000 proceeds from block 2008 to block 2010. If the authentication system identifies, at block 2008, that at least the portion of the amount of the digital asset (output in block 2004) is incorrect (not correct), then the process 2000 proceeds from block 2008 to block 2018. At block 2018, the authentication system (or a subsystem thereof) is configured to, and can, output a security alert, such as the user interface 1508, the user interface 1608, the “incorrect” warning in the user interface 1708, or the user interface 1902.

The user interface 1402 is an example of the first interactive user interface. For instance, the field 1430 includes least a portion of the amount of the digital asset. In some examples, the first input (received at block 2006) can be an interaction with the “No” button 1404 (to indicate that at least the portion of the amount of the digital asset is incorrect) or an interaction with the “Yes” button 1406 (to indicate that at least the portion of the amount of the digital asset is correct).

In some examples, the first interactive user interface may look similar and/or function similarly to the user interface 1408 and/or the user interface 1414. For instance, at block 2004, a first portion of the amount can be in field 1432 or field 1436, and the first input can be an input of a second portion of the amount (e.g., adjacent to the first portion of the amount) into the field 1434 or the field 1438. In some examples, if the authentication system confirms that the second portion of the amount is correct (e.g., correctly identifies (matches) the portion of the amount that is adjacent to the first portion), this serves as an indicator (at block 2008) that at least the portion of the amount of the digital asset is correct. On the other hand, if the authentication system identifies that the second portion of the amount is incorrect (e.g., does not correctly identify the portion of the amount that is adjacent to the first portion), this serves as an indicator (at block 2008) that at least the portion of the amount of the digital asset is incorrect.

In some aspects, the first interactive user interface identifies a first portion of the amount of the digital asset, and the first input identifies a second portion of the amount of the digital asset to verify that the first portion of the amount of the digital asset is correct. In some aspects, the authentication system (or a subsystem thereof) is configured to, and can, verify that the second portion of the amount of the digital asset is adjacent to the first portion of the amount of the digital asset within the amount of the digital asset. For instance, as indicated in the user interface 1408 and the user interface 1414, the second portion can be “the next” one or more digits in the amount after the first portion. In some examples, the second portion can be the previous one or more digits in the amount before the first portion.

At block 2010, the authentication system (or a subsystem thereof) is configured to, and can, output, through a second interactive user interface, a first subset of an address corresponding to the transferee account. In some examples, the second interactive user interface can also prompt the user for a second subset of the address. At block 2012, the authentication system (or a subsystem thereof) is configured to, and can, receive, through the second interactive user interface, a second input. The second subset can identify the second subset of the address.

In some aspects, the authentication system (or a subsystem thereof) is configured to, and can, output the second interactive user interface (e.g., at or before block 2010). In some aspects, the authentication system (or a subsystem thereof) is configured to, and can, display a second interactive graphical user interface (e.g., user interface 1408, user interface 1414) of the second interactive user interface (e.g., at or before block 2010).

At block 2014, the authentication system (or a subsystem thereof) is configured to, and can, check whether the second input (received at block 2012) correctly identifies (matches) the second subset of the address. If the authentication system confirms, at block 2014, that the second input (received at block 2012) correctly identifies (matches) the second subset of the address, then the process 2000 proceeds from block 2014 to block 2016. If the authentication system identifies, at block 2014, that second input (received at block 2012) does not correctly identify (e.g., incorrectly identifies, does not match) the second subset of the address, then the process 2000 proceeds from block 2014 to block 2020. At block 2020, the authentication system (or a subsystem thereof) is configured to, and can, output a security alert, such as the user interface 1508, the user interface 1608, the “incorrect” warning in the user interface 1708, or the user interface 1902.

Examples of the second interactive user interface include the user interface 1408 and/or the user interface 1414. For instance, at block 2010, the first subset of the address can be in field 1432 or field 1436, and the second input can be an input of a second subset of the address (e.g., adjacent to the first subset of the address) into the field 1434 or the field 1438. In some examples, if the authentication system confirms that the second subset of the address is correct (e.g., correctly identifies, or matches, the subset of the address that is adjacent to the first subset), this serves as an indicator (at block 2014) that the second input (received at block 2012) correctly identifies (matches) the second subset of the address. On the other hand, if the authentication system identifies that the second subset of the address is incorrect (e.g., does not correctly identify the subset of the address that is adjacent to the first subset), this serves as an indicator (at block 2014) that the second input (received at block 2012) does not correctly identify (e.g., incorrectly identifies or does not match) the second subset of the address.

In some aspects, the authentication system (or a subsystem thereof) is configured to, and can, verify that the second subset is adjacent to the first subset within the address. For instance, as indicated in the user interface 1408 and the user interface 1414, the second subset can be “the next” one or more characters in the address after the first subset. In some examples, the second subset can be the previous one or more characters in the address before the first subset.

At block 2016, the authentication system (or a subsystem thereof) is configured to, and can, initiate the transfer of the amount of the cryptocurrency from the transferor account to the transferee account. For instance, the block 2016 can include the operation(s) of block 512 and/or block 612.

In some aspects, the authentication system (or a subsystem thereof) is configured to, and can, identify that the amount of the digital asset to be transferred exceeds a threshold before receiving the first input and before receiving the second input. The threshold can be an example of the verification threshold that is set or changed in the user interface 1806 and the user interface 1814 (where the verification threshold is changed from $1,000 to $1,500), and the user interface 1908 (where the verification threshold is changed from $1,000 to $500).

In some aspects, the authentication system (or a subsystem thereof) is configured to, and can, receive an indication of a potential security issue, for instance as indicated in the user interface 1508, the user interface 1608, the user interface 1708, or the user interface 1902. The authentication system (or a subsystem thereof) can automatically reduce the threshold (e.g., the verification threshold) in response to the indication of the potential security issue (e.g., as in the user interface 1908, where the verification threshold is automatically changed from $1,000 to $500 in response to the potential security issue identified in the user interface 1902).

In some aspects, the authentication system (or a subsystem thereof) is configured to, and can, receive, through a third interactive user interface, a third input that identifies the threshold (e.g., the verification threshold). For instance, the user interface 1806 is an example of the third interactive user interface. The third input can include input(s) to the number pad of the user interface 1806, and/or an interaction with the “confirm” button 1808 of the user interface 1806.

In some aspects, the authentication system (or a subsystem thereof) is configured to, and can, process input data using a trained machine learning (ML) model that generates a recommended value for the threshold (e.g., the verification threshold). The input data can be associated with the transferee, the transferor, the transfer, the amount, a type of the digital asset (e.g., cryptocurrency, NFT, media asset), a previous transaction history and/or transfer history, device(s) used in processing and/or authorizing the transfer (e.g., the decentralized network 102, the first edge device 110, the key device 112, the wallet server 126, the network 128, and/or other device(s) that are part of the authentication system), or a combination thereof. The ML model(s) can include, for instance, one or more neural network(s) (NN(s)), convolutional NN(s) (CNN(s)), time delay NN(s) (TDNN(s)), deep network(s) (DN(s)), autoencoder(s) (AE(s)), variational autoencoder(s) (VAE(s)), deep belief net(s) (DBN(s)), recurrent NN(s) (RNN(s)), generative adversarial network(s) (GAN(s)), conditional GAN(s) (cGAN(s)), feed-forward network(s), network(s) having fully connected layers, support vector machine(s) (SVM(s)), random forest(s) (RF), computer vision (CV) system(s), autoregressive (AR) model(s), Sequence-to-Sequence (Seq2Seq) model(s), large language model(s) (LLM(s)), deep learning system(s), classifier(s), transformer(s), or a combination thereof. In some examples, the ML model(s) can include a U-Network (U-Net) structure and/or architecture that includes a contracting path and an expansive path. If the ML model(s) is a U-Net, the ML model(s) may include, for instance, combination of convolution, up-convolution, pooling and skip connections that allows the ML model(s) to extract and capture complex features, while also keeping and reconstructing spatial information. In examples where the ML model(s) include LLMs, the LLMs can include, for instance, a Generative Pre-Trained Transformer (GPT) (e.g., GPT-2, GPT-3, GPT-3.5, GPT-4, etc.), DaVinci or a variant thereof, an LLM using Massachusetts Institute of Technology (MIT)® langchain, Pathways Language Model (PaLM), Large Language Model Meta® AI (LLaMA), Language Model for Dialogue Applications (LaMDA), Bidirectional Encoder Representations from Transformers (BERT), Falcon (e.g., 40B, 7B, 1B), Orca, Phi-1, StableLM, DeepSeek® R1, Alibaba® Qwen®, ByteDance® Doubao®, another LLM, variant(s) of any of the previously-listed LLMs, or a combination thereof. In some aspects, the threshold is dynamically changed over time (e.g., continuously and/or periodically and/or in real-time) as new input data is received (e.g., as different transactions are processed), to ensure that the threshold remains up-to-date as recommendation(s) for the value change over time.

In some aspects, the authentication system (or a subsystem thereof) is configured to, and can, detect an interaction between a first device and a second device (e.g., the short-range wireless communication between the first edge device 110 and the key device 112 in association with the user interface 1810). In some aspects, the authentication system can set the threshold (e.g., the verification threshold) in response to the interaction between the first device and the second device. For instance, the change to the verification threshold in the user interface diagram 1800 is performed in response to the scan being successful as indicated in the user interface 1814, with the scan referring to the short-range wireless communication between the first edge device 110 and the key device 112 in association with the user interface 1810.

In some aspects, the authentication system (or a subsystem thereof) is configured to, and can, send a message indicative of the third input and/or of the request to change the verification threshold. The message can include an interactive element, that, when interacted with, responds and cancels the change to the threshold (e.g., as in the “cancel pending changes” button 1816 of the user interface 1814). The authentication system can wait for a predetermined amount of time for a response to the message, and can set (or change) the threshold (e.g., the verification threshold) based on the third input in response to failure to receive the response to the message within the predetermined amount of time (e.g., one or more second, minutes, hours, days, or weeks). Examples of the predetermined amount of time include the 7-day “delay and notify” period referenced in the user interface 1806, the user interface 1810, and the user interface 1814. Examples of the message can include the user interface 1814 or a message through an alternate communication channel such as, for instance, email, text messaging (e.g., Short Message Service (SMS), Multimedia Messaging Service (MMS), Rich Communication Services (RCS), or a platform-specific text messaging service), a third-party messaging service (e.g., WhatsApp®, Google®, Apple®, Facebook®, and the like), or a combination thereof.

In some aspects, the authentication system (or a subsystem thereof) is configured to, and can, select the first subset (“jrsq” in field 1432) and/or the third subset (“3p83” in field 1436) based on a random number, for instance by selecting a random number between zero and the length of the address, and selecting the subset that starts at that character of the address. In some aspects, the authentication system (or a subsystem thereof) is configured to, and can, compare the address to a dictionary or other source of words in the English language or another language, and can identify whether a word exists in the address, and select that word to be at least a part of the first subset (in field 1432) and/or the third subset (in field 1436). For instance, if the characters of the address happen to form the word “sand” partway through the address, the first edge device 110 (and/or a server such as the wallet server 126) can select the word “sand” to be the first subset (in field 1432) and/or the third subset (in field 1436). This can help improve the ease-of-use of the interface by making it easier for a user to find the first subset (in field 1432) and/or the third subset (in field 1436) within the address.

In some aspects, the authentication system (or a subsystem thereof) is configured to, and can, proactively remediate potential security issue(s) if any of the verifications or authentications of the process 2000 fail (e.g., if block 2018 or block 2020 is reached). For instance, in some aspects, the authentication system (or a subsystem thereof) is configured to, and can, cancel the transfer, lower the verification threshold (e.g., of FIGS. 18-19), disable certain functions of the authentication system (e.g., disable functions of the first edge device 110, the key device 112, the first wallet application 118, the wallet server 126, or a combination thereof), or a combination thereof.

In some aspects, the process 2000 can perform multiple verifications using multiple subsets of the address. For instance, the process 2000 can output a first subset of the address and request a second subset of the address through the interactive user interface (e.g., as in the user interface 1408), and can output a third subset of the address and request a fourth subset of the address through the interactive user interface (e.g., as in the user interface 1414).

In some aspects, the process 2000 can verify the address of the transferor instead of, or in addition to, verifying the address of the transferee. This can provide an additional factor of authentication to further improve security of the transaction.

In some aspects, the authentication system (or a subsystem thereof) is configured to, and can, send a message automatically in response to verifying that the second input correctly identifies (matches) the second subset of the address. The message includes an interactive element that is configured to trigger a response to the message through which the transfer can be cancelled (through which the transfer is cancellable). Initiating the transfer (at block 2016) is based on a failure to receive the response to the message (and thus a failure to receive any instruction to cancel the transfer) for at least a predetermined amount of time (e.g., one or more second, minutes, hours, days, or weeks) since the sending of the message (e.g., as a “delay and notify” period). Examples of the predetermined amount of time include the 7-day “delay and notify” period referenced in the user interface 1806, the user interface 1810, and the user interface 1814. Examples of the message can include a message similar to the user interface 1814, but notifying the user about the transfer and giving the user the opportunity to cancel the transfer, or a corresponding message through an alternate communication channel such as, for instance, email, text messaging (e.g., Short Message Service (SMS), Multimedia Messaging Service (MMS), Rich Communication Services (RCS), or a platform-specific text messaging service), a third-party messaging service (e.g., WhatsApp®, Google®, Apple®, Facebook®, and the like), or a combination thereof.

The systems and methods described with respect to the process 2000 provide technical improvements, for instance in the realm of security enhancements through multi-factor authentication. The implementation of multi-factor authentication in the process 2000 enhances the security of distributed ledger asset transactions by using multiple forms of verification before a transaction is approved. This approach mitigates the risk of unauthorized access, mistakes in transactions, and/or suspicious network activity (e.g., attempts to initiate potentially fraudulent transactions) by ensuring, in multiple ways, that amounts (to be transferred) and addresses (of parties to the transaction) are correct. The process 2000 also provides improved user interfaces that are interactive and provide easy-to-implement ways to improve security (e.g., even with mobile devices of low complexity). For instance, the interactive user interfaces described in the process 2000 allow users to verify the accuracy of the transaction details, such as the amount of the digital asset and the address of the transferor, before proceeding. If the details are incorrect, the system outputs a security alert and cancels or prevents erroneous or malicious transactions. The multi-factor authentication of the process 2000 addresses several technical problems, including security vulnerabilities and user interface challenges. By making the transaction contingent on verification and/or authentication of the amount of the digital asset and/or the address of the transferee account through separate interactive user interfaces, the system ensures that different aspects of the transaction are authenticated independently. This layered approach to verification reduces the likelihood of errors and enhances the overall security of the transaction process. Furthermore, the process 2000 provides for improved security through dynamic adjustments to security thresholds (e.g., the verification threshold of FIGS. 18-19) based on potential security issues. For instance, the authentication system can automatically lower the verification threshold in response to detected security threats, thereby providing an adaptive security mechanism that dynamically and proactively monitors, responds to, mitigates, and/or remediates security issues (e.g., unauthorized transactions). This enhances security by proactively safeguarding access to account(s) and/or digital assets, potentially canceling a pending transaction and increasing verification procedures for future transactions (e.g., by reducing the verification threshold) in response to any suspicious activity (e.g., potential security issues). The authentication system performing the process 2000 thus provides robust security enhancements and effectively addresses technical problems related to transaction verification and user interface design. By implementing multiple layers of authentication and adaptive security measures, the system provides a secure and easy-to-use solution for managing distributed ledger asset transactions.

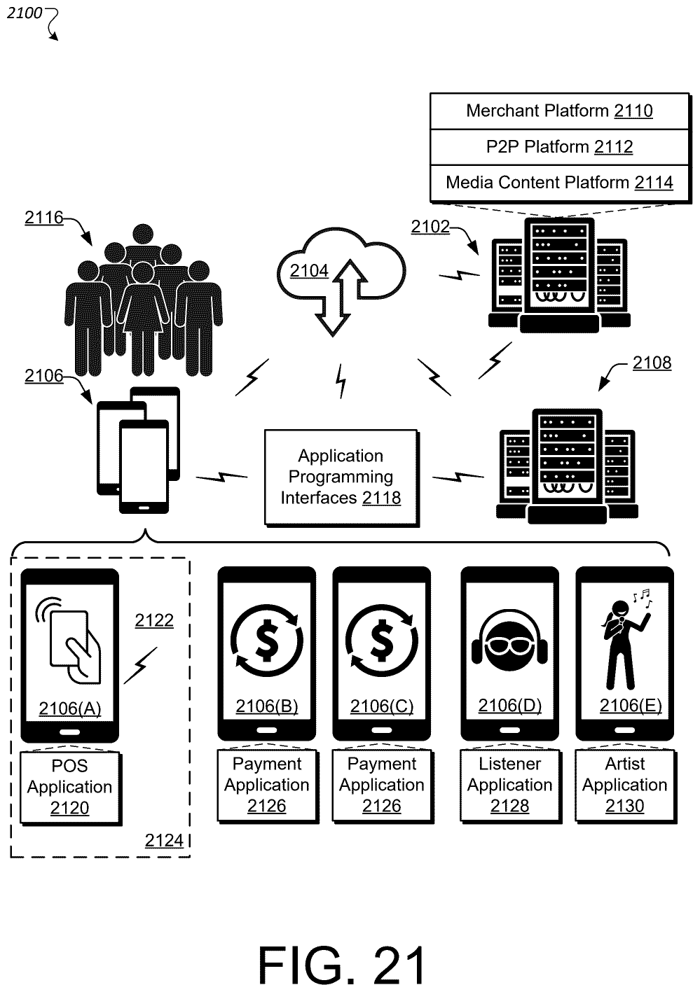

FIG. 21 illustrates an example environment 2100 for application interface customization. The environment 2100 includes server(s) 2102 that can communicate over a network 2104 with end user devices 2106 and/or server(s) 2108 associated with third-party service provider(s). In various examples, the end user devices 2106 may comprise one or more merchant devices 2106(A), one or more user devices 2106(B) and/or 2106(C) in a peer network, one or more content consumption devices 2106(D), one or more artist user devices 2106(E), combinations of these examples, or other categories of user devices. The server(s) 2102 can be associated with one or more service providers that can provide one or more services for the benefit of users 2116, as described below. For example, the server(s) 2102 may enable services of service providers such as in association with a merchant platform 2110 (which may further include a buyer platform), a peer-to-peer (P2P) payment platform 2112, a media content platform 2114, a combination of these platforms, or other platforms associated with other service providers. While services and features are referenced throughout in connection with a particular one of the merchant platform 2110, the P2P payment platform 2112, or the media content platform 2114, it should be understood that any of these platforms may perform the functionality described in relation to any of the other platforms. Actions attributed to the service provider(s) can be performed by the server(s) 2102.

In some examples, the end user devices 2106, merchant platform 2110, P2P platform 2112, and/or media content platform 2114 can be examples of the decentralized network 102, the first edge device 110, the key device 112, the supplemental interface 114, the second edge device 116, the wallet server 126, the network 128, a system that performs the procedure 400, a system that performs the procedure 600, the blockchain system 1202, the blockchain nodes 1204, the virtual machine 1206, the distributed ledgers 1208, the storage 1214, the blockchain 1216, the distributed state machine 1224, the decentralized web application 1226, the system 1300, the blockchain system 1302, the identity hub 1304, the institutional system 1306, the communication protocol 1308, the data store and message relay system 1320, the point-to-point messaging protocol 1324, a system that performs the process 2000, or a combination thereof. In some examples, individual ones of the end user devices 2106 can be operable by users 2116 (e.g., user 605, user 1605). The users 2116 (individually referred to herein as “user 2116”) can be referred to as miners, customers, buyers, merchants, sellers, borrowers, employees, employers, payors, payees, couriers, artists, musicians, listeners, fans, supervisors, hosts, audience members, and so on. The users 2116 can interact with the end user devices 2106 via user interfaces presented via the end user devices 2106. In at least one example, a user interface can be presented via a web browser, or the like. Alternatively or additionally, a user interface can be presented via an application, such as a mobile application or desktop application, which can be provided by the merchant platform 2110, the P2P payment platform 2112, and/or the media content platform 2114, or which can be an otherwise dedicated application. In some examples, individual end user devices 2106 can have an instance or versioned instance of an application, which can be downloaded from an application store, for example, which can present the user interface(s) described herein.

In at least one example, the users 2116 can include merchants that can operate the seller device(s) 2106(A) that are configured for use by merchants. For the purpose of this discussion, a “merchant” can be any entity that offers items (e.g., goods or services) for purchase or other means of acquisition (e.g., rent, borrow, barter, etc.). The merchants can offer items for purchase or other means of acquisition via brick-and-mortar stores, mobile stores (e.g., pop-up shops, food trucks, etc.), online stores, event venues, combinations of the foregoing, and so forth. In some examples, at least some of the merchants can be associated with the same entity but can have different merchant locations and/or can have franchise/franchisee relationships.

In additional or alternative examples, the merchants can be different merchants. For the purpose of this discussion, “different merchants” can refer to two or more unrelated merchants. “Different merchants” therefore can refer to two or more merchants that are different legal entities (e.g., natural persons and/or corporate persons) that do not share accounting, employees, branding, etc. “Different merchants,” as used herein, have different names, employer identification numbers (EIN) s, lines of business (in some examples), inventories (or at least portions thereof), and/or the like. Thus, the use of the term “different merchants” does not refer to a merchant with various merchant locations or franchise/franchisee relationships. Such merchants—with various merchant locations or franchise/franchisee relationships—can be referred to as merchants having different merchant locations and/or different commerce channels.

The seller device 2106(A) can have an instance of a point of sale (“POS”) application 2120 stored thereon. The POS application 2120 can configure the seller device 2106(A) as a POS terminal, which enables the merchant to interact with one or more customers. In at least one example, interactions between the customers and the merchants that involve the exchange of funds (from the customers) for items or services (from the merchants) can be referred to as “transactions.” In at least one example, the POS application 2120 can determine transaction data associated with the POS transactions. Transaction data can include payment information, which can be obtained from a reader device 2122 associated with the seller device 2106(A), user authentication data, purchase amount information, point-of-purchase information (e.g., item(s) purchased, date of purchase, time of purchase, subscription type, etc.), etc. The POS application 2120 can send transaction data to the server(s) 2102 such that the server(s) 2102 can track transactions of the customers, merchants, and/or the users 2116 over time. Furthermore, the POS application 2120 can present a UI to enable the merchant to interact with the POS application 2120 and/or the merchant platform 2110 via the POS application 2120.

In at least one example, the seller device 2106(A) can be a special-purpose computing device configured as a POS terminal (via the execution of the POS application 2120). In at least one example, the POS terminal may be connected to a reader device 2122, which is capable of accepting a variety of payment instruments, such as credit cards, debit cards, gift cards, short-range communication based payment instruments, and the like, as described below. In at least one example, the reader device 2122 can plug in to a port in the seller device 2106(A), such as a microphone port, a headphone port, an audio-jack, a data port, or other suitable port. In additional or alternative examples, the reader device 2122 can be coupled to the seller device 2106(A) via another wired or wireless connection, such as via Bluetooth®, BLE, and so on. In some examples, the reader device 2122 can be a software solution executing on the POS terminal, e.g., a mobile phone. In some examples, the reader device 2122 can read information from alternative payment instruments including, but not limited to, wristbands and the like.

In some examples, the reader device 2122 may physically interact with payment instruments such as magnetic stripe payment cards, EMV payment cards, and/or short-range communication (e.g., near field communication (NFC), radio frequency identification (RFID), Bluetooth®, Bluetooth® low energy (BLE), etc.) payment instruments (e.g., cards, hardware wallets, fobs, or devices configured for tapping). The POS terminal may provide a rich user interface, communicate with the reader device 2122, and communicate with the merchant platform 2110, which can provide, among other services, a payment processing service. The server(s) 2102 associated with the merchant platform 2110 can communicate with server(s) 2108, as described below. In this manner, the POS terminal and reader device 2122 may collectively process transaction(s) between the merchants and customers. In some examples, multiple POS terminal(s) may be connected to a number of other devices, such as “secondary” terminals, e.g., back-of-the-house systems, printers, line-buster devices, reader devices, speakers, and the like, to allow for information from the secondary terminal to be shared between the primary POS terminal(s) and secondary terminal(s), for example via short-range communication technology. This kind of arrangement may continue operation in an offline-online scenario to allow one device (e.g., secondary terminal) to continue taking user input, and synchronize data with another device (e.g., primary terminal) when the primary or secondary terminal switches to online mode. In other examples, such data synchronization may happen periodically or at randomly selected time intervals.

While the POS terminal and the reader device 2122 of the POS system 2124 are shown as separate devices, in additional or alternative examples, the POS terminal and the reader device 2122 can be part of a single device. In some examples, the reader device 2122 can have a display integrated therein for presenting information to customers of a merchant. In additional or alternative examples, the POS terminal can have a display integrated therein for presenting information to the customers of the merchant. POS systems, such as the POS system 2124, may be mobile, such that POS terminals and reader devices may process transactions in disparate locations across the world. POS systems can be used for processing card-present transactions and card-not-present (CNP) transactions.

A card-present transaction is a transaction where both a customer and the customer's payment instrument are physically present at the time of the transaction. Card-present transactions may be contact or contactless transactions processed by swipes (e.g., by sliding a magnetic strip through a reader device), dips (e.g., by inserting an embedded microchip into a reader device), taps (e.g., by wirelessly, through Bluetooth, NFC or other short range technology hover or tap a payment instrument into a reader device), or any other interaction between a physical payment instrument (e.g., a card), or otherwise present payment instrument, and a reader device 2122, whereby the reader device 2122 is able to obtain payment data from the payment instrument.

A CNP transaction is a transaction where a card, or other payment instrument, is not physically present at the POS such that payment data is manually keyed in (e.g., by a merchant, customer, etc.), or payment data is required to be recalled from a card-on-file data store, to complete the transaction.

The POS system 2124, the server(s) 2102, and/or the server(s) 2108 may exchange payment information and transaction data to determine whether transactions are authorized. For example, the POS system 2124 may provide encrypted payment data, user authentication data, purchase amount information, point-of-purchase information, etc. (collectively, transaction data) to server(s) 2102 over the network(s) 2104. The server(s) 2102 may send the transaction data to the server(s) 2108.

For the purpose of this discussion, the “payment service providers” can be acquiring banks (“acquirer”), issuing banks (“issuer”), card payment networks, and the like. In an example, an acquirer is a bank or financial institution that processes payments (e.g., credit or debit card payments) and can assume risk on behalf of merchants(s). An acquirer can be a registered member of a card association (e.g., Visa®, MasterCard®), and can be part of a card payment network. In at least one example, the service provider can serve as an acquirer and connect directly with the card payment network.

The card payment network (e.g., the server(s) 2108 associated therewith) can forward the fund transfer request to an issuing bank (e.g., “issuer”). The issuer is a bank or financial institution that offers a financial account (e.g., credit or debit card account) to a user. The issuer (e.g., the server(s) 2108 associated therewith) can make a determination as to whether the customer has the capacity to absorb the relevant charge associated with the payment transaction. In at least one example, the merchant platform 2110 can serve as an issuer and/or can partner with an issuer. The transaction is either approved or rejected by the issuer and/or the card payment network (e.g., the server(s) 2108 associated therewith), and a payment authorization message is communicated from the issuer to the POS device via a path opposite of that described above, or via an alternate path.

The server(s) 2108 may send an authorization notification over the network(s) 2104 to the server(s) 2102, which may send the authorization notification to the POS system 2124 over the network(s) 2104 to indicate whether the transaction is authorized. The server(s) 2102 may also transmit additional information such as transaction identifiers to the POS system 2124. In one example, the server(s) 2102 may include a merchant application and/or other functional components for communicating with the POS system 2124 and/or the server(s) 2108 to authorize or decline transactions (e.g., the API 2118). In examples, the merchant platform 2110 can enable the merchants to receive cash payments, payment card payments, and/or electronic payments from customers for POS transactions and the service provider can process transactions on behalf of the merchants.

Based on the authentication notification that is received by the POS system 2124 from server(s) 2102, the merchant may indicate to the customer whether the transaction has been approved. In some examples, approval may be indicated at the POS system 2124, for example, at a display of the POS system 2124. In some cases, such as with a smart phone or watch operating as a short-range communication payment instrument, information about the approved transaction may be provided to the short-range communication payment instrument for presentation via a display of the smart phone or watch. In some examples, additional or alternative information can additionally be presented with the approved transaction notification including, but not limited to, receipts, special offers, coupons, or loyalty program information.

The merchant platform 2110 can provide, among other services, payment processing services, inventory management services, catalog management services, business banking services, financing services, lending services, reservation management services, web-development services, payroll services, employee management services, appointment services, loyalty tracking services, restaurant management services, order management services, fulfillment services, onboarding services, identity verification (IDV) services, media content (e.g., music, videos, etc.) management and/or subscription services, and so on. In some examples, the end user devices 2106 can access all of the services. In some cases, the end user devices 2106 can have gradated access to the services, which can be based on risk tolerance, IDV outputs, subscriptions, and so on. In at least one example, access to such services can be availed to the merchants via the POS application 2120. In additional or alternative examples, each service can be associated with its own access point (e.g., application, web browser, etc.).

As the merchant platform 2110 processes transactions on behalf of the merchants, the merchant platform 2110 can maintain accounts or balances for the merchants in one or more ledgers. For example, the merchant platform 2110 can analyze transaction data received for a transaction to determine an amount of funds owed to a merchant for the transaction and deposit funds into an account of the merchant. The account can have a stored balance, which can be managed by the merchant platform 2110. The account can be different from a conventional bank account at least because the stored balance is managed by a ledger of the merchant platform 2110 and the associated funds are accessible via various withdrawal channels including, but not limited to, scheduled deposit, same-day deposit, instant deposit, and a linked payment instrument.

A scheduled deposit can occur when the merchant platform 2110 transfers funds associated with a stored balance of the merchant to a bank account of the merchant that is held at a bank or other financial institution (e.g., associated with the server(s) 2108). Scheduled deposits can occur at a prearranged time after a POS transaction is funded, which can be a business day after the POS transaction occurred, or sooner or later. In some examples, the merchant can access funds prior to a scheduled deposit (e.g., same-day deposits and/or real-time deposits). Further, in at least one example, the merchant can have a payment instrument that is linked to the stored balance that enables the merchant to access the funds without first transferring the funds from the account managed by the merchant platform 2110 to the bank account of the merchant.

In at least one example, the merchant platform 2110 may provide inventory management services. That is, the merchant platform 2110 may provide inventory tracking and reporting. Inventory management services may enable the merchant to access and manage a database storing data associated with a quantity of each item that the merchant has available (i.e., an inventory). Furthermore, in at least one example, the merchant platform 2110 can provide catalog management services to enable the merchant to maintain a catalog, which can be a database storing data associated with items that the merchant has available for acquisition (i.e., catalog management services). The merchant platform 2110 can offer recommendations related to pricing of the items, placement of items on the catalog, and multi-party fulfillment of the inventory, to name a few examples.

In at least one example, the merchant platform 2110 can provide business banking services, which allow the merchant to track deposits (from payment processing and/or other sources of funds) into an account of the merchant, payroll payments from the account (e.g., payments to employees of the merchant), payments to other merchants (e.g., business-to-business) directly from the account or from a linked debit card, withdrawals made via scheduled deposit and/or real-time deposit, configure allocations among multiple balances or accounts (e.g., spending, saving, taxes, etc.), etc. Furthermore, the business banking services can enable the merchant to obtain a customized payment instrument (e.g., credit card), check how much money the merchant is earning (e.g., via presentation of available earned balance), understand where the money of the merchant is going (e.g., via deposit reports (which can include a breakdown of fees), spend reports, etc.), access/use earned money (e.g., via scheduled deposit, real-time deposit, linked payment instrument, etc.), have improved control of the money of the merchant (e.g., via management of deposit schedule, deposit speed, linked instruments, etc.), etc. Moreover, the business banking services can enable the merchants to visualize their cash flow to track their financial health, set aside money for upcoming obligations (e.g., savings), organize money around goals, etc.

In at least one example, the merchant platform 2110 can provide financing services and products, such as via business loans, consumer loans, fixed term loans, flexible term loans, and the like. In at least one example, the service provider can utilize one or more risk signals to determine whether to extend financing offers and/or terms associated with such financing offers. Such risk signals can be particular to an individual platform or service, as described herein, or can be based on aggregated data associated with multiple of the platforms or services. In at least one example, the merchant platform 2110 can provide financing services for offering and/or lending a loan to a borrower that is to be used for, in some instances, financing the borrower's short-term operational needs (e.g., a capital loan). Additionally or alternatively, the merchant platform 2110 can provide financing services for offering and/or lending a loan to a borrower that is to be used for, in some instances, financing the borrower's consumer purchase (e.g., a consumer loan). In at least one example, a borrower can submit a request for a loan to enable the borrower to purchase an item from a merchant. The merchant platform 2110 can generate the loan based at least in part on determining that the borrower purchased or intends to purchase the item from the merchant. Advances, loans, or other funds provided to a merchant or other user can be repaid via a variety of mechanisms. In some examples, loans can be repaid in installments (e.g., multiple payments over time), at a particular date, from a portion of incoming funds (e.g., payments processed for the merchant, tax refunds, direct deposits, etc.), or the like.

The merchant platform 2110 can provide web-development services, which enable users 2116 who are unfamiliar with HTML, XML, Javascript, CSS, or other web design tools to create and maintain functional websites. Further, in addition to websites, the web-development services can create and maintain other online omni-channel presences, such as social media posts for example. In some examples, the resulting web page(s) and/or other content items can be used for offering item(s) for sale via an online/e-commerce platform. In at least one example, the merchant platform 2110 can recommend and/or generate content items to supplement omni-channel presences of the merchants.

Furthermore, the merchant platform 2110 can provide payroll services to enable employers to pay employees for work performed on behalf of employers. In at least one example, the merchant platform 2110 can receive data that includes time worked by an employee (e.g., through imported timecards and/or POS interactions), sales made by the employee, gratuities received by the employee, and so forth. Based on such data, the merchant platform 2110 can make payroll payments to employee(s) on behalf of an employer via the payroll service. For instance, the merchant platform 2110 can facilitate the transfer of a total amount to be paid out for the payroll of an employee from the bank of the employer to the bank of the merchant platform 2110 to be used to make payroll payments. In at least one example, when the funds have been received at the bank of the merchant platform 2110, the merchant platform 2110 can pay the employee, such as by check or direct deposit.

Moreover, in at least one example, the merchant platform 2110 can provide employee management services for managing schedules of employees. Further, the merchant platform 2110 can provide appointment services for enabling users 2116 to set schedules for scheduling appointments and/or users 2116 to schedule appointments.

In some examples, the merchant platform 2110 can provide restaurant management services to enable users 2116 to make and/or manage reservations, to monitor front-of-house and/or back-of-house operations, and so on. In such examples, the seller device(s) 2106(A) and/or server(s) 2102 can be configured to communicate with one or more other computing devices, which can be located in the front-of-house (e.g., POS device(s)) and/or back-of-house (e.g., kitchen display system(s) (KDS)). In at least one example, the merchant platform 2110 can provide order management services and/or fulfillment services to enable restaurants (or other merchant types) to manage open tickets, split tickets, and so on and/or manage fulfillment services.

In some examples, the merchant platform 2110 can provide omni-channel fulfillment services. A fulfillment service includes item ordering and delivery services, such as via a courier. In some examples, the courier can be an unmanned aerial vehicle (e.g., a drone), an autonomous vehicle, or any other type of vehicle capable of receiving instructions for traveling between locations. For instance, if a customer places an order with a merchant and the merchant cannot fulfill the order because one or more items are out of stock or otherwise unavailable, the merchant platform 2110 can leverage other merchants and/or sales channels that are part of the merchant platform 2110 to fulfill the customer's order. That is, another merchant can provide the one or more items to fulfill the order of the customer. Furthermore, in some examples, another sales channel (e.g., online, brick-and-mortar, etc.) can be used to fulfill the order of the customer.

In some examples, the merchant platform 2110 can enable conversational commerce via conversational commerce services, which can use one or more machine learning mechanisms to analyze messages exchanged between two or more users 2116, voice inputs into a virtual assistant or the like, to determine intents of user(s) 2116. In some examples, the merchant platform 2110 can utilize determined intents to automate customer service, offer promotions, provide recommendations, or otherwise interact with customers in real-time. In at least one example, the merchant platform 2110 can integrate products and services, and payment mechanisms into a communication platform (e.g., messaging, etc.) to enable customers to make purchases, or otherwise transact, without having to call, email, or visit a web page or other channel of a merchant. That is, conversational commerce alleviates the need for customers to toggle back and forth between conversations and web pages to gather information and make purchases.

In at least one example, a user 2116 may be new to the merchant platform 2110 such that the user 2116 that has not registered (e.g., subscribed to receive access to one or more services offered by the merchant platform 2110) with the merchant platform 2110. The merchant platform 2110 can offer onboarding services for registering a potential user 2116 with the merchant platform 2110. In some examples, onboarding can involve presenting various questions, prompts, and the like to a potential user 2116 to obtain information that can be used to generate a profile for the potential user 2116. In at least one example, the merchant platform 2110 can provide limited or short-term access to its services prior to, or during, onboarding (e.g., a user of a peer-to-peer payment service can transfer and/or receive funds prior to being fully onboarded, a merchant can process payments prior to being fully onboarded, a user of a music streaming service can listen to music having advertisement breaks prior to being fully onboarded, etc.). In response to full or partial completion of onboarding, any limited or short-term access to services of the merchant platform 2110 can be transitioned to more permissive (e.g., less limited) or longer-term access to such services.

The merchant platform 2110 can be associated with IDV services, which can be used by the merchant platform 2110 for compliance purposes and/or can be offered as a service, for instance to third-party service providers (e.g., associated with the server(s) 2108). That is, the merchant platform 2110 can offer IDV services to verify the identity of users 2116 seeking to use or using their services. Identity verification may involve requesting a customer (or potential customer) to provide information that is used by compliance departments to prove that the information is associated with an identity of a real person or entity (e.g., an artist). In at least one example, the merchant platform 2110 can perform services for determining whether identifying information provided by a user 2116 accurately identifies the customer (or potential customer).

Techniques described herein can be configured to operate in both real-time/online and offline modes. “Online” modes refer to modes when devices are capable of communicating with the merchant platform 2110 while offline mode refers to modes when devices are unable to communicate with the server(s) 2108 due to network connectivity issue, for example. In such examples, devices may operate in “offline” mode where at least some payment data is stored (e.g., on the seller device(s) 2106(A)) and/or the server(s) 2102 until connectivity is restored and the payment data can be transmitted to the server(s) 2102 and/or the server(s) 2108 for processing.

In at least one example, the merchant platform 2110 can be associated with a hub, such as an order hub, an inventory hub, a fulfillment hub and so on, which can enable integration with one or more additional service providers (e.g., associated with the additional server(s) 2108). In some examples, such additional service providers can offer additional or alternative services and the service provider can provide an interface or other computer-readable instructions to integrate functionality of the service provider into the one or more additional service providers.

Turning now to the P2P functionality provided by the environment 2100, the P2P platform 2112 can provide a peer-to-peer payment service that enables peer-to-peer payments between two or more of the users 2116. Two or more of the users 2116 may be considered “peers” in a peer-to-peer interaction, such as a payment. In at least one example, the P2P platform 2112 can communicate with instances of a payment application 2126 (or other access point) installed on end user devices 2106 configured for operation by the users 2116. In an example, an instance of the payment application 2126 executing on a first user device 2106(B) operated by a payor (e.g., one of the users 2116) can send a request to the P2P platform 2112 to transfer an asset (e.g., fiat currency, non-fiat currency, digital assets such as non-fungible tokens (NFTs), cryptocurrency, securities, gift cards, and/or related assets) from the payor to a payee (e.g., a different one of the users 2116) via a peer-to-peer payment. In some examples, assets associated with an account of the payor are transferred to an account of the payee. In some examples, assets can be held at least temporarily in an account of the P2P platform 2112 prior to transferring the assets to the account of the payee.

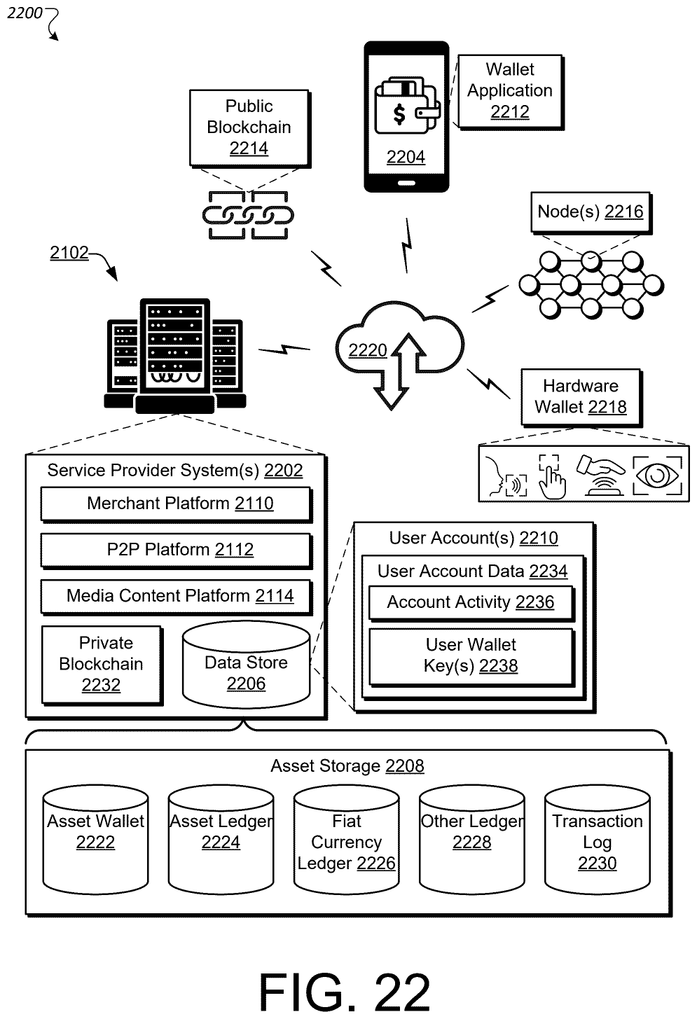

In some examples, the P2P platform 2112 can utilize a ledger system to track transfers of assets between users 2116. FIG. 22, below, provides additional details associated with such a ledger system. The ledger system can enable users 2116 to own fractional shares of assets that are not conventionally available. For instance, a user can own a fraction of a Bitcoin, an NFT, or a stock. Additional details are described herein.

In at least one example, the P2P platform 2112 can facilitate transfers and can send notifications related thereto to instances of the payment application 2126 executing on user device(s) of payee(s). As an example, the P2P platform 2112 can transfer assets from an account of a first user to an account of a second user and can send a notification to the user device 2106(B) of the second user for presentation via a user interface. The notification can indicate that a transfer is in process, a transfer is complete, or the like. In some examples, the P2P platform 2112 can send additional or alternative information to the instances of the payment application 2126 (e.g., low balance to the payor, current balance to the payor or the payee, etc.). In some examples, the payor and/or payee can be identified automatically, e.g., based on context, proximity, prior transaction history, and so on. In other examples, the payee can send a request for funds to the payor prior to the payor initiating the transfer of funds. In some embodiments, the P2P platform 2112 funds the request to payee on behalf of the payor, to speed up the transfer process and compensate for lags that may be attributed to the payor's financial network.

In some examples, the P2P platform 2112 can trigger the peer-to-peer payment process through identification of a “payment proxy” having a particular syntax. The payment proxy is useable in lieu of payment data. That is, payment data and a payment proxy can be linked to, or otherwise associated with, a user account of a user and either can be used for making payments. In an example, the syntax can include a monetary currency indicator prefixing one or more alphanumeric characters (e.g., $Cash). The currency indicator operates as the tagging mechanism that indicates to the server(s) 2102 to treat the inputs as a request from the payor to transfer assets, where detection of the syntax triggers a transfer of assets. The currency indicator can correspond to various currencies including but not limited to, dollar ($), euro (€), pound (£), rupee ( [symbol] ), yuan (¥), etc. Although use of the dollar currency indicator ($) is used herein, it is to be understood that any currency symbol or other symbol could equally be used. In some examples, additional or alternative identifiers can be used to trigger the peer-to-peer payment process. For instance, email, telephone number, social media handles, artist or band names, and/or the like can be used to trigger and/or identify users of a peer-to-peer payment process.

In some examples, the peer-to-peer payment process can be initiated through instances of the payment application 2126 executing on the end user devices 2106. In at least some embodiments, the peer-to-peer process can be implemented within a landing page associated with a user and/or an identifier of a user. The term “landing page,” as used here, refers to a virtual location identified by a personalized location address that is dedicated to collect payments on behalf of a recipient associated with the personalized location address. The personalized location address that identifies the landing page can be a uniform resource locator (URL), which can include a payment proxy discussed above. The P2P platform 2112 can generate the landing page to enable the recipient to conveniently receive one or more payments from one or more senders.

In some examples, the peer-to-peer payment process can be implemented within a forum. The term “forum,” as used here, refers to a content provider's media channel (e.g., a social networking platform, a microblog, a blog, video sharing platform, a music sharing platform, etc.) that enables user interaction and engagement through streaming of content, comments, posts, messages on electronic bulletin boards, messages on a social networking platform, and/or any other types of messages. In some examples, the content provider can be the service provider as described with reference to FIG. 21 or a third-party service provider associated with the server(s) 2108. In examples where the content provider is a third-party service provider, the server(s) 2108 can be accessible via one or more APIs 2118 or other integrations. In some examples, “forum” may also refer to an application or webpage of an e-commerce or retail organization that offers products and/or services. Such websites can provide an online “form” to complete before or after the products or services are added to a virtual cart. Some of these fields may be configured to receive payment information, such as a payment proxy, in lieu of other kinds of payment mechanisms, such as credit cards, debit cards, prepaid cards, gift cards, virtual wallets, etc.

In some embodiments, the peer-to-peer process can be implemented within a communication application, such as a messaging application. The term “messaging application,” as used here, refers to any messaging application that enables communication between users (e.g., sender and recipient of a message) over a wired or wireless communications network, through use of a communication message. The messaging application can be internal to the P2P platform 2112 (e.g., the P2P platform 2112 offers a chat or messaging service that is within the payment application or accessible via the payment application). In some examples, the messaging application can be external to the P2P platform 2112. (e.g., the messaging application is hosted by a third-party service provider associated with the server(s) 2108, which can be accessible via one or more of the APIs 2118 or other integrations). The messaging application can include, for example, a text messaging application for communication between phones (e.g., conventional mobile telephones or smartphones), or a cross-platform instant messaging application for smartphones and phones that use the Internet for communication.

Funds received from payments can be stored in stored balances that are linked to, or otherwise associated with, user accounts. In some examples, the P2P platform 2112 can enable users 2116 to perform banking transactions via instances of the payment application 2126. For example, users can configure direct deposits, recurring deposits, or other deposits (e.g., tax refunds, loans, etc.) for adding assets to their various ledgers/balances. In some examples, users can deposit physical cash via ATMs or other deposit sources, which can include merchants, such as those merchants that utilize the payment processing system described above. In some examples, the P2P platform 2112 can enable users to allocate funds between different accounts, sub-accounts, or balances (e.g., spending, saving, different assets, different currencies), etc. Further, users 2116 can configure bill pay, recurring payments, and/or the like using assets associated with their accounts. In some examples, the P2P platform 2112, with consent of the user, can track individual transactions made using the payment application and can utilize such transaction data to make personalized or customized recommendations, determine creditworthiness, generate tax documentation, and/or the like.

In addition to sending and/or receiving assets via peer-to-peer transactions, the P2P platform 2112 enables users to buy and/or sell assets via asset networks such as cryptocurrency networks, securities networks, and/or the like. In some examples, acquisition of such assets can be in whole or fractional shares. The ledger system described below with reference to FIG. 22 can enable such assets to be acquired in fractional shares and/or in real-time or near real-time (by delaying or omitting the need to buy/sell assets via asset networks or exchanges). In some examples, users can “gift” assets to other users, for example, by transferring cryptocurrency, stocks, or the like to one another.

In some examples, the P2P platform 2112 can enable users to link payment instruments to their user accounts. As a result, users can use their linked payment instruments to access funds in their accounts or balances. In some examples, the payment instrument can be a credit card, debit card, card linked to multiple accounts or balances via software or hardware, a fob or other object having payment data stored thereon, or the like. In some examples, the payment instrument can be a virtual payment instrument or a physical payment instrument. In some examples, the virtual payment instrument can be issued in real-time or for temporary usage. In some examples, the virtual payment instrument can have the same or different payment data as a corresponding physical payment instrument. Payment instruments can be customizable using a design user interface of the payment application. Such customization can enable users to select colors, stamps, images, text, or the like for surface(s) of their payment instruments. In some examples, users can draw or otherwise interact with the design user interface to personalize surface(s) of their payment instruments.

In some examples, users can associate incentives with their payment instruments. Incentives can be recommended to users based on user preferences (inferred or explicitly identified), geolocation, propensity to redeem, value, and/or the like. In some examples, incentives can be particular to individual merchants, types of merchants, types of transactions, and/or the like. In at least one example, when a user uses their payment instrument at a merchant or type of merchant associated with an incentive, or for a transaction type associated with an incentive, the P2P platform 2112 can automatically apply the incentive to the transaction. In some examples, users can gift other users “gift cards” that can be associated with payment instruments. That is, a user can transfer an amount of funds to another user and such funds can be associated with a condition (e.g., merchant, merchant type, transaction type, location, etc.) that, upon satisfaction, enables the amount of funds, or a portion thereof, to be applied to a transaction. In at least one example, when a user uses their payment instrument for a transaction that satisfies the condition, the P2P platform 2112 can automatically apply the amount of funds associated with the gift card to the transaction.

In some examples, users can configure their account such that when they use their payment instruments, the P2P platform 2112 can deposit an amount of funds into a savings account, investing account, bitcoin account, or the like.

In some examples, users can search for or browse other users, merchants, items, or the like via the payment application. In some examples, search results can be personalized and/or customized for the user (e.g., based on user data collected with consent of the user). In some examples, users can shop or otherwise purchase items from other users, merchants, or the like from within the payment application or via a deep link to a merchant application or website.

The P2P platform 2112 can offer primary and secondary accounts, wherein a primary account is a sponsor or other delegate of one or more secondary accounts. Such accounts can be useful for families, wherein a parent or other guardian is a sponsor or delegate to one or more child accounts, or where a child is a sponsor or delegate of an elderly parent's account. In some examples, primary accounts can establish limits on secondary accounts, such as spending limits, or the like. In some examples, the primary account owner is the user legally responsible for the account and their identity may be verifiable for secondary user accounts to perform certain transactions, such as buying/selling cryptocurrency or stocks. In some examples, one or more primary accounts and one or more secondary accounts can form a “group” with shared goals, such as saving, investing, or the like.

The P2P platform 2112 can present activity data via an activity user interface of the payment application. In some examples, activity can be presented by merchant, date, time, amount, or the like. In some examples, interactions between entities can be represented in conversational communications such that each interaction or transaction is represented as a message. In some examples, users can interact with individual messages and/or send/request funds from within such a conversational communication. In some examples, such conversational communications can represent conversations of a group of two or more users. Groups can be used to pool funds, obtain group discounts or incentives, or enable multiple users to participate in financial transactions together (e.g., group investing, group savings, etc.).

The P2P platform 2112 can offer a variety of financial training or learning opportunities. In some examples, such training or learning can be personalized for individual users, for example, based on user data and/or transaction data of the user that is obtained with consent of the user. In some examples, such user data and/or transaction data can be analyzed to make actionable recommendations with respect to optimizing financial health of users of the P2P platform 2112.

In some examples, components of the environment 2100 may be integrated to enable payments at the point-of-sale using assets associated with user accounts of the P2P platform 2112. As illustrated in the environment 2100, the components can communicate with one another via the network 2104, where one or more APIs 2118 or other functional components can be used to facilitate such communication.

In at least one example, an integration can enable a customer to participate in a transaction via their own computing device (e.g., user device 2106(B)) instead of interacting with a merchant device of a merchant, such as the seller device 2106(A). In such an example, the POS application 2120, associated with a payment processing platform and executable by the seller device 2106(A) of the merchant, can present a Quick Response (QR) code, or other code that can be used to identify a transaction (e.g., a transaction code), in association with a transaction between the customer and the merchant. The QR code, or other transaction code, can be provided to the POS application 2120 via an API 2118 associated with the peer-to-peer payment platform. In an example, the customer can utilize their own computing device, such as the user device 2106(B), to capture the QR code, or the other transaction code, and to provide an indication of the captured QR code, or other transaction code, to server(s) 2102.

Based at least in part on the integration of the peer-to-peer payment platform and the payment processing platform (e.g., via the API 2118), the server(s) 2102 of the merchant platform 2110 can exchange communications with a payment application 2126 associated with the P2P platform 2112 and/or the POS application 2120 to process payment for the transaction using a peer-to-peer payment where the customer is a first “peer” and the merchant is a second “peer.”

Based at least in part on receiving an indication of which payment method a user (e.g., customer or merchant) intends to use for a transaction, techniques described herein utilize an integration between the P2P platform 2112 and merchant platform 2110 (which can be a first- or third-party integration) such that a QR code, or other transaction code, specific to the transaction can be used for providing transaction details, location details, customer details, or the like to a computing device of the customer, such as the user device 2106(B), to enable a contactless (peer-to-peer) payment for the transaction, and transferring funds from an account of the customer to an account of the merchant.

In at least one example, techniques described herein can offer improvements to conventional payment technologies at both brick-and-mortar points of sale and online points of sale. For example, at brick-and-mortar points of sale, techniques described herein can enable customers to “scan to pay,” by using their computing devices to scan QR codes, or other transaction codes, encoded with data as described herein, to remit payments for transactions. In such a “scan to pay” example, a customer computing device, such as the user device 2106(B), can be specially configured as a buyer-facing device that can enable the customer to view cart building in near real-time, interact with a transaction during cart building using the customer computing device, authorize payment via the customer computing device, apply coupons or other incentives via the customer computing device, add gratuity, loyalty information, feedback, or the like via the customer computing device, etc. In another example, merchants can “scan for payment” such that a customer can present a QR code, or other transaction code, that can be linked to a payment instrument or stored balance. Funds associated with the payment instrument or stored balance can be used for payment of a transaction.

As described above, techniques described herein can offer improvements to conventional payment technologies at online points of sale, as well as brick-and-mortar points of sale. For example, multiple applications can be used in combination during checkout. That is, the POS application 2120 and the payment application 2126, as described herein, can process a payment transaction by routing information input via the merchant application to the payment application for completing a “frictionless” payment.

Returning to the “scan to pay” examples described herein, QR codes, or other transaction codes, can be presented in association with a merchant web page or ecommerce web page. In at least one example, techniques described herein can enable customers to “scan to pay,” by using their computing devices to scan or otherwise capture QR codes, or other transaction codes, encoded with data, as described herein, to remit payments for online/ecommerce transactions. A customer computing device, such as the user device 2106(B), can be specially configured as a buyer-facing device having functionality similar to the functionality described above in the brick-and-mortar example.

In some examples, based at least in part on capturing the QR code, or other transaction code, the merchant platform 2110 can provide transaction data to the P2P platform 2112 for presentation via the payment application 2126 on the computing device of the customer, such as the user device 2106(B), to enable the customer to complete the transaction via their own computing device. In some examples, in response to receiving an indication that the QR code, or other transaction code, has been captured or otherwise interacted with via the customer computing device, the P2P platform 2112 can determine that the customer authorizes payment of the transaction using funds associated with a stored balance of the customer that is managed and/or maintained by the P2P platform 2112. Such authorization can be implicit such that the interaction with the transaction code can imply authorization of the customer. Alternatively or additionally, the P2P platform 2112 can request express authorization to process payment for the transaction using the funds associated with the stored balance and the customer can interact with the payment application to expressly authorize the settlement of the transaction. In some examples, such an authorization (implicit or express) can be provided prior to a transaction being complete and/or initialization of a conventional payment flow. That is, in some examples, such an authorization can be provided during cart building (e.g., adding item(s) to a virtual cart) and/or prior to payment selection. In some examples, such an authorization can be provided after payment is complete (e.g., via another payment instrument). Based at least in part on receiving an authorization to use funds associated with the stored balance (e.g., implicitly or explicitly) of the customer, the P2P platform 2112 can transfer funds from the stored balance of the customer to the merchant platform 2110. In at least one example, the merchant platform 2110 can deposit the funds, or a portion thereof, into a stored balance of the merchant that is managed and/or maintained by the merchant platform 2110. In such an example, the merchant platform 2110 can be a “peer” to the customer in a peer-to-peer transaction.

In some examples, techniques described herein can enable the customer to interact with the transaction after payment for the transaction has been settled. For example, in at least one example, the merchant platform 2110 can cause a total amount of a transaction to be presented via a user interface associated with the payment application 2126 such that the customer can provide gratuity, feedback, loyalty information, or the like, via an interaction with the user interface. In another example, the merchant platform 2110 can adjust a total amount of a transaction based on events during a shopping experience, such as adding or removing a charge to the total amount based on whether a media content item requested by the customer to be played during a shopping experience was in fact played. In some examples, because the customer has already authorized payment via the P2P platform 2112, if the customer inputs a tip and/or an event affecting the total amount of the transaction is triggered, the P2P platform 2112 can transfer additional funds, associated with the tip or event, to the merchant platform 2110. This pre-authorization (or maintained authorization) of sorts can enable faster, more efficient payment processing when the tip is received and/or the event initiates the trigger. Further, the customer can provide feedback and/or loyalty information via the user interface presented by the payment application, which can be associated with the transaction. Using the pre-authorization techniques described herein results in fewer data transmissions and thus, techniques described herein can conserve bandwidth and reduce network congestion. Moreover, as described above, funds associated with tips can be received faster and more efficiently than with conventional payment technologies.

In addition to the improvements described above, techniques described herein can provide enhanced security in payment processing. In some examples, if a camera, or other sensor, used to capture a QR code, or other transaction code, is integrated into a payment application 2126 (e.g., instead of a native camera, or other sensor), techniques described herein can utilize an indication of the QR code, or other transaction code, received from the payment application for two-factor authentication to enable more secure payments.

It should be noted that, while techniques described herein are directed to contactless payments using QR codes or other transaction codes, in additional or alternative examples, techniques described herein can be applicable for contact payments. That is, in some examples, a customer can swipe a payment instrument (e.g., a credit card, a debit card, or the like) via a reader device associated with a merchant device, dip a payment instrument into a reader device associated with a merchant computing device, tap a payment instrument with a reader device associated with a merchant computing device, or the like, to initiate the provisioning of transaction data to the customer computing device. In some examples, the payment instrument can be associated with the P2P platform 2112 as described herein (e.g., a debit card linked to a stored balance of a customer) such that when the payment instrument is caused to interact with a payment reader, the merchant platform 2110 can exchange communications with the P2P platform 2112 to authorize payment for a transaction and/or provision associated transaction data to a computing device of the customer associated with the transaction.

Turning now to media content functionality provided by the environment 2100, the media content platform 2114 can provide digital media to a content consumption device 2106(D) where playback may occur using “streaming.” In examples, “streaming” media content involves encoding the media content and transmitting the encoded media content over the network 2104 to a media player or a media application executing on a device (e.g., via a speaker). The device then decodes and plays the media content while data is being received. In some cases, a buffer queues some of the data of the media content (e.g., audio data, video data, etc.) ahead of the media being played. During moments of network congestion, which leads to lower available bandwidth, less media content data is added to the buffer, which drains down as media content is being dequeued during streaming playback. However, during moments of high network bandwidth, the buffer is replenished, adding media content data to the buffer.

In at least one example, the media content platform 2114 can provide a digital media streaming service (e.g., subscription-based, non-subscription-based) that enables a content consumption device 2106(D) to stream and/or download digital media content via a listener application 2128 installed on the content consumption device 2106(D). For instance, the media content platform 2114 may comprise a digital audio streaming service (e.g., for music, podcasts, audiobooks, etc.), a digital video streaming service, and/or a streaming service that provides streaming of various different types of digital media content or multimedia. In such cases where digital media content items are downloaded and stored locally on the content consumption devices 2106(D), the listener application 2128 may verify access rights to the digital media content items at time intervals, for instance intermittently (e.g., when the content consumption device 2106(D) has a network connection with the media content platform 2114 via the network(s) 2104), and/or at regular intervals (e.g., daily, weekly, monthly, etc.). In examples, access rights to the digital media content items may be provided when a subscription to the media content platform 2114 is active, while access rights to the digital media content items may be withheld when the subscription to the media content platform 2114 is terminated. Enabling storage on the end user devices 2106 and subsequent access to digital media content items via the listener application 2128 provides the users 2116 with the ability to access the digital media content items “offline” such as when a connection to the media content platform 2114 via the network(s) 2104 is unavailable or unreliable.

In some examples, the media content platform 2114 may additionally or alternatively provide an artist management service that enables the users 2116 to manage aspects of artist business via an artist application 2130 installed on the artist device 2106(E), such as data analytics and management (e.g., listener data, consumer data, etc.), marketing, regulatory obligations, cash flow management, publishing, customer relationship management (CRM), social media, event coordination, industry communications, digital media content ingestion and storage, and so forth. In some cases, the users 2116 can have graduated access to the services, which can be based on a user type (e.g., artist, group member, personal manager, business manager, attorney, agent, etc.), risk tolerance, artist verification status, listener and/or viewer analytics (e.g., number of streams in a month), and so on. In some cases, multiple users 2116 may have access to a single user account via respective end user devices 2106, with the various users having different access privileges to services provided by the artist management service. In various scenarios, an artist can designate functions provided by the artist management service to different members of the team associated with the artist, thus granting the respective team members access to services suited to the skills of the individual team members.

In some cases, the artist application 2130 and the listener application 2128 may be distinct applications having differing user experiences and verification processes for access, such as illustrated in the environment 2100. For instance, the media content platform 2114 may request additional verification, such as a link to an artist website, a sample of an artist's work, a verified credential supplied by a third party, etc. to grant access to the artist application 2130 in addition to information requested to access the listener application 2128. Further, the artist application 2130 may provide the artist management services described herein, without the subscription-based digital media streaming services described herein, and vice versa. However, examples are also considered in which functionality provided by the artist application 2130 and the listener application 2128 partially or fully overlap, and/or where verification processes for access are substantially similar.

In at least some examples, the media content platform 2114 enables interaction between the users 2116 utilizing the listener application 2128 installed on the content consumption devices 2106(D), and the users 2116 utilizing the artist application 2130 installed on the artist end user devices 2106(E). For example, the media content platform 2114 may provide interconnectivity between the subscription-based digital media streaming service and the artist management service. Functionality provided by the media content platform 2114 in such instances may include a communication channel between one or more of the users 2116 (e.g., a listener, fan, music supervisor, publisher, etc.) utilizing the listener application 2128 and another user (e.g., an artist) of the users 2116 utilizing the artist application 2130. The communication channel may include, for instance, a messaging platform (also referred to as a “messaging application” herein), a live streaming platform, a videoconferencing or teleconferencing platform, and/or a combination of these.

Additionally, in some cases, the media content platform 2114 may facilitate a resource transfer between the listener application 2128 and the artist application 2130. In an example, the media content platform 2114 may direct a resource, such as a portion of a subscription fee paid by one of the users 2116 designated as a listener, to one or more of the users 2116 designated as artists based on a number of instances that the listening user consumed (e.g., streamed, downloaded, etc.) content created by respective ones of the artist users. Alternatively or additionally, the media content platform 2114 may direct a resource, such as funds, from an account associated with a listening user to an account associated with an artist user (or vice versa), in accordance with transfers between accounts as described herein. The media content platform 2114 may facilitate resource transfers in examples such as merchandise purchases, event ticket purchases, “tipping” an artist, payments for royalties or other fees, and so forth.

In some examples, the media content platform 2114 enables interaction between individual ones of the users 2116 with one another via the listener application 2128 installed on the content consumption device 2106(D) and other of the content consumption devices 2106(D) via a communication channel as described above. In an example, the listener application 2128 may provide functionality via a communication channel for a user to stream an individual digital media item, a playlist, or the like to an audience comprising other ones of the content consumption devices 2106(D). Alternatively or additionally, the communication channel may facilitate sharing of individual digital media items, playlists, user and/or artist profiles, and the like between the users 2116 via messages, uniform resource locators (URLs), quick response (QR) codes, and so forth.

In some cases, the media content platform 2114 enables interaction between individual ones of the users 2116 with one another via the artist application 2130 installed on the artist device 2106(E) and other of the artist end user devices 2106 via a communication channel as described above. In some instances, the media content platform 2114 may provide recommendations for a particular user indicating which of the other users 2116 to communicate with. Such a recommendation may be based on a similarity (or dissimilarity) of content created by two or more of the users 2116, an overlap (or lack thereof) of audience members of the users 2116, a geographic location of the users 2116, a coinciding event location of the users 2116, and so forth. In some examples, a user may input parameters for a desired connection via the artist application 2130, and the media content platform 2114 may filter which of the users 2116 to surface for recommendations to the user based on the input parameters. Alternatively or additionally, the media content platform 2114 may implement one or more machine learning models to filter which of the users 2116 to surface for recommendations to the user. The recommendations provided by the media content platform 2114 may be data driven and thus increase relevance of communications presented to the users 2116 and reduce unsolicited communications that may be received by the users 2116.

The media content platform 2114 may interact with the server(s) 2108 associated with the third-party service providers to, for instance, ingest digital media items, report digital media consumption data, pay royalties, and the like. In some examples, the server(s) 2108 may be accessible by the media content platform 2114 via one or more APIs 2118 or other integrations. In some cases, the third-party service provider may be a digital media content provider (e.g., a record label, a performance rights organization (PRO), an independent artist, etc.). In such cases, the media content platform 2114 may receive digital media content items from the server(s) 2108, along with metadata associated with the digital media content items. The metadata, in some instances, may indicate individual contributors to a digital media content item such as an artist or artists, a songwriter (e.g., a composer, lyricist, author, etc.), a producer (which may further include a co-producer, a mastering engineer, a mixing engineer, a recording engineer, an arranger, a programmer, etc.), a musician (e.g., instrumentalist, vocalist, etc.), a visual artist, and so forth, with an indication of the role of the individual contributor. Alternatively or additionally, the metadata may indicate information such as release date, track title, track duration, clean or explicit version, jurisdiction information, and the like. The media content platform 2114 may use the metadata to associate the digital media content item as being created by a particular user, to provide search results to the users 2116, to generate playlists, and so forth. Further, the media content platform 2114 may provide payments (e.g., royalties) to the third-party service provider based on a number of streams and/or downloads of individual digital media content items by the users 2116 via the listener application 2128.

Techniques described herein are directed to services provided via a distributed system of end user devices 2106 that are in communication with server(s) 2102 of the service provider. That is, techniques described herein are directed to a specific implementation—or, a practical application—of utilizing a distributed system of end user devices 2106 that are in communication with server(s) 2102 of the merchant platform 2110, the P2P platform 2112, and/or the media content platform 2114 to perform a variety of services, as described above. The unconventional configuration of the distributed system described herein enables the server(s) 2102 that are remotely-located from end-users (e.g., users 2116) to intelligently offer services based on aggregated data associated with the end-users, such as the users 2116 (e.g., data associated with multiple, different merchants and/or multiple, different buyers; data associated with multiple different listeners and/or multiple different artists, etc.), in some examples, in near-real time. Accordingly, techniques described herein are directed to a particular arrangement of elements that offer technical improvements over conventional techniques for performing payment processing services, P2P payment services, media content services, and the like. For small business owners and artists in particular, the business environment is typically fragmented and relies on unrelated tools and programs, making it difficult for an owner or an artist to manually consolidate and view such data. The techniques described herein constantly or periodically monitor disparate and distinct user accounts, e.g., accounts within the control of the merchant platform 2110, the P2P platform 2112, and/or the media content platform 2114, and those outside of the control of these service providers, to track the standing (payables, receivables, payroll, invoices, appointments, capital, balances, collaborations, etc.) of the users 2116. The techniques herein provide a consolidated view of a user's cash flow, predict needs, preemptively offer recommendations or services, such as capital, coupons, etc., and/or enable money movement between disparate accounts (merchant's, another merchant's, or even payment service's) in a frictionless and transparent manner.

As described herein, artificial intelligence, machine learning, and the like can be used to dynamically make determinations, recommendations, and the like, thereby adding intelligence and context-awareness to an otherwise one-size-fits-all scheme for providing payment processing services, P2P payment services, media content services, and/or additional or alternative services described herein. In some implementations, the distributed system is capable of applying the intelligence derived from an existing user base to a new user, thereby making the onboarding experience for the new user personalized and frictionless when compared to traditional onboarding methods. Further, models or algorithms that are used to implement techniques described herein may be retrained over time to improve outcomes for subsequent scenarios based on outcomes of previous scenarios. Thus, techniques described herein improve existing technological processes.

As described above, various graphical user interfaces (GUIs) can be presented to facilitate techniques described herein. Some of the techniques described herein are directed to user interface features presented via GUIs to improve interaction between users 2116 and end user devices 2106. Furthermore, such features are changed dynamically based on the profiles of the users involved interacting with the GUIs. As such, techniques described herein are directed to improvements to computing systems.

The merchant platform 2110, the P2P platform 2112, and/or the media content platform 2114 are capable of providing additional or alternative services, and the services described above are offered as a sampling of services. In at least one example, the merchant platform 2110, the P2P platform 2112, and/or the media content platform 2114 can exchange data with the server(s) 2108 associated with third-party service providers. Such third-party service providers can provide information that enables the merchant platform 2110, the P2P platform 2112, and/or the media content platform 2114 to provide services, such as those described above. In additional or alternative examples, such third-party service providers can access services of the merchant platform 2110, the P2P platform 2112, and/or the media content platform 2114. That is, in some examples, the third-party service providers can be subscribers, or otherwise access, services of the merchant platform 2110, the P2P platform 2112, and/or the media content platform 2114.

FIG. 22 illustrates an example environment 2200 including a service provider system 2202 which may be associated with the server(s) 2102 of FIG. 21. The environment 2200 may also include a user device 2204, which may correspond to any of the end user devices 2106 described in relation to FIG. 21. In examples, the service provider system 2202 may include one or a combination of the merchant platform 2110, the P2P platform 2112, or the media content platform 2114, as well as one or more data store(s) 2206 that can store assets in an asset storage 2208, as well as data in user account(s) 2210. In some examples, the environment 2200 may also include a public blockchain 2214, one or more nodes 2216, and/or a hardware wallet 2218. The service provider system 2202, the user device 2204, public blockchain 2214, the node(s) 2216, and the hardware wallet 2218 may be connected and able to communicate via one or more networks 2220, which may have the same or similar functionality described in relation to the network 2104 of FIG. 21.

In some examples, user account(s) 2210 can include merchant account(s), customer account(s), media content subscriber account(s), artist account(s), and so forth. In at least one example, the asset storage 2208 can be used to record whether individual assets are registered to a user account 2210. For example, the asset storage 2208 can include asset wallet(s) 2222 for storing records of assets owned by the service provider system 2202, such as cryptocurrency, securities, NFTs, or the like, and communicating with one or more asset networks, such as cryptocurrency networks, NFT networks, securities networks, or the like. In some examples, the asset network can be a first-party network or a third-party network, such as a cryptocurrency exchange or the stock market. In examples where the asset network is a third-party network, the server(s) 2108 of FIG. 21 can be associated therewith.

The asset wallet 2222 can be associated with one or more addresses and can vary addresses used to acquire assets (e.g., from the asset network(s)) so that its holdings are represented under a variety of addresses on the asset network. In examples where the service provider system 2202 has holdings of cryptocurrency (e.g., in the asset wallet 2222), a user can acquire cryptocurrency directly from the service provider system 2202. In some examples, the service provider system 2202 can include logic for buying and selling cryptocurrency to maintain a desired level of cryptocurrency. In some examples, the desired level can be based on a volume of transactions over a period of time, balances of collective cryptocurrency ledgers, exchange rates, or trends in changing of exchange rates such that the cryptocurrency is trending towards gaining or losing value with respect to the fiat currency. In some scenarios, the buying and selling of cryptocurrency, and therefore the associated updating of the public ledger of an asset network can be separate from a customer-merchant transaction or a peer-to-peer transaction, and therefore not necessarily time-sensitive. This can enable batching transactions to reduce computational resources and/or costs. The service provider system 2202 can provide the same or similar functionality for securities or other assets.

The asset storage 2208 may contain ledgers that store records of assignments of assets to users 2116. Specifically, the asset storage 2208 may include asset ledger 2224, fiat currency ledger 2226, and/or other ledger(s) 2228, which can be used to record transfers of assets between users 2116 and/or one or more third-parties (e.g., merchant network(s), payment card network(s), ACH network(s), equities network(s), the asset network, securities networks, etc.). In doing so, the asset storage 2208 can maintain a running balance of assets managed by the service provider system 2202. The ledger(s) of the asset storage 2208 can further indicate some of the running balance for individual ledger(s) stored in the asset storage 2208 are assigned or registered to one or more user account(s) 2210.

In at least one example, the asset storage 2208 can include transaction logs 2230, which can include, as transaction data, records of past transactions involving the service provider system 2202 and/or the user account 2210. In some examples, the data store(s) 2206 can store a private blockchain 2232. A private blockchain 2232 can function to record sender addresses, recipient addresses, public keys, values of cryptocurrency transferred, and/or can be used to verify ownership of cryptocurrency tokens to be transferred. In some examples, the service provider system 2202 can record transactions involving cryptocurrency until the number of transactions has exceeded a determined limit (e.g., number of transactions, storage space allocation, etc.). Based at least in part on determining that the limit has been reached, the service provider system 2202 can publish the transactions in the private blockchain 2232 to the public blockchain 2214 (e.g., associated with the asset network), where miners can verify the transactions and record the transactions to blocks on the public blockchain 2214. In at least one example, the service provider system 2202 can participate as miner(s) at least for transactions to which the respective platform is a party to, to be posted to the public blockchain 2214.

In some cases, the data store(s) 2206 can store and/or manage multiple user accounts, an example of which is described in relation to the user account 2210. In at least one example, the user account 2210 can include user account data 2234, which can include, but is not limited to, data associated with user identifying information (e.g., name, phone number, address, artist or band name, verified credentials, etc.), user identifier(s) (e.g., alphanumeric identifiers, etc.), user preferences (e.g., learned or user-specified), purchase history data (e.g., identifying one or more items purchased (and respective item information), subscription tier information, etc.), linked payment sources (e.g., bank account(s), stored balance(s), etc.), payment instruments used to purchase one or more items, returns associated with one or more orders, statuses of one or more orders (e.g., preparing, packaging, in transit, delivered, etc.), etc.), appointments data (e.g., previous appointments, upcoming (scheduled) appointments, timing of appointments, lengths of appointments, etc.), payroll data (e.g., employers, payroll frequency, payroll amounts, etc.), reservations data (e.g., previous reservations, upcoming (scheduled) reservations, reservation duration, interactions associated with such reservations, etc.), inventory data, user service data, loyalty data (e.g., loyalty account numbers, rewards redeemed, rewards available, etc.), risk indicator(s) (e.g., level(s) of risk), etc.

In at least one example, the user account data 2234 can include account activity 2236 and user wallet key(s) 2238. In some examples, the user wallet key(s) 2238 can include a public-private key-pair and a respective address associated with the asset network or other asset networks. In some examples, the user wallet key(s) 2238 may include one or more key pairs, which can be unique to the asset network or other asset networks.

In addition to the user account data 2234, the user account 2210 can include ledger(s) for account(s) managed by the service provider system 2202, for the user. For example, the user account 2210 may include an asset ledger 2224, a fiat currency ledger 2226, and/or one or more other ledgers 2228. The ledger(s) can indicate that a corresponding user utilizes the service provider system 2202 to manage corresponding accounts (e.g., a cryptocurrency account, a securities account, a fiat currency account, an artist account, etc.). It should be noted that in some examples, the ledger(s) can be logical ledger(s) and the data can be represented in a single database. In some examples, individual ones of the ledger(s), or portions thereof, can be maintained by the service provider system 2202.

In some examples, the asset ledger 2224 can store a balance for each of one or more cryptocurrencies (e.g., Bitcoin, Ethereum, Litecoin, etc.) registered to the user account 2210. In at least one example, the asset ledger 2224 can further record transactions of cryptocurrency assets associated with the user account 2210. For example, the user account 2210 can receive cryptocurrency from the asset network using the user wallet key(s) 2238. In some examples, the user wallet key(s) 2238 may be generated for the user upon request. User wallet key(s) 2238 can be requested by the user in order to send, exchange, or otherwise control the balance of cryptocurrency held by the service provider system 2202 (e.g., in the asset wallet 2222) and registered to the user. In some examples, the user wallet key(s) 2238 may not be generated until a user account requires such. This on-the-fly wallet key generation provides enhanced security features for users, reducing the number of access points to a user account's balance and, therefore, limiting exposure to external threats.

Each account ledger can reflect a positive balance when funds are added to the corresponding account. An account can be funded by transferring currency in the form associated with the account from an external account (e.g., transferring a value of cryptocurrency to the service provider system 2202 and the value is credited as a balance in asset ledger 2224), by purchasing currency in the form associated with the account using currency in a different form (e.g., buying a value of cryptocurrency from the service provider system 2202 using a value of fiat currency reflected in fiat currency ledger 12391226, and crediting the value of cryptocurrency in asset ledger 2224), or by conducting a transaction with another user (customer or merchant) of the service provider system 2202 wherein the account receives incoming currency (which can be in the form associated with the account or a different form, in which the incoming currency may be converted to the form associated with the account).

With specific reference to funding a cryptocurrency account, a user may have a balance of cryptocurrency stored in another cryptocurrency wallet. In some examples, the other cryptocurrency wallet can be associated with a third-party unrelated to the service provider system 2202 (i.e., an external account). Such a transaction can request that the user to transfer an amount of the cryptocurrency in a message signed by user's private key to an address provided by the service provider system 2202. In at least one example, the transaction can be sent to miners to bundle the transaction into a block of transactions and to verify the authenticity of the transactions in the block. Once a miner has verified the block, the block is written to the public blockchain 2214 where the service provider system 2202 can then verify that the transaction has been confirmed and can credit the user's asset ledger 2224 with the transferred amount. When an account is funded by transferring cryptocurrency from a third-party cryptocurrency wallet, an update can be made to the public blockchain 2214. In some cases, this update of the public blockchain 2214 need not take place at a time-critical moment, such as when a transaction is being processed by a merchant in store or online.

In some examples, a user can purchase cryptocurrency to fund their cryptocurrency account. In some examples, the user can purchase cryptocurrency through services offered by the service provider system 2202. As described above, in some examples, the service provider system 2202 can acquire cryptocurrency from a third-party source. In examples where the service provider system 2202 has its own cryptocurrency assets, cryptocurrency transferred in a transaction (e.g., data with address provided for receipt of transaction and a balance of cryptocurrency transferred in the transaction) can be stored in an asset wallet 2222 associated with the service provider system 2202. In at least one example, the service provider system 2202 can credit the asset ledger 2224 of the user. Additionally, while the service provider system 2202 recognizes that the user retains the value of the transferred cryptocurrency through crediting the asset ledger 2224, an inspection of the blockchain shows the cryptocurrency as having been transferred to the service provider system 2202. In some examples, the asset wallet 2222 can be associated with many different addresses. In such examples, an inspection of the blockchain may not necessarily associate all cryptocurrency stored in asset wallet 2222 as belonging to the same entity. The presence of a private ledger used for real-time transactions and maintained by the service provider system 2202, combined with updates to the public ledger at other times, allows for extremely fast transactions using cryptocurrency to be achieved. In some examples, the “private ledger” can refer to the asset ledger 2224, which in some examples, can utilize the private blockchain 2232, as described herein. The “public ledger” can correspond to the public blockchain 2214 associated with the asset network.

In at least one example, an asset ledger 2224, fiat currency ledger 2226, or the like associated with the user account 2210 can be credited when conducting a transaction with another user (customer or merchant) wherein the user receives incoming currency. In some examples, a user can receive cryptocurrency in the form of payment for a transaction with another user. In at least one example, such cryptocurrency can be used to fund the asset ledger 2224. In some examples, a user can receive fiat currency or another currency in the form of payment for a transaction with another user. In at least one example, at least a portion of such funds can be converted into cryptocurrency by the service provider system 2202 and used to fund the asset ledger 2224 of the user.

In examples, a user can also have an account in U.S. dollars, which can be tracked, for example, via the fiat currency ledger 2226. Such an account can be funded by transferring money from a bank account at a third-party bank to an account maintained by the service provider system 2202 as is conventionally known. In some examples, a user can receive fiat currency in the form of payment for a transaction with another user. In such examples, at least a portion of such funds can be used to fund the fiat currency ledger 2226.

In some examples, a user can have one or more internal payment cards registered with the service provider system 2202. Internal payment cards can be linked to one or more of the accounts associated with the user account 2210. In some embodiments, options with respect to internal payment cards can be adjusted and managed using an application (e.g., the payment application 2126, a wallet application 2212, etc.).

In at least one example, the user account 2210 can be associated with the asset wallet accessible via a wallet application 2212 of the user device 2204, or a stored balance for use in payment transactions, peer-to-peer transactions, payroll payments, etc. In at least one example, the asset wallet 2222 can store data indicating an address provided for receipt of a cryptocurrency transaction. In at least one example, the balance of the asset wallet 2222 can be based at least in part on a balance of the asset ledger 2224. In at least one example, funds availed via the asset wallet 2222 can be stored in the asset wallet 2222. Funds availed via the asset wallet 2222 can be tracked via the asset ledger 2224. The asset wallet 2222, however, can be associated with additional cryptocurrency funds.

In at least one example, when the service provider system 2202 includes a private blockchain 2232 for recording and validating cryptocurrency transactions, the asset wallet 2222 can be used instead of, or in addition to, the asset ledger 2224. For example, a merchant can provide the address of the asset wallet 2222 for receiving payments. In an example where a customer is paying in cryptocurrency and the customer has their own cryptocurrency wallet account associated with the service provider system 2202, the customer can send a message signed by its private key including its wallet address (i.e., of the customer) and identifying the cryptocurrency and value to be transferred to the merchant's asset wallet 2222. The service provider system 2202 can complete the transaction by reducing the cryptocurrency balance in the customer's cryptocurrency wallet and increasing the cryptocurrency balance in the merchant's asset wallet 2222. In addition to recording the transaction in the respective cryptocurrency wallets, the transaction can be recorded in the private blockchain 2232 and the transaction can be confirmed. A user can perform a similar transaction with cryptocurrency in a peer-to-peer transaction as described above.

While the asset ledger 2224 and/or asset wallet 2222 are each described above with reference to cryptocurrency, the asset ledger 2224 and/or asset wallet 2222 can alternatively be used in association with securities. In some examples, different ledgers and/or wallets can be used for different types of assets. That is, in some examples, a user can have multiple asset ledgers and/or asset wallets for tracking cryptocurrency, securities, or the like.

It should be noted that user(s) having accounts managed by the service provider system 2202 is an aspect of the technology disclosed that enables technical advantages of increased processing speed and improved security.

The description of the environment 2200 above generally relates to a centralized service provider system 2202 that at least partially facilitates storing and managing assets in the data store 2206. However, the environment 2200 may also facilitate decentralized storage and management of assets alternatively or in addition to centralized storage and management as described above. For instance, the environment 2200 may include a decentralized platform implemented using a plurality of nodes (e.g., web nodes), an example of which is illustrated as node 2216. The node 2216 is representative of a computer or other device tasked with validating transactions and/or maintaining a copy of a blockchain ledger, such as a ledger associated with the public blockchain 2214. The decentralized platform may be implemented via the environment 2200 through use of decentralized identifiers and verifiable credentials that are stored and managed by user devices 2204. A decentralized identifier is configured as a self-owned identifier that supports decentralized authentication and routing. A self-owned identifier in a blockchain network is a unique identifier that is owned and controlled by an individual entity on the blockchain, as contrasted with an entity controlled by a centralized authority (e.g., the service provider system 2202). The decentralized identity referenced by a decentralized identifier gives an entity control over what data can be accessed, stored, modified, and so forth by other entities, such as the service provider system 2202.

The node 2216, as representative of one of a plurality of decentralized nodes (e.g., decentralized web nodes), supports data storage and relays that allows entities, service provider systems, individuals, organizations and so forth to send, store, and receive encrypted or public messages and data. The node 2216 is universally addressable and is “crawlable” using data addressing in relation to the decentralized identifiers. The node 2216 is also configured to support decentralized replication of data across the nodes that is consistent across multiple nodes over time through continued data communication between the nodes in the decentralized platform. The node 2216 is configurable to support secure encryption through use of a cryptographic key associated with an individual's decentralized identifier and support semantic discovery to discover different forms of published data.

Verifiable credentials are an open standard for digital credentials, and employ a data format for cryptographic presentation and verification of claims. A verifiable credential represents an indication of trust of a piece of information related to an entity. For example, a verifiable credential indicates that the issuer of the verifiable credential trusts the holder of the verifiable credential; the holder trusts a verifier of the verifiable credential; and that the verifier trusts the issuer. Verifiable credentials may be issued by anyone, about anything, and can be presented to and verified by everyone granted access to the verifiable credential. Accordingly, a user of the user device 2204 may be an issuer, a holder, and/or a verifier, as can the service provider system 2202.

In some examples, the user device 2204 may implement a wallet application 2212 configured to manage decentralized identifiers and/or verifiable credentials. For instance, the wallet application 2212 may provide a user interface for implementation of access controls to various data associated with the decentralized identifier by the service provider system 2202, to other user devices, and so forth. Additionally, the wallet application 2212 may be configured to provide functionality for resource transfers (e.g., cryptocurrency, fiat currency, etc.) with the service provider system 2202, other user devices, and the like, based on techniques described herein.

In some examples, the hardware wallet 2218 may store cryptocurrency assets in combination with the wallet application 2212 and the service provider system 2202. For instance, the hardware wallet 2218, the wallet application 2212, and the service provider system 2202 may each store a respective, different private key, where a transaction with the cryptocurrency assets is signed by at least two of the three private keys. The user interface provided by the wallet application 2212 may allow a user to request a transaction. The wallet application 2212 may then sign the transaction with the private key of the wallet application 2212, have either the hardware wallet 2218 or the service provider system 2202 use a second of the three private keys to sign the transaction, and then provide the transaction with two signatures to the public blockchain 2214 for processing.

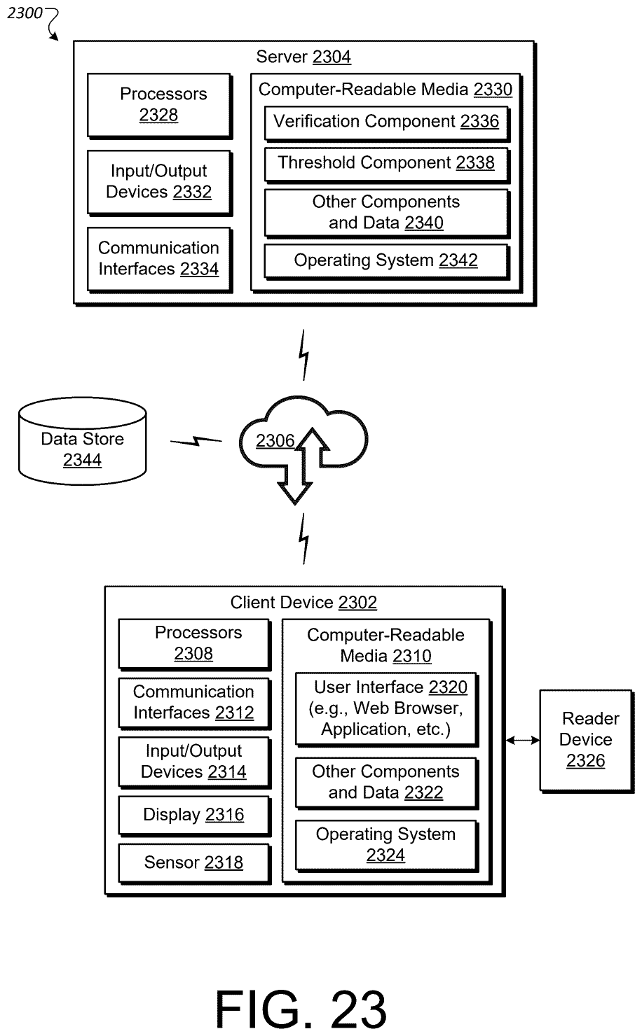

FIG. 23 depicts an illustrative block diagram illustrating a system 2300 for performing techniques described herein. The system 2300 includes a user device 2302, that communicates with server computing device(s) (e.g., server(s) 2304) via network(s) 2306 (e.g., the Internet, cable network(s), cellular network(s), cloud network(s), wireless network(s) (e.g., Wi-Fi) and wired network(s), as well as close-range communications such as Bluetooth®, Bluetooth® low energy (BLE), and the like). While a single user device 2302 is illustrated, in additional or alternate examples, the system 2300 can have multiple user devices, as described above with reference to FIG. 21.

In some examples, the client device 2302 and/or the server 2304 can include the the decentralized network 102, the first edge device 110, the key device 112, the supplemental interface 114, the second edge device 116, the wallet server 126, the network 128, a system that performs the procedure 400, a system that performs the procedure 600, the blockchain system 1202, the blockchain nodes 1204, the virtual machine 1206, the distributed ledgers 1208, the storage 1214, the blockchain 1216, the distributed state machine 1224, the decentralized web application 1226, the system 1300, the blockchain system 1302, the identity hub 1304, the institutional system 1306, the communication protocol 1308, the data store and message relay system 1320, the point-to-point messaging protocol 1324, a system that performs the process 2000, or a combination thereof. The user interface 2320 can be associated with the user interface 802, the user interface 902, the user interface 1002, the user interface 1402, the user interface 1408, the user interface 1414, the user interface 1420, the user interface 1508, the user interface 1608, the user interface 1708, the user interface 1802, the user interface 1806, the user interface 1810, the user interface 1814, the user interface 1908, or any other user interface discussed herein.

In at least one example, the user device 2302 can be any suitable type of computing device, e.g., portable, semi-portable, semi-stationary, or stationary. Some examples of the user device 2302 can include, but are not limited to, a tablet computing device, a smart phone or mobile communication device, a laptop, a netbook or other portable computer or semi-portable computer, a desktop computing device, a terminal computing device or other semi-stationary or stationary computing device, a dedicated device, a wearable computing device or other body-mounted computing device, an augmented reality device, a virtual reality device, a speaker device, an automobile or other vehicle type, an Internet of Things (IoT) device, etc. That is, the user device 2302 can be any computing device capable of sending communications and performing the functions according to the techniques described herein. The user device 2302 can include devices, e.g., payment card readers, or components capable of accepting payments, as described below. The user device 2302 may be representative of, and provide functionality for, the user devices 2106 described in relation to FIG. 21.

In the illustrated example, the user device 2302 includes one or more processors 2308, one or more computer-readable media 2310, one or more communication interface(s) 2312, one or more input/output (I/O) devices 2314, a display 2316, sensor(s) 2318, one or more encoders 2346, and one or more decoders 2348.

In at least one example, each processor 2308 can itself comprise one or more processors or processing cores. For example, the processor(s) 2308 can be implemented as one or more microprocessors, microcomputers, microcontrollers, digital signal processors, central processing units, state machines, logic circuitries, and/or any devices that manipulate signals based on operational instructions. In some examples, the processor(s) 2308 can be one or more hardware processors and/or logic circuits of any suitable type specifically programmed or configured to execute the algorithms and processes described herein. The processor(s) 2308 can be configured to fetch and execute computer-readable processor-executable instructions stored in the computer-readable media 2310.

Depending on the configuration of the user device 2302, the computer-readable media 2310 can be an example of tangible non-transitory computer storage media and can include volatile and nonvolatile memory and/or removable and non-removable media implemented in any type of technology for storage of information such as computer-readable processor-executable instructions, data structures, program components or other data. The computer-readable media 2310 can include, but is not limited to, RAM, ROM, EEPROM, flash memory, solid-state storage, magnetic disk storage, optical storage, and/or other computer-readable media technology. Further, in some examples, the user device 2302 can access external storage, such as RAID storage systems, storage arrays, network attached storage, storage area networks, cloud storage, or any other medium that can be used to store information and that can be accessed by the processor(s) 2308 directly or through another computing device or network. Accordingly, the computer-readable media 2310 can be computer storage media able to store instructions, components or components that can be executed by the processor(s) 2308. Further, when mentioned, non-transitory computer-readable media exclude media such as energy, carrier signals, electromagnetic waves, and signals per se.

The computer-readable media 2310 can be used to store and maintain any number of functional components that are executable by the processor(s) 2308. In some implementations, these functional components comprise instructions or programs that are executable by the processor(s) 2308 and that, when executed, implement operational logic for performing the actions and services attributed above to the user device 2302. Functional components stored in the computer-readable media 2310 can include a user interface 2320 to enable users to interact with the user device 2302, and thus the server(s) 2304 and/or other networked devices. In some examples, the user interface 2320 can include a UI associated with a mining application used to perform, control, and/or monitor the mining operations discussed herein, as performed using the mining ASIC(s) of the hashboard(s) discussed herein. In at least one example, a user can interact with the user interface via touch input, spoken input, gesture, or any other type of input. The word “input” is also used to describe “contextual” input that may not be directly provided by the user via the user interface 2320. For example, user's interactions with the user interface 2320 are analyzed using, e.g., natural language processing techniques, user movement tracking techniques, eye tracking techniques, etc. to determine context or intent of the user, which may be treated in a manner similar to “direct” user input.

Depending on the type of the user device 2302, the computer-readable media 2310 can also optionally include other functional components and data, such as other components and data 2322, which can include programs, drivers, etc., and the data used or generated by the functional components. In addition, the computer-readable media 2310 can also store data, data structures and the like, that are used by the functional components. Further, the user device 2302 can include many other logical, programmatic and physical components, of which those described are merely examples that are related to the discussion herein.

In at least one example, the computer-readable media 2310 can include additional functional components, such as an operating system 2324 for controlling and managing various functions of the user device 2302 and for enabling user interactions.

The communication interface(s) 2312 can include one or more interfaces and hardware components for enabling communication with various other devices, such as over the network(s) 2306 or directly. For example, communication interface(s) 2312 can enable communication through one or more network(s) 2306, which can include, but are not limited any type of network known in the art, such as a local area network or a wide area network, such as the Internet, and can include a wireless network, such as a cellular network, a cloud network, a local wireless network, such as Wi-Fi and/or close-range wireless communications, such as Bluetooth®, BLE, NFC, RFID, a wired network, or any other such network, or any combination thereof. Accordingly, network(s) 2306 can include both wired and/or wireless communication technologies, including Bluetooth®, BLE, Wi-Fi and cellular communication technologies, as well as wired or fiber optic technologies. Components used for such communications can depend at least in part upon the type of network, the environment selected, or both. Protocols for communicating over such networks are well known and will not be discussed herein in detail.

Embodiments of the disclosure may be provided to users through a cloud computing infrastructure. Cloud computing refers to the provision of scalable computing resources as a service over a network, to enable convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

The user device 2302 can further include one or more input/output (I/O) devices 2314. The I/O devices 2314 can include speakers, a microphone, a camera, and various user controls (e.g., buttons, a joystick, a keyboard, a keypad, etc.), a haptic output device, and so forth. The I/O devices 2314 can also include attachments that leverage the accessories (audio-jack, USB-C, Bluetooth, etc.) to connect with the user device 2302.

In at least one example, user device 2302 can include a display 2316. Depending on the type of computing device(s) used as the user device 2302, the display 2316 can employ any suitable display technology. For example, the display 2316 can be a liquid crystal display, a plasma display, a light emitting diode display, an OLED (organic light-emitting diode) display, an electronic paper display, or any other suitable type of display able to present digital content thereon. In at least one example, the display 2316 can be an augmented reality display, a virtual reality display, or any other display able to present and/or project digital content. In some examples, the display 2316 can have a touch sensor associated with the display 2316 to provide a touchscreen display configured to receive touch inputs for enabling interaction with a graphic interface presented on the display 2316. Accordingly, implementations herein are not limited to any particular display technology. In some examples, the user device 2302 may not include the display 2316, and information can be presented by other means, such as aurally, haptically, etc.

In addition, the user device 2302 can include sensor(s) 2318. The sensor(s) 2318 can include a global positioning system (“GPS”) device able to indicate location information. Further, the sensor(s) 2318 can include, but are not limited to, an accelerometer, gyroscope, compass, proximity sensor, camera, microphone, and/or a switch.

In some examples, the GPS device can be used to identify a location of a user. In at least one example, the location of the user can be used by the merchant platform 2110, the P2P platform 2112, and/or the media content platform 2114, described above, to provide one or more services. That is, in some examples, the service provider can implement geofencing to provide particular services to users by the merchant platform 2110, the P2P platform 2112, and/or the media content platform 2114.

In examples, the user device 2302 includes a codec system, which may comprise an encoder 2346 and/or a decoder 2348. The encoder 2346 is configured to encode a data stream or signal from an analog signal (e.g., an analog audio signal, an analog video signal, etc.) to a digital signal for transmission or storage. The decoder 2348 is configured to convert the digital signal back to an analog signal, such as for playback or editing. In some cases, the encoder 2346 may be configured to encode the data stream or analog signal in an encrypted format, and the decoder 2348 may accordingly be configured to decrypt the digital signal as part of the decoding process (e.g., using a cryptographic key). Additionally, in some examples, the encoder 2346 may compress data to reduce transmission bandwidth and/or storage space for the digital signal. One example of a compression codec system is a lossless codec, in which the digital data stream is a compressed format of the original data stream, but retains the information present in the original data stream. Another example of a compression codec system is a lossy codec which reduces the quality of the digital data stream but can increase the compression of the data stream relative to lossless codec systems. The codec system comprising the encoder 2346 and/or the decoder 2348 may be specialized to accomplish various different objectives, such as to preserve motion, preserve color, minimize latency, maintain fidelity, minimize bit-rate, optimize for different output device types, maintain synchronization of audio and video (e.g., using a metadata synchronization data stream), and so on. Although not explicitly illustrated in the example system 2300, the server 2304 may include an encoder 2346 and/or a decoder 2348 as well.

Additionally, the user device 2302 can include various other components that are not shown, examples of which include removable storage, a power source, such as a battery and power control unit, a barcode scanner, a printer, a cash drawer, and so forth.

In addition, as described in relation to FIG. 21, the user device 2302 can include, be connectable to, or otherwise be coupled to a reader device 2326, for reading payment instruments and/or identifiers associated with payment objects. The reader device 2326 can include a read head for reading a magnetic strip of a payment card, and further can include encryption technology for encrypting the information read from the magnetic strip. Additionally or alternatively, the reader device 2326 can be an EMV payment reader, which in some examples, can be embedded in the user device 2302. Moreover, numerous other types of readers can be employed with the user device 2302 herein, depending on the type and configuration of the user device 2302.

The reader device 2326 may be a portable magnetic stripe card reader, optical scanner, smartcard (card with an embedded IC chip) reader (e.g., an EMV-compliant card reader or short-range communication-enabled reader), RFID reader, or the like, configured to detect and obtain data from various types of payment instruments. Accordingly, the reader device 2326 may include hardware implementation, such as slots, magnetic tracks, and rails with one or more sensors or electrical contacts to facilitate detection and acceptance of a payment instrument. That is, the reader device 2326 may include hardware implementations to enable the reader device 2326 to interact with a payment instrument via a swipe, a dip, or a tap to obtain payment data associated with a customer. Additionally or optionally, the reader device 2326 may also include a biometric sensor to receive and process biometric characteristics and process them as payment instruments, given that such biometric characteristics are registered with the payment service and connected to a financial account with a bank server. The reader device 2326 may include processing unit(s), computer-readable media, a reader chip, a transaction chip, a timer, a clock, a network interface, a power supply, and so on. That is, the reader device 2326 may include any of the computing components described herein with reference to the user device 2302 to implement the functionality provided by the reader device 2326.

In examples, the reader device 2326 includes a reader chip, which may perform functionality to control the power supply, among other functionality of the reader device 2326. The power supply may include one or more power supplies such as a physical connection to AC power or a battery. Power supply may include power conversion circuitry for converting AC power and generating a plurality of DC voltages for use by components of reader device 2326. When power supply includes a battery, the battery may be charged via a physical power connection, via inductive charging, or via any other suitable method.

The reader device 2326 may also include a transaction chip that may perform functionalities relating to processing of payment transactions, interfacing with payment instruments, cryptography, and other payment-specific functionality. That is, the transaction chip may access payment data associated with a payment instrument and may provide the payment data to a POS terminal, as described above. The payment data may include, but is not limited to, a name of the customer, an address of the customer, a type (e.g., credit, debit, etc.) of a payment instrument, a number associated with the payment instrument, a verification value (e.g., PIN Verification Key Indicator (PVKI), PIN Verification Value (PVV), Card Verification Value (CVV), Card Verification Code (CVC), etc.) associated with the payment instrument, an expiration data associated with the payment instrument, a primary account number (PAN) corresponding to the customer (which may or may not match the number associated with the payment instrument), restrictions on what types of charges/debts may be made, etc. The transaction chip may encrypt the payment data upon receiving the payment data.

It should be understood that in some examples, the reader chip may have its own processing unit(s) and computer-readable media and/or the transaction chip may have its own processing unit(s) and computer-readable media. In other examples, the functionalities of reader chip and transaction chip may be embodied in a single chip or a plurality of chips, each including any suitable combination of processing units and computer-readable media to collectively perform the functionalities of reader chip and transaction chip as described herein.

While the user device 2302, which can be a POS terminal, and the reader device 2326 are shown as separate devices, in additional or alternative examples, the user device 2302 and the reader device 2326 can be part of a single device, which may be a battery-operated device. In some examples, the reader device 2326 can have a display integrated therewith, which can be in addition to (or as an alternative of) the display 2316 associated with the user device 2302.

The server(s) 2304 can include one or more servers or other types of computing devices that can be embodied in any number of ways. For example, in the example of a server, the components, other functional components, and data can be implemented on a single server, a cluster of servers, a server farm or data center, a cloud-hosted computing service, a cloud-hosted storage service, and so forth, although other computer architectures can additionally or alternatively be used.

Further, while the figures illustrate the components and data of the server(s) 2304 as being present in a single location, these components and data can alternatively be distributed across different computing devices and different locations in any manner. Consequently, the functions can be implemented by one or more server computing devices, with the various functionality described above distributed in various ways across the different computing devices. Multiple server(s) 2304 can be located together or separately, and organized, for example, as virtual servers, server banks and/or server farms. The described functionality can be provided by the servers of a single merchant or enterprise, or can be provided by the servers and/or services of multiple different customers or enterprises.

In the illustrated example, the server(s) 2304 can include one or more processors 2328, one or more computer-readable media 2330, one or more I/O devices 2332, and one or more communication interfaces 2334. Each processor 2328 can be a single processing unit or a number of processing units, and can include single or multiple computing units or multiple processing cores. The processor(s) 2328 can be implemented as one or more microprocessors, microcomputers, microcontrollers, digital signal processors, central processing units, state machines, logic circuitries, and/or any devices that manipulate signals based on operational instructions. For example, the processor(s) 2328 can be one or more hardware processors and/or logic circuits of any suitable type specifically programmed or configured to execute the algorithms and processes described herein. The processor(s) 2328 can be configured to fetch and execute computer-readable instructions stored in the computer-readable media 2330, which can program the processor(s) 2328 to perform the functions described herein.

The computer-readable media 2330 can include volatile and nonvolatile memory and/or removable and non-removable media implemented in any type of technology for storage of information, such as computer-readable instructions, data structures, program components, or other data. Such computer-readable media 2330 can include, but is not limited to, RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the server(s) 2304, the computer-readable media 2330 can be a type of computer-readable storage media and/or can be a tangible non-transitory media to the extent that when mentioned, non-transitory computer-readable media exclude media such as energy, carrier signals, electromagnetic waves, and signals per se.

The computer-readable media 2330 can be used to store any number of functional components that are executable by the processor(s) 2328. In many implementations, these functional components comprise instructions or programs that are executable by the processors 2328 and that, when executed, specifically configure the one or more processors 2328 to perform the actions attributed above to the merchant platform 2110, the P2P platform 2112, and/or the media content platform 2114. Functional components stored in the computer-readable media 2330 can optionally include a verification component 2336, a threshold component 2338, and one or more other components and data 2340. The computer-readable media 2330 can additionally include an operating system 2342 for controlling and managing various functions of the server(s) 2304.

The verification component 2336 can manage aspect(s) of verification of amount(s) and/or address(es). For instance, the verification component 2336 can manage the amount verification of the user interface 1402 and/or of operations 2004-2008. The verification component 2336 can manage the address verification of the user interface 1408, the user interface 1414, the user interface 1420, the user interface 1708, and/or of operations 2010-2014.

The threshold component 2338 can manage setting and/or adjusting a threshold (for an amount of a transaction) beyond which the system verifies amount(s) and/or address(es). Examples of the threshold include the verification threshold that is changed from $1,000 to $1,500 through the user interface 1806, the verification threshold that is changed from $1,000 to $500 through the user interface 1908, other verification thresholds discussed herein, or a combination thereof.

In some examples, the one or more other components and data 2340 can include a payment component can be configured to receive transaction data from POS systems. The payment component can transmit requests (e.g., authorization, capture, settlement, etc.) to payment service server computing device(s) to facilitate POS transactions between merchants and customers. The payment component can communicate the successes or failures of the POS transactions to the POS systems.

In some examples, the one or more other components and data 2340 can include a training component can be configured to train and/or fine-tune machine learning (ML) model(s) based on training data for the ML model(s), as well as update (e.g., retrain, further train, and/or fine-tune) the models to improve outputs provided by the ML model(s) based on feedback (about previous outputs of the ML model(s)) received over time. For example, an ML engine can analyze training data to train a data model that generates an output, which can be a recommendation, a score, and/or another indication. ML engine mechanisms can include, but are not limited to supervised learning algorithms (e.g., artificial neural networks, Bayesian statistics, support vector machines, decision trees, classifiers, k-nearest neighbor, etc.), unsupervised learning algorithms (e.g., artificial neural networks, association rule learning, hierarchical clustering, cluster analysis, etc.), semi-supervised learning algorithms, deep learning algorithms, etc.), reinforcement learning algorithms, statistical models, heuristics, rules, or combinations thereof. In at least one example, machine-trained ML models can be stored in a datastore associated with the user device(s) 2302 and/or the server(s) 2304 for use at a time after the data models have been trained (e.g., at runtime).

The one or more “components” referenced herein may be implemented as more components or as fewer components, and functions described for the components may be redistributed depending on the details of the implementation. The term “component,” as used herein, refers broadly to software stored on non-transitory storage medium (e.g., volatile or non-volatile memory for a computing device), hardware, or firmware (or any combination thereof) components. Modules are typically functional such that they may generate useful data or other output using specified input(s). A component may or may not be self-contained. An application program (also called an “application”) may include one or more components, or a component may include one or more application programs that can be accessed over a network or downloaded as software onto a device (e.g., executable code causing the device to perform an action). An application program (also called an “application”) may include one or more components, or a component may include one or more application programs. In additional and/or alternative examples, the component(s) may be implemented as computer-readable instructions, various data structures, and so forth via at least one processing unit to configure the computing device(s) described herein to execute instructions and to perform operations as described herein.

In some examples, a component may include one or more application programming interfaces (APIs) to perform some or all of its functionality (e.g., operations). In at least one example, a software developer kit (SDK) can be provided by the service provider to allow third-party developers to include service provider functionality and/or avail service provider services in association with their own third-party applications. Additionally or alternatively, in some examples, the service provider can utilize a SDK to integrate third-party service provider functionality into its applications. That is, API(s) and/or SDK(s) can enable third-party developers to customize how their respective third-party applications interact with the service provider or vice versa.

The communication interface(s) 2334 can include one or more interfaces and hardware components for enabling communication with various other devices, such as over the network(s) 2306 or directly. For example, communication interface(s) 2334 can enable communication through one or more network(s) 2306, which can include, but are not limited any type of network known in the art, as described herein.

The server(s) 2304 can further be equipped with various I/O devices 2332. Such I/O devices 2332 can include a display, various user interface controls (e.g., buttons, joystick, keyboard, mouse, touch screen, biometric or sensory input devices, etc.), audio speakers, connection ports and so forth.

In at least one example, the system 2300 can include a datastore 2344 that can be configured to store data that is accessible, manageable, and updatable. In some examples, the datastore 2344 can be integrated with the user device 2302 and/or the server(s) 2304. In other examples, as shown in FIG. 23, the datastore 2344 can be located remotely from the server(s) 2304 and can be accessible to the server(s) 2304. The datastore 2344 can comprise multiple databases and/or servers connected locally and/or remotely via the network(s) 2306. In at least one example, the datastore 2344 can store user profiles, which can include merchant profiles, customer profiles, artist profiles, and so on.

Merchant profiles can store, or otherwise be associated with, data associated with merchants. For instance, a merchant profile can store, or otherwise be associated with, information about a merchant (e.g., name of the merchant, geographic location of the merchant, operating hours of the merchant, employee information, etc.), a merchant category classification (MCC), item(s) offered for sale by the merchant, hardware (e.g., device type) used by the merchant, transaction data associated with the merchant (e.g., transactions conducted by the merchant, payment data associated with the transactions, items associated with the transactions, descriptions of items associated with the transactions, itemized and/or total spends of each of the transactions, parties to the transactions, dates, times, and/or locations associated with the transactions, etc.), loan information associated with the merchant (e.g., previous loans made to the merchant, previous defaults on said loans, etc.), risk information associated with the merchant (e.g., indications of risk, instances of fraud, chargebacks, etc.), appointments information (e.g., previous appointments, upcoming (scheduled) appointments, timing of appointments, lengths of appointments, etc.), payroll information (e.g., employees, payroll frequency, payroll amounts, etc.), employee information, reservations data (e.g., previous reservations, upcoming (scheduled) reservations, interactions associated with such reservations, etc.), inventory data, customer service data, etc. The merchant profile can securely store bank account information as provided by the merchant. Further, the merchant profile can store payment information associated with a payment instrument linked to a stored balance of the merchant, such as a stored balance maintained in a ledger by the service provider.

Customer profiles can store customer data including, but not limited to, customer information (e.g., name, phone number, address, banking information, etc.), customer preferences (e.g., learned or customer-specified), purchase history data (e.g., identifying one or more items purchased (and respective item information), payment instruments used to purchase one or more items, returns associated with one or more orders, statuses of one or more orders (e.g., preparing, packaging, in transit, delivered, etc.), etc.), appointments data (e.g., previous appointments, upcoming (scheduled) appointments, timing of appointments, lengths of appointments, etc.), payroll data (e.g., employers, payroll frequency, payroll amounts, etc.), reservations data (e.g., previous reservations, upcoming (scheduled) reservations, reservation duration, interactions associated with such reservations, etc.), inventory data, customer service data, media content consumption data (e.g., number of streams of media content and by which artists, direct artist payouts, playlists generated or “favorited,” durations of listening and/or watching individual media content items, actions performed while consuming media content (e.g., skips, repeats, volume changes, etc.), locations at which media content is consumed, devices used to consume media content, activities during which media content is consumed, etc.), etc.

Artist profiles can store data including, but not limited to, artist information (e.g., artist's performance or stage name, band name, artist's legal name, record label, phone number, address, social media handles, website address, banking information, etc.), artist preferences (e.g., learned or artist-specified), media content (and/or associated data) at least partially attributed to the artist (e.g., songs, videos, artists in a same genre or having shared listeners, etc.), event data (e.g., tour dates, appearance dates, appointments, etc.), financial data (e.g., advance data, recoupment data, royalty data, payouts data, etc.), payroll data (e.g., employees, contractors, venues, payroll frequency, etc.), listening data (e.g., number of streams on media content platform(s), listening trends, etc.), fan data (number of followers on media content platform(s), number of followers on social media platform(s), etc.), reservations data (e.g., venue reservations, studio recording reservations, previous reservations, upcoming (scheduled) reservations, reservation duration, interactions associated with such reservations, etc.), inventory data (e.g., merchandise inventory), customer service data, and so forth.

Furthermore, in at least one example, the datastore 2344 can store inventory database(s) and/or catalog database(s). As described above, an inventory can store data associated with a quantity of each item that a merchant has available to the merchant. Furthermore, a catalog can store data associated with items that a merchant has available for acquisition. The datastore 2344 can store additional or alternative types of data as described herein.

The phrases “in some examples,” “according to various examples,” “in the examples shown,” “in one example,” “in other examples,” “various examples,” “some examples,” and the like generally mean the particular feature, structure, or characteristic following the phrase is included in at least one example of the present invention, and may be included in more than one example of the present invention. In addition, such phrases do not necessarily refer to the same examples or to different examples.

If the specification states a component or feature “can,” “may,” “could,” or “might” be included or have a characteristic, that particular component or feature is not required to be included or have the characteristic.

Further, the aforementioned description is directed to devices and applications that are related to payment technology. However, it will be understood, that the technology can be extended to any device and application. Moreover, techniques described herein can be configured to operate irrespective of the kind of payment object reader, POS terminal, web applications, mobile applications, POS topologies, payment cards, computer networks, and environments.

Various figures included herein are flowcharts showing example methods involving techniques as described herein. The methods illustrated are described with reference to components described in the figures for convenience and ease of understanding. However, the methods illustrated are not limited to being performed using components described in the figures and such components are not limited to performing the methods illustrated herein.

Furthermore, the methods described above are illustrated as collections of blocks in logical flow graphs, which represent sequences of operations that can be implemented in hardware, software, or a combination thereof. In the context of software, the blocks represent computer-executable instructions stored on one or more computer-readable storage media that, when executed by processor(s), perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the processes. In some embodiments, one or more blocks of the process can be omitted entirely. Moreover, the methods can be combined in whole or in part with each other or with other methods.

Although the systems and techniques have been described in language specific to structural features and/or methodological acts, it is to be understood that the systems and techniques defined in the appended claims are not necessarily limited to the specific features or acts described. Rather, the specific features and acts are disclosed as example forms of implementing the claimed subject matter.

Embodiments of the present disclosure can be implemented at least according to the following clauses:

Clause 1. A method of multi-factor authentication to improve cryptocurrency transaction security, the method comprising: receiving, at a user device, a request for a transfer of an amount of a cryptocurrency from a transferor account to a transferee account, wherein the transferee account is associated with an address that includes at least a first subset and a second subset; displaying, through a first interactive graphical user interface at the user device, at least a portion of the amount of the cryptocurrency; receiving a first input from a user through the first interactive graphical user interface at the user device verifying that at least the portion of the amount of the cryptocurrency is correct, wherein the first input represents a first factor of authentication for the transfer; displaying, through a second interactive graphical user interface at the user device, the first subset of the address associated with the transferee account; receiving a second input from the user through the second interactive graphical user interface at the user device, wherein the second interactive graphical user interface prompts the user for the second subset of the address associated with the transferee account, and wherein the second input is indicative of the second subset of the address; verifying that the second input matches the second subset of the address, wherein the second input matching the second subset represents a second factor of authentication for the transfer; and initiating the transfer of the amount of the cryptocurrency from the transferor account to the transferee account in response to multi-factor authentication via the first factor of authentication and the second factor of authentication.

Clause 2. The method of Clause 1, further comprising: verifying that the second subset is adjacent to the first subset within the address.

Clause 3. The method of any one of Clauses 1 to 2, further comprising: identifying that the amount of the cryptocurrency to be transferred exceeds a threshold before displaying the first interactive graphical user interface and before displaying the second interactive graphical user interface.

Clause 4. The method of any one of Clauses 1 to 3, further comprising: performing operations according to any of Clauses 6 to 17.

Clause 5. A method comprising: receiving a request for a transfer of an amount of a digital asset from a transferor account to a transferee account, wherein the transferee account is associated with an address that includes at least a first subset and a second subset; receiving a first input from a user through a first interactive user interface, wherein the first interactive user interface identifies at least a portion of the amount of the digital asset, wherein the first input verifies that at least the portion of the amount of the digital asset is correct, and wherein the first input represents a first factor of authentication for the transfer; receiving a second input from the user through a second interactive user interface, wherein the second interactive user interface identifies the first subset of the address associated with the transferee account, and wherein the second interactive user interface prompts the user for the second subset of the address associated with the transferee account; verifying that the second input matches the second subset of the address, wherein the second input matching the second subset represents a second factor of authentication for the transfer; and initiating the transfer of the amount of the digital asset from the transferor account to the transferee account in response to multi-factor authentication via the first factor of authentication and the second factor of authentication.

Clause 6. The method of Clause 5, further comprising: verifying that the second subset is adjacent to the first subset within the address.

Clause 7. The method of any one of Clauses 5 to 6, further comprising: outputting the first interactive user interface; and outputting the second interactive user interface.

Clause 8. The method of any one of Clauses 5 to 7, further comprising: displaying a first interactive graphical user interface of the first interactive user interface; and displaying a second interactive graphical user interface of the second interactive user interface.

Clause 9. The method of any one of Clauses 5 to 8, wherein the digital asset is a cryptocurrency.

Clause 10. The method of any one of Clauses 5 to 9, wherein the first interactive user interface identifies a first portion of the amount of the digital asset, and wherein the first input identifies a second portion of the amount of the digital asset to verify that the first portion of the amount of the digital asset is correct.

Clause 11. The method of Clause 10, further comprising: verifying that the second portion of the amount of the digital asset is adjacent to the first portion of the amount of the digital asset within the amount of the digital asset.

Clause 12. The method of any one of Clauses 5 to 11, further comprising: identifying that the amount of the digital asset to be transferred exceeds a threshold before receiving the first input and before receiving the second input.

Clause 13. The method of Clause 12, further comprising: receiving an indication of a potential security issue; and automatically reducing the threshold in response to the indication of the potential security issue.

Clause 14. The method of any one of Clauses 12 to 13, further comprising: receiving a third input through a third interactive user interface, wherein the third input identifies the threshold.

Clause 15. The method of Clause 14, further comprising: sending a message indicative of the third input; waiting for a predetermined amount of time for a response to the message; and setting the threshold based on the third input in response to failure to receive the response to the message within the predetermined amount of time.

Clause 16. The method of any one of Clauses 12 to 15, further comprising: detecting an interaction between a first device and a second device; and setting the threshold in response to the interaction between the first device and the second device.

Clause 17. The method of any one of Clauses 5 to 16, further comprising: sending a message automatically in response to verifying that the second input correctly identifies the second subset of the address, wherein the message includes an interactive element that is configured to trigger a response to the message through which the transfer is cancellable, wherein initiating the transfer is based on a failure to receive the response to the message for at least a predetermined amount of time since the sending of the message.

Clause 18. A system comprising: a memory storing instructions; and a processor, wherein execution of the instructions by the processor causes the processor to: receive a request for a transfer of an amount of a digital asset from a transferor account to a transferee account, wherein the transferee account is associated with an address that includes at least a first subset and a second subset; receive a first input from a user through a first interactive user interface, wherein the first interactive user interface identifies at least a portion of the amount of the digital asset, wherein the first input verifies that at least the portion of the amount of the digital asset is correct, and wherein the first input represents a first factor of authentication for the transfer; receive a second input from the user through a second interactive user interface, wherein the second interactive user interface identifies the first subset of the address corresponding to the transferee account, and wherein the second interactive user interface prompts the user for the second subset of the address associated with the transferee account; verify that the second input matches the second subset of the address, wherein the second input matching the second subset represents a second factor of authentication for the transfer; and initiate the transfer of the amount of the digital asset from the transferor account to the transferee account in response to multi-factor authentication via the first factor of authentication and the second factor of authentication.

Clause 19. The system of Clause 18, wherein the execution of the instructions by the processor causes the processor to: verify that the second subset is adjacent to the first subset within the address.

Clause 20. The system of any one of Clauses 18 to 19, wherein the first interactive user interface identifies a first portion of the amount of the digital asset, and wherein the first input identifies a second portion of the amount of the digital asset to verify that the first portion of the amount of the digital asset is correct.

Clause 21. The system of any one of Clauses 18 to 20, wherein the execution of the instructions by the processor causes the processor to: identify that the amount of the digital asset to be transferred exceeds a threshold before receiving the first input and before receiving the second input.

Clause 22. The system of any one of Clauses 18 to 21, wherein the execution of the instructions by the processor causes the processor to: perform operations according to any of Clauses 6 to 17.

Clause 23. A non-transitory computer-readable medium having stored thereon instructions that, when executed by at least one processor, cause the at least one processor to perform operations according to any of Clauses 1 to 22.

Clause 24. An apparatus for wireless communications, comprising one or more means for performing operations according to any of Clauses 1 to 22.

What is claimed is:

1. A method of multi-factor authentication to improve cryptocurrency transaction security, the method comprising:
receiving, at a user device, a request for a transfer of an amount of a cryptocurrency from a transferor account to a transferee account, wherein the transferee account is associated with an address that includes at least a first subset and a second subset;
displaying, through a first interactive graphical user interface at the user device, at least a portion of the amount of the cryptocurrency;
receiving a first input from a user through the first interactive graphical user interface at the user device verifying that at least the portion of the amount of the cryptocurrency is correct, wherein the first input represents a first factor of authentication for the transfer;
displaying, through a second interactive graphical user interface at the user device, the first subset of the address associated with the transferee account;
receiving a second input from the user through the second interactive graphical user interface at the user device, wherein the second interactive graphical user interface prompts the user for the second subset of the address associated with the transferee account, and wherein the second input is indicative of the second subset of the address;
verifying that the second input matches the second subset of the address, wherein the second input matching the second subset represents a second factor of authentication for the transfer; and
initiating the transfer of the amount of the cryptocurrency from the transferor account to the transferee account in response to multi-factor authentication via the first factor of authentication and the second factor of authentication.

2. The method of claim 1, wherein the second subset is adjacent to the first subset within the address.

3. The method of claim 1, further comprising:
identifying that the amount of the cryptocurrency to be transferred exceeds a threshold before displaying the first interactive graphical user interface and before displaying the second interactive graphical user interface.

4. A method comprising:
receiving a request for a transfer of an amount of a digital asset from a transferor account to a transferee account, wherein the transferee account is associated with an address that includes at least a first subset and a second subset;
receiving a first input from a user through a first interactive user interface, wherein the first interactive user interface identifies at least a portion of the amount of the digital asset, wherein the first input verifies that at least the portion of the amount of the digital asset is correct, and wherein the first input represents a first factor of authentication for the transfer;
receiving a second input from the user through a second interactive user interface, wherein the second interactive user interface identifies the first subset of the address associated with the transferee account, and wherein the second interactive user interface prompts the user for the second subset of the address associated with the transferee account;
verifying that the second input matches the second subset of the address, wherein the second input matching the second subset represents a second factor of authentication for the transfer; and
initiating the transfer of the amount of the digital asset from the transferor account to the transferee account in response to multi-factor authentication via the first factor of authentication and the second factor of authentication.

5. The method of claim 4, wherein the second subset is adjacent to the first subset within the address.

6. The method of claim 4, further comprising:
outputting the first interactive user interface; and
outputting the second interactive user interface.

7. The method of claim 4, further comprising:
displaying a first interactive graphical user interface of the first interactive user interface; and
displaying a second interactive graphical user interface of the second interactive user interface.

8. The method of claim 4, wherein the digital asset is a cryptocurrency.

9. The method of claim 4, wherein the first interactive user interface identifies a first portion of the amount of the digital asset, and wherein the first input identifies a second portion of the amount of the digital asset to verify that the first portion of the amount of the digital asset is correct.

10. The method of claim 9, further comprising:
verifying that the second portion of the amount of the digital asset is adjacent to the first portion of the amount of the digital asset within the amount of the digital asset.

11. The method of claim 4, further comprising:
identifying that the amount of the digital asset to be transferred exceeds a threshold before receiving the first input and before receiving the second input.

12. The method of claim 11, further comprising:
receiving an indication of a potential security issue; and
automatically reducing the threshold in response to the indication of the potential security issue.

13. The method of claim 11, further comprising:
receiving a third input through a third interactive user interface, wherein the third input identifies the threshold.

14. The method of claim 13, further comprising:
sending a message indicative of the third input;
waiting for a predetermined amount of time for a response to the message; and
setting the threshold based on the third input in response to failure to receive the response to the message within the predetermined amount of time.

15. The method of claim 11, further comprising:
detecting an interaction between a first device and a second device; and
setting the threshold in response to the interaction between the first device and the second device.

16. The method of claim 4, further comprising:
sending a message automatically in response to verifying that the second input correctly identifies the second subset of the address, wherein the message includes an interactive element that is configured to trigger a response to the message through which the transfer is cancellable, wherein initiating the transfer is based on a failure to receive the response to the message for at least a predetermined amount of time since the sending of the message.

17. A system comprising:
a memory storing instructions; and
a processor, wherein execution of the instructions by the processor causes the processor to:
receive a request for a transfer of an amount of a digital asset from a transferor account to a transferee account, wherein the transferee account is associated with an address that includes at least a first subset and a second subset;
receive a first input from a user through a first interactive user interface, wherein the first interactive user interface identifies at least a portion of the amount of the digital asset, wherein the first input verifies that at least the portion of the amount of the digital asset is correct, and wherein the first input represents a first factor of authentication for the transfer;
receive a second input from the user through a second interactive user interface, wherein the second interactive user interface identifies the first subset of the address associated with the transferee account, and wherein the second interactive user interface prompts the user for the second subset of the address associated with the transferee account;
verify that the second input correctly identifies the second subset of the address, wherein the second input matching the second subset represents a second factor of authentication for the transfer; and
initiate the transfer of the amount of the digital asset from the transferor account to the transferee account in response to multi-factor authentication via the first factor of authentication and the second factor of authentication.

18. The system of claim 17, wherein the execution of the instructions by the processor causes the processor to:
verify that the second subset is adjacent to the first subset within the address.

19. The system of claim 17, wherein the first interactive user interface identifies a first portion of the amount of the digital asset, and wherein the first input identifies a second portion of the amount of the digital asset to verify that the first portion of the amount of the digital asset is correct.

20. The system of claim 17, wherein the execution of the instructions by the processor causes the processor to:
identify that the amount of the digital asset to be transferred exceeds a threshold before receiving the first input and before receiving the second input.
